(19) United States
(12) Patent Application Publication
(10) Pub. No.: US 2025/0002617 A1
(43) Pub. Date: Jan. 2, 2025

(54) C1 SYMMETRIC METALLOCENE CATALYSTS TAILORED FOR PRODUCTION OF VINYL-TERMINATED POLYPROPYLENE OLIGOMERS AND MACROMONOMERS

(71) Applicant: EXXONMOBIL CHEMICAL PATENTS INC., Baytown, TX (US)

(72) Inventors: Nikola S. LAMBIC, Houston, TX (US); Maksim E. SHIVOKHIN, Houston, TX (US); Gregory J. SMITH-KARAHALIS, Houston, TX (US); An Ngoc-Michael NGUYEN, Pearland, TX (US)

(73) Assignee: EXXONMOBIL TECHNOLOGY AND ENGINEERING COMPANY, Spring, TX (US)

(21) Appl. No.: 18/290,966

(22) PCT Filed: Sep. 1, 2022
(86) PCT No.: PCT/US2022/075802

§ 371 Date: Jan. 22, 2024

Related U.S. Application Data
(60) Provisional application No. 63/240,230, filed on Sep. 2, 2021.

(51) Int. Cl. C08F 10/06

(52) U.S. Cl. CPC C08F 10/06; C08F 2420/10

(57) ABSTRACT

Mixed metallocene catalyst systems may comprise an activator, a first metallocene having a structure represented by Formula 1, and a second metallocene different from the first metallocene.

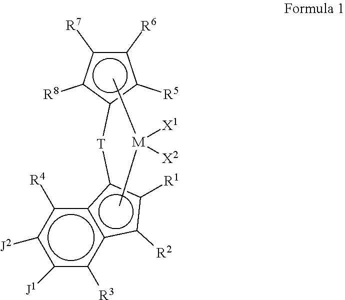

M is a Group 4 metal, T is a bridging group, X¹ and X² are each a univalent anionic ligand or optionally joined together to define a metallocycle ring or similar, J¹ and J² are each H or J¹ and J² are joined together to form a cyclic or polycyclic ring structure, and R¹, R², and R⁸ are preferably independently H, optionally substituted C₁-C₄₀ alkyl, or optionally substituted C₆-C₁₄ aryl. R³ is a bulky alkyl group, such as an optionally substituted cyclohexyl, norbornanyl, adamantyl, or t-butyl, or an optionally substituted aryl group, such as an optionally substituted phenyl group. The second metallocene may have C₂ symmetry or pseudo-C₂ symmetry. The catalyst systems may afford polyolefins having a high degree of vinyl termination.

### BACKGROUND

### Field

Embodiments of the present disclosure generally relate to asymmetric metallocenes and catalyst systems formed therefrom. More particularly, embodiments of the present disclosure relate to asymmetric, bridged metallocenes based upon substituted indenyl ligands or larger fused heteroaromatic ring systems based upon indenyl ligands.

### Description of the Related Art

Polypropylene resins produced using conventional slurry processes and catalyst systems produce granular products that are highly linear. Such highly linear polypropylenes have insufficient melt strength for applications such as foams, blown films, and thermoforming. Increased branching may improve the melt strength. Long-chain branched polypropylenes (LCB-PP) are commonly produced using relatively expensive post-reactor treatments with various peroxide-based reagents or through photoirradiation processes. Alternately, vinyl-terminated macromonomers (VTM), such as α,ω-diene comonomers, may be copolymerized with propylene to achieve branching through an in-reactor process; however, in-reactor production of branched polypropylenes requires careful comonomer concentration control to limit formation of undesired gels. Moreover, not all polymerization catalysts are capable of effectively polymerizing α,ω-diene comonomers.

Therefore, there exists a need for improved metallocenes and metallocene compositions capable of producing vinyl-terminated iPP with high vinyl content at commercially relevant process conditions and productivity levels, without utilizing expensive post-reactor treatments or α,ω-diene comonomers, which may lead to formation of high molecular weight fractions and undesired gels formed therefrom. Vinyl chain ends upon vinyl-terminated macromonomers formed in-reactor, in contrast, may afford long-chain branches by becoming incorporated into a growing backbone of the main polymer chain. In-reactor production and backbone incorporation of vinyl-terminated macromonomers may avoid the downside of other approaches for introducing long-chain branching, such as post-reactor modification by photoirradiation or peroxide treatment or copolymerization of propylene with an α,ω-diene comonomer.

References of interest include: U.S. Pat. Nos. 10,280,240; 9,951,155; 9,803,037; 9,458,254; 9,309,340; 9,266,910; 7,005,491; 6,977,287; 6,780,936; 5,504,171; US 2001/0007896; US 2002/0013440; US 2004/0087750; US 2015/0322184; US 2016/0034784; US 2016/0244535; US 2018/0162964; US 2019/0119418; US 2019/0119427; US 2019/0292282; EP 3441407; EP 2402353; WO 2002/002575; WO 2005/058916; WO 2006/097497; WO 2011/012245; WO 2015/009471; WO 2015/158790; WO 2017/204830; WO 2019/093630, Nifant'ev, I. E. et al. (2011) “Asymmetric ansa-Zirconocenes Containing a 2-Methyl-4-aryltetrahydroindacene Fragment: Synthesis, Structure, and Catalytic Activity in Propylene Polymerization and Copolymerization” Organometallics, v. 30, pp. 5744-5752; Rieger, B. et al. (2000) “Dual-Side ansa-Zirconocene Dichlorides for High Molecular Weight Isotactic Polypropene Elastomers,” Organometallics, v. 19(19), pp. 3767-3775; Rieger, B. et al. (2013) “Polymerization Behavior of C₁-Symmetric Metallocenes (M=Zr, Hf): from Ultrahigh Molecular Weight Elastic Polypropylene to Useful Macromonomers,” Organometallics, v. 32, pp. 427-437; Peacock, A. et al. (2006) “Molecular Characterization of Polymers,” Polymer Chemistry, Chap. 5, pp. 77-87; Walter, P. et al. (2001) “Long Chain Branched Polypropene Prepared by Means of Propene Copolymerization with 1,7-Octadiene Using MAO-Activated rac-Me₂Si(2-Me-4-Phenyl-Ind)₂ZrCl₂, Macromol. Mater. Eng. v. 286(5), pp. 309-315; Langston, J. A. et al. (2007) “Synthesis and Characterization of Long Chain Branched Isotactic Polypropylene via Metallocene Catalyst and T-Reagent,” Macromolecules, v. 40(8), pp. 2712-2720; and Ye, Z. et al. (2004) “Synthesis and Rheological Properties of Long-Chain-Branched Isotactic Polypropylenes Prepared by Copolymerization of Propylene and Nonconjugated Dienes,” Ind. Eng. Chem. Res., v. 43(11), pp. 2860-2870.

### SUMMARY

In some embodiments, the present disclosure provides mixed metallocene catalyst systems comprising: at least one first metallocene having a structure represented by Formula 1, at least one second metallocene different from the at least one first metallocene; optionally, a support; optionally, a scavenger; and an activator

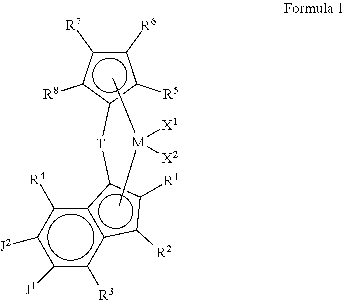

wherein:
M is a Group 4 metal;
T is a bridging group;
X¹ and X² are each a univalent anionic ligand, or X¹ and X² are joined to form a metallocycle ring, a chelating ligand, a diene ligand, or an alkylidene;
R¹ is hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
R² and R⁴ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
R³ is optionally substituted C₁-C₄₀ alkyl or optionally substituted C₆-C₁₄ aryl;
R⁵, R⁶, R⁷, and R⁸ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl, or one or more of R⁵ and R⁶, R⁶ and R⁷, or R⁷ and R⁸ are joined to form a C₃-C₆₂ substituted or unsubstituted, saturated or unsaturated, cyclic or polycyclic ring structure, or a combination thereof; and
J¹ and J² are each H, or J¹ and J² are joined to form a C₃-C₆₂ substituted or unsubstituted, saturated or unsaturated, cyclic or polycyclic ring structure, or a combination thereof.

In some or other embodiments, the present disclosure provides metallocene compositions comprising: at least one metallocene having a structure represented by Formula 9

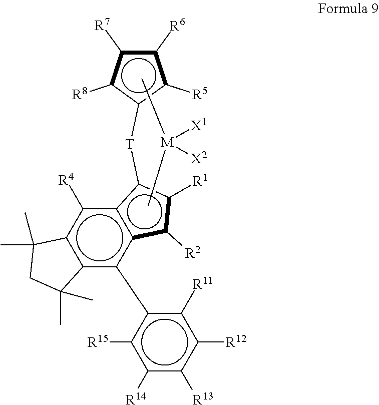

wherein:
M is a Group 4 metal;
T is a bridging group;
X¹ and X² are each a univalent anionic ligand, or X¹ and X² are joined to form a metallocycle ring, a chelating ligand, a diene ligand, or an alkylidene;
R¹ is hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
   R² and R⁴ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
R⁵, R⁶, R⁷, and R⁸ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl, or one or more of R⁵ and R⁶, R⁶ and R⁷, or R⁷ and R⁸ are joined to form a C₃-C₆₂ substituted or unsubstituted, saturated or unsaturated, cyclic or polycyclic ring structure, or a combination thereof; and
   R¹¹—R¹⁵ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and each R′ is hydrogen, C₁-C₁₀ alkyl, or C₆-C₁₀ aryl, or R¹¹ and R¹², R¹² and R¹³, R¹³ and R¹⁴, or R¹⁴ and R¹⁵, or any combination thereof are joined to form a C₃-C₆₂ substituted or unsubstituted, saturated or unsaturated, cyclic or polycyclic ring structure, or a combination thereof. Catalyst systems may comprise a metallocene having a structure represented by Formula 9, an activator, optionally, a support, and optionally, a scavenger.

Polymerization processes may comprise: providing an olefinic feed, and contacting a catalyst system of the present disclosure under polymerization reaction conditions to produce a polyolefin.

These and other features and attributes of the disclosed complexes, systems, and/or methods of the present disclosure and their advantageous applications and/or uses will be apparent from the detailed description which follows.

### BRIEF DESCRIPTION OF THE DRAWINGS

So that the manner in which the above recited features of the present invention can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 11 is a GPC-4D trace for PP produced with Catalyst C16-Zr, according to one or more embodiments provided herein.

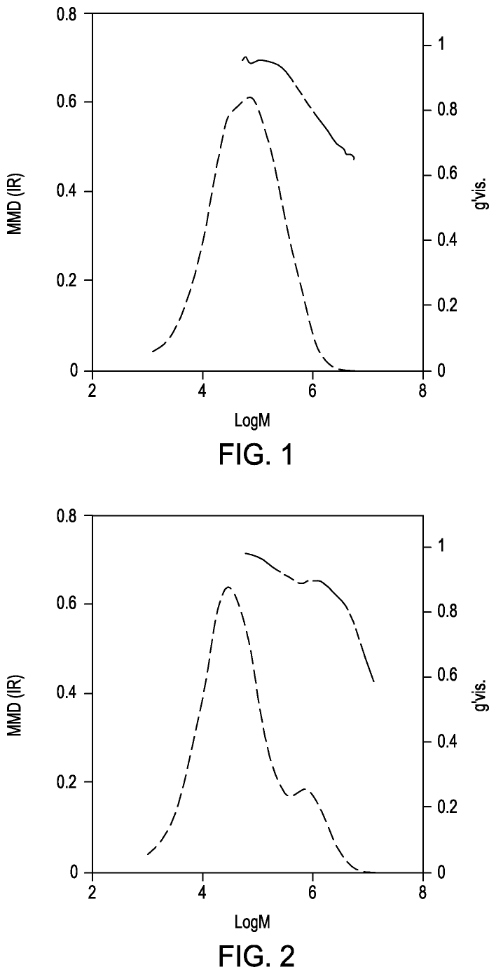

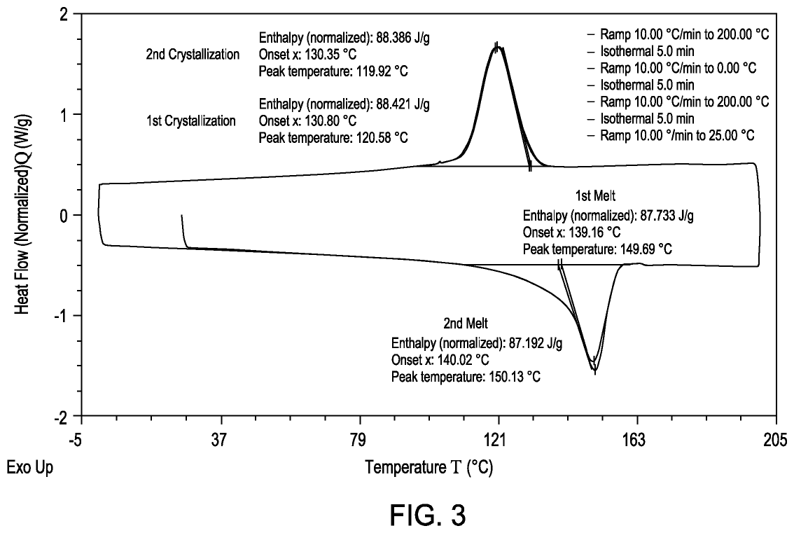

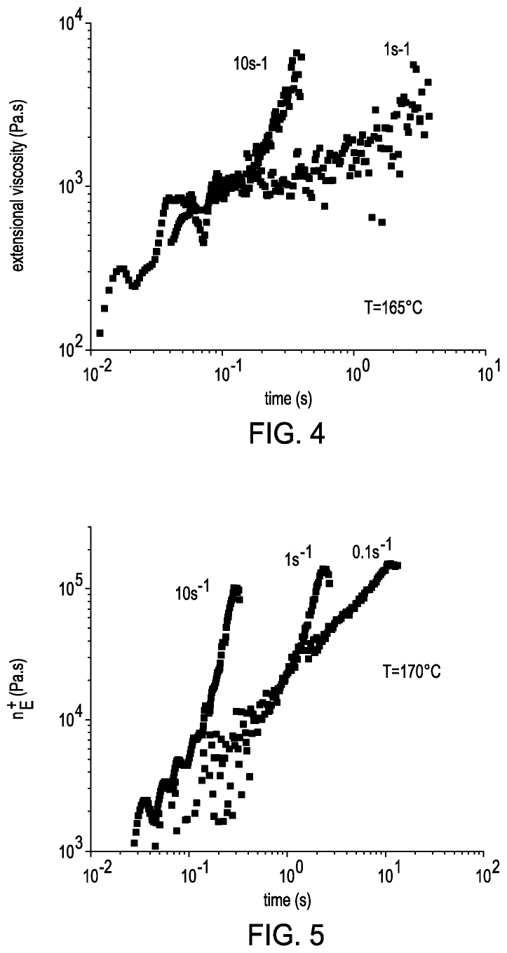

FIG. 2 is a GPC-4D trace for PP produced with dual metallocene Catalysts C16-Zr and C14, according to one or more embodiments provided herein.

FIG. 3 is a DSC plot of PP produced with co-supported dual metallocene Catalysts C16-Zr and C11, according to one or more embodiments provided herein.

FIG. 4 is an extensional viscosity plot for a polymer sample produced with Catalyst C16-Zr in a single catalyst system, according to one or more embodiments provided herein.

FIG. 5 is an extensional viscosity plot for a polymer sample produced with Catalysts C16-Zr and C14 in a dual metallocene catalyst system, according to one or more embodiments provided herein.

### DETAILED DESCRIPTION

Embodiments of the present disclosure generally relate to asymmetric metallocenes and catalyst systems formed therefrom. More particularly, embodiments of the present disclosure relate to asymmetric, bridged metallocenes based upon substituted indenyl ligands or larger fused heteroaromatic ring systems based upon indenyl ligands.

Metallocenes effective for promoting olefin polymerization when suitably activated may be based on asymmetric, bridged metallocenes with a bulky substituent at the 4-position of an indenyl ligand. Optionally, the indenyl ligand may define a portion of a larger fused heteroaromatic ring system. Depending on the type of polymer being targeted and its molecular weight, for instance, the bulky substituent may be a bulky alkyl group (e.g., substituted cyclohexyl, norbornanyl, adamantyl, tert-butyl, or the like) or an aryl group. An alkyl group is considered bulky if the carbon atom bound to the indenyl ring is a secondary, tertiary, or quaternary carbon atom. Specific examples of suitable bulky alkyl groups are provided herein.

In some examples, the bridged metallocenes can include, for example, bridged tetramethylcyclopentadienyl/2-alkyl-4-adamantylindacenyl ligands or similar ligands bearing a bulky alkyl substituent at the 4-position. When bound to a Group 4 transition metal (e.g., Zr or Hf), such bridged metallocenes may promote formation of vinyl-terminated polypropylene with a significant degree of specificity, and surprisingly and unexpectedly promote efficient production of vinyl-terminated macromonomers (VTMs). VTMs may allow production of tailored polymer products to be realized by further reacting the terminal vinyl groups to introduce branching within a higher molecular weight polymer product. A second metallocene capable of forming higher molecular weight polymers may be utilized for this purpose. The branching may be long-chain or short-chain, depending on molecular weight, which may result in dramatic changes in polymer behavior that may be useful for producing, for example, foams, blown films, and thermoforming compositions, among other things.

By utilizing a second metallocene in combination with a first metallocene bearing a bulky alkyl group at the 4-position of the indenyl ligand, a peroxide- and diene-free approach for producing long-chain branched polypropylenes may be realized. The second metallocene is different from the first metallocene in at least the respect of lacking a bulky alkyl substituent at the 4-position and may preferably have C₂ symmetry or pseudo-C₂ symmetry. A metallocene may be pseudo-C₂ symmetric when similar (but not identical) substituents are present on the metallocene, and the metallocene would be rigorously C₂ symmetric but for the minor differences in the substituents. Optical isomers of C₂ and pseudo-C₂ symmetric metallocenes may be resolved from one another. The first metallocene and the second metallocene may be present together in co-supported catalyst systems to accomplish the foregoing. Such catalyst systems can achieve increased polymerization activity, afford polymers having enhanced properties, and promote increased conversion and/or comonomer incorporation. Specifically, the first metallocene may be effective to produce vinyl-terminated macromonomers of fairly low molecular weight, which may then be converted to higher molecular weight polymers having long-chain branching under promotion by the second metallocene. Long-chain branched polypropylenes can be formed in-situ in the foregoing manner with the catalyst systems, thereby eliminating the need for expensive post-reactor treatments or use of α,ω-diene comonomers.

In some embodiments, the bridged metallocenes can include, for example, bridged tetramethylcyclopentadienyl/4-arylindacenyl ligands. When bound to a Group 4 transition metal (e.g., Zr or Hf), such bridged metallocenes may be effective to promote formation of ethylene-propylene copolymers (e.g., ethylene-propylene random copolymers) having relatively high molecular weights. Such polymerization behavior is surprising for C₁ symmetric metallocenes, which commonly fail to provide high molecular weight polymers of this type. For homopolymerization of propylene, such bridged metallocene catalysts may afford highly crystalline isotactic polypropylene. Ethylene-higher alpha olefin copolymers may be produced using the bridged metallocenes as well. Such bridged metallocenes having a 4-arylindacenyl ligand may accomplish the foregoing alone without a second metallocene being present. It is to be appreciated, however, that a second metallocene different than the first metallocene may be present in some cases, however.

Metallocenes having C₁ symmetry may be more economical for conducting olefin polymerization compared to higher symmetry counterparts by virtue of eliminating the need to separate optical isomers of the complexes prior to polymerization. More effective utilization of raw materials used to form the metallocenes and decreased processing thereof may aid in narrowing the cost differential between metallocene catalysts and other types of polymerization catalysts. Moreover, polymerization processes utilizing the metallocenes provided herein can be carried out in solution, slurry, bulk, or gas-phase polymerization processes, thereby affording a considerable degree of process flexibility. The metallocenes described herein may be readily immobilized upon a support material for use in the foregoing.

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this disclosure is combined with publicly available information and technology.

### Definitions

All numerical values within the detailed description and the claims herein are modified by “about” or “approximately” with respect to the indicated value, and take into account experimental error and variations that would be expected by a person having ordinary skill in the art. Unless otherwise indicated, room temperature is about 23° C.

As used in the present disclosure and claims, the singular forms “a,” “an,” and “the” include plural forms unless the context clearly dictates otherwise. The term “and/or” as used in a phrase such as “A and/or B” herein is intended to include “A and B,” “A or B,” “A,” and “B.”

For the purposes of the present disclosure, the new numbering scheme for groups of the Periodic Table is used. In said numbering scheme, the groups (columns) are numbered sequentially from left to right from 1 through 18, excluding the f-block elements (lanthanides and actinides). Under this scheme, the term “transition metal” refers to any atom from Groups 3-12 of the Periodic Table, inclusive of the lanthanides and actinide elements. Ti, Zr, and Hf are Group 4 transition metals, for example.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, and Mz) are in units of g/mol (g·mol-1). Procedures for analyzing polymers and determining molecular weights thereof are specified below.

An “olefin,” alternatively referred to as “alkene,” is a linear, branched, or cyclic compound of carbon and hydrogen having at least one carbon-carbon double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically. An “ethylene polymer” or “ethylene copolymer” is a polymer or copolymer comprising at least 50 mol % ethylene derived units, a “propylene polymer” or “propylene copolymer” is a polymer or copolymer comprising at least 50 mol % propylene derived units, and so on.

The terms “group,” “radical,” and “substituent” can be used interchangeably herein.

The term “hydrocarbon” refers to a class of compounds having hydrogen bound to carbon, and encompasses saturated hydrocarbon compounds, unsaturated hydrocarbon compounds, and mixtures of hydrocarbon compounds (saturated and/or unsaturated), including mixtures of hydrocarbon compounds having different numbers of carbon atoms. The term “C.” refers to hydrocarbon(s) or a hydrocarbyl group having n carbon atom(s) per molecule or group, wherein n is a positive integer. Such hydrocarbon compounds may be one or more of linear, branched, cyclic, acyclic, saturated, unsaturated, aliphatic, and/or aromatic. As used herein, a cyclic hydrocarbon may be referred to as “carbocyclic,” which includes saturated, unsaturated, and partially unsaturated carbocyclic compounds as well as aromatic carbocyclic compounds. The term “heterocyclic” refers to a carbocyclic ring containing at least one ring heteroatom.

The terms “hydrocarbyl radical,” “hydrocarbyl group,” or “hydrocarbyl” can be used interchangeably and are defined to mean a group consisting of hydrogen and carbon atoms only and bearing at least one unfilled valence position when removed from a parent compound. Preferred hydrocarbyls are C₁-C₁₀₀ radicals that may be linear, cyclic, or branched. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, and/or the like. The term “hydrocarbyl group having 1 to about 100 carbon atoms,” for example, may refer to a moiety selected from a linear or branched C₁-C₁₀₀ alkyl or a C₃-C₁₀₀ cycloalkyl.

The term “optionally substituted” means that a hydrocarbon or hydrocarbyl group can be unsubstituted or substituted. For example, the term “optionally substituted hydrocarbyl” refers to replacement of at least one hydrogen atom or carbon atom in a hydrocarbyl group with a heteroatom or heteroatom functional group. Unless otherwise specified as being expressly unsubstituted, any of the hydrocarbyl groups herein may be optionally substituted. The term “substituted” further means that at least one hydrogen atom has been replaced with at least a non-hydrogen group, such as a hydrocarbyl group, a heteroatom, or a heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently hydrogen, a hydrocarbyl, or a halocarbyl radical, or two or more R* may join together to form a substituted or unsubstituted, saturated, unsaturated, partially unsaturated, or aromatic cyclic or polycyclic ring structure, or where at least one heteroatom has been inserted within a ring structure.

Cyclopentadiene and fused cyclopentadienes (e.g., indene, tetrahydroindene, fluorene, indacene, cyclopenta[b]naphthalene, heterocyclopentanaphthalene, heterocyclopentaindene, and the like) may complex a metal atom through R-bonding. Substituted cyclopentadienyl, indenyl, tetrahydroindenyl, fluorenyl, indacenyl, cyclopenta[b]naphthalenyl, heterocyclopentanaphthalenyl, heterocyclopentaindenyl groups are those in which at least one hydrogen atom has been replaced with at least a non-hydrogen group, such as a hydrocarbyl group, a heteroatom, or a heteroatom-containing group, such as halogen (e.g., F, Cl, Br, I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently hydrogen, a hydrocarbyl, or halocarbyl radical, or two or more R* may join together to form a substituted or unsubstituted, saturated, unsaturated, partially unsaturated, or aromatic cyclic or polycyclic ring structure, or where at least one heteroatom has been inserted within a ring structure.

Halocarbyl radicals (also referred to as halocarbyls, halocarbyl groups or halocarbyl substituents) are radicals in which one or more hydrocarbyl hydrogen atoms have been substituted with at least one halogen (e.g., F, Cl, Br, I) or halogen-containing group. Substituted halocarbyl radicals are radicals in which at least one halocarbyl hydrogen or halogen atom has been substituted with at least one functional group such as NR*₂, OR*, SeR*, TeR*, PR*₂, AsR*₂, SbR*₂, SR*, BR*₂, SiR*₃, GeR*₃, SnR*₃, PbR*₃, and the like or where at least one non-carbon atom or group has been inserted within the halocarbyl radical such as —O—, —S—, —Se—, —Te—, —N(R*)—, =N—, —P(R*)—, =P—, —As(R*)—, ═As—, —Sb(R*)—, =Sb—, —B(R*)—, =B—, —Si(R*)₂—, —Ge(R*)₂—, —Sn(R*)₂—, —Pb(R*)₂— and the like, where R* is independently hydrogen, a hydrocarbyl, or halocarbyl radical provided that at least one halogen atom remains on the original halocarbyl radical. Additionally, two or more R* may join together to form a substituted or unsubstituted, saturated, unsaturated, partially unsaturated, or aromatic cyclic or polycyclic ring structure.

Hydrocarbylsilyl groups, also referred to as silylcarbyl groups, are radicals in which one or more hydrocarbyl hydrogen atoms have been substituted with at least one SiR*₃ containing group or where at least one —Si(R*)₂— has been inserted within the hydrocarbyl radical where R* is independently hydrogen, a hydrocarbyl or halocarbyl radical, or two or more R* may join together to form a substituted or unsubstituted, saturated, unsaturated, partially unsaturated, or aromatic cyclic or polycyclic ring structure. Silylcarbyl radicals can be bonded via a silicon atom or a carbon atom.

Substituted silylcarbyl radicals are silylcarbyl radicals in which at least one hydrogen atom has been substituted with at least one functional group such as NR*₂, OR*, SeR*, TeR*, PR*₂, AsR*₂, SbR*₂, SR*, BR*₂, GeR*₃, SnR*₃, PbR₃ and the like or where at least one non-hydrocarbon atom or group has been inserted within the silylcarbyl radical, such as —O—, —S—, —Se—, —Te—, —N(R*)—, ═N—, —P(R*)—, =P—, —As(R*)—, ═As—, —Sb(R*)—, =Sb—, —B(R*)—, =B—, —Ge(R*)₂—, —Sn(R*)₂—, —Pb(R*)₂— and the like, where R* is independently hydrogen, a hydrocarbyl, or halocarbyl radical, or two or more R* may join together to form a substituted or unsubstituted, saturated, unsaturated, partially unsaturated, or aromatic cyclic or polycyclic ring structure.

Germylcarbyl radicals (also referred to as germylcarbyls, germylcarbyl groups or germylcarbyl substituents) are radicals in which one or more hydrocarbyl hydrogen atoms have been substituted with at least one GeR*₃ containing group or where at least one —Ge(R*)₂— has been inserted within the hydrocarbyl radical where R* is independently hydrogen, a hydrocarbyl or halocarbyl radical, or two or more R* may join together to form a substituted or unsubstituted, saturated, unsaturated, partially unsaturated, or aromatic cyclic or polycyclic ring structure. Germylcarbyl radicals can be bonded via a germanium atom or a carbon atom.

Substituted germylcarbyl radicals are germylcarbyl radicals in which at least one hydrogen atom has been substituted with at least one functional group such as NR*₂, OR*, SeR*, TeR*, PR*₂, AsR*₂, SbR*₂, SR*, BR*₂, SiR*₃, SnR*₃, PbR₃ and the like or where at least one non-hydrocarbon atom or group has been inserted within the germylcarbyl radical, such as —O—, —S—, —Se—, —Te—, —N(R*)—, ═N—, —P(R*)—, =P—, —As(R*)—, ═As—, —Sb(R*)—, =Sb—, —B(R*)—, ═B—, —Si(R*)₂—, —Sn(R*)₂—, —Pb(R*)₂— and the like, where R* is independently hydrogen, a hydrocarbyl or halocarbyl radical, or two or more R* may join together to form a substituted or unsubstituted, saturated, unsaturated, partially unsaturated, or aromatic cyclic or polycyclic ring structure.

The terms “alkyl radical,” and “alkyl” are used interchangeably throughout this application. For purposes of this application, “alkyl radicals” are defined to be C₁-C₁₀₀ saturated hydrocarbyl groups that may be linear, branched, or cyclic. Examples of such radicals can include, for instance, methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, and the like. Substituted alkyl radicals are radicals in which at least one hydrogen atom of the alkyl radical has been substituted with at least a non-hydrogen group, such as a hydrocarbyl group, a heteroatom, or a heteroatom-containing group, such as halogen (F, Cl, Br, I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently hydrogen, a hydrocarbyl or halocarbyl radical, or two or more R* may join together to form a substituted or unsubstituted, saturated, unsaturated, partially unsaturated, or aromatic cyclic or polycyclic ring structure, or where at least one heteroatom has been inserted within a hydrocarbyl ring.

The term “branched alkyl” means that the alkyl group contains a tertiary or quaternary carbon (a tertiary carbon is a carbon atom bound to three other carbon atoms; a quaternary carbon is a carbon atom bound to four other carbon atoms). For example, 3,5,5-trimethylhexylphenyl is an alkyl group (hexyl) having three methyl branches (hence, one tertiary and one quaternary carbon) and thus is a branched alkyl bound to a phenyl group.

The term “alkoxy,” “alkoxyl,” or “alkoxide” mean an alkyl group bound to an oxygen atom, such as an alkyl ether or aryl ether group/radical and can include those where the alkyl group is a C₁ to C₁₀ hydrocarbyl. The alkyl group may be straight chain, branched, or cyclic. The alkyl group may be saturated or unsaturated. Examples of alkoxy groups and radicals can include methoxy, ethoxy, n-propoxy, iso-propoxy, n-butoxy, iso-butoxy, sec-butoxy, tert-butoxy, and the like.

The term “aryloxy” or “aryloxide” means an aryl group bound to an oxygen atom, such as an aryl ether group/radical wherein the term aryl is as defined herein. Examples of aryloxy radicals can include phenoxyl, and the like.

The term “aryl” or “aryl group” means a carbon-containing aromatic ring such as phenyl group or fused phenyl group. Likewise, the term “heteroaryl” means an aryl group where a ring carbon atom (or two or three ring carbon atoms) has been replaced with a heteroatom, such as N, O, or S. Aryl and heteroaryl groups are aromatic. As used herein, the term “aromatic” also refers to pseudoaromatic heterocycles, which are heterocyclic substituents that have similar properties and structures (nearly planar) to aromatic heterocyclic ligands, but are not by definition aromatic. Aromatic (but not pseudoaromatic) hydrocarbons obey the Hückel Rule and contain a cyclic cloud of 4n+2 π-electrons, where n is a positive integer.

A substituted aryl is an aryl group where at least one hydrogen atom of the aryl radical has been substituted with at least a non-hydrogen group, such as a hydrocarbyl group, a heteroatom, or a heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently hydrogen, a hydrocarbyl or halocarbyl radical, or two or more R* may join together to form a substituted or unsubstituted, saturated, unsaturated, partially unsaturated, or aromatic cyclic or polycyclic ring structure, or where at least one heteroatom has been inserted within a hydrocarbyl ring. For example, 3,5-dimethylphenyl and 2-methylphenyl are substituted aryl groups. The term “arylalkyl” may also refer to an aryl group where a hydrogen has been replaced with an alkyl or substituted alkyl group. The term “alkylaryl” means an alkyl group where a hydrogen has been replaced with an aryl or substituted aryl group. Thus, for example, 2-methylphenyl is an arylalkyl or substituted aryl group, and benzyl and phenethyl are arylalkyl groups.

The term “substituted phenyl,” or “substituted phenyl group” means a phenyl group having one or more hydrogen groups replaced by a hydrocarbyl, substituted hydrocarbyl, heteroatom or heteroatom-containing group, such as halogen (F, Cl, Br, I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently hydrogen, a hydrocarbyl, halogen, or halocarbyl radical, or two or more R* may join together to form a substituted or unsubstituted, saturated, unsaturated, partially unsaturated, or aromatic cyclic or polycyclic ring structure, or where at least one heteroatom has been inserted within a hydrocarbyl ring.

Heterocyclic means a cyclic group where a ring carbon atom (or two or three ring carbon atoms) has been replaced with a heteroatom, such as N, O, or S. A heterocyclic ring is a ring having a heteroatom in the ring structure as opposed to a heteroatom-substituted ring where a hydrogen on a ring atom is replaced with a heteroatom. For example, tetrahydrofuran is a heterocyclic ring, and 4-N,N-dimethylaminophenyl is a heteroatom-substituted ring.

Substituted heterocyclic means a heterocyclic group where at least one hydrogen atom of the heterocyclic radical has been substituted with at least a non-hydrogen group, such as a hydrocarbyl group, a heteroatom, or a heteroatom-containing group, such as halogen (F, Cl, Br, I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently hydrogen, a hydrocarbyl or halocarbyl radical.

The term “ring atom” means an atom that is part of a cyclic ring structure. Accordingly, a benzyl group has 6 ring atoms, a phenyl group has 6 ring atoms, and tetrahydrofuran has 5 ring atoms.

Reference to group without specifying a particular isomer (e.g., butyl) expressly discloses all possible isomers (e.g., n-butyl, isobutyl, sec-butyl, tert-butyl, cyclobutyl, and methylcyclopropyl), unless otherwise indicated.

A “catalyst system” is a combination of at least one catalyst compound (e.g., at least one metallocene), at least one activator, an optional co-activator, and an optional support material. When “catalyst system” is used to describe such a pair before activation, it means the unactivated catalyst compound (precatalyst) together with an activator and, optionally, a co-activator. When it is used to describe such a pair after activation, it means the activated complex and the activator or other charge-balancing moiety. For the purposes of this disclosure and the claims thereto, when catalyst systems are described as comprising neutral stable forms of the components, it is well understood by one of ordinary skill in the art, that the ionic form of the component is the form that reacts with the monomers to produce polymers.

“Complex” or “metal-ligand complex,” as used herein, may also be referred to interchangeably herein as catalyst precursor, precatalyst, catalyst, catalyst compound, transition metal compound, or transition metal complex. Any of these terms may refer to a metallocene herein.

An “anionic ligand,” as used herein, is a negatively charged ligand which donates one or more pairs of electrons to a metal atom. A “neutral donor ligand” or “neutral ligand,” as used herein, is a neutrally charged ligand which donates one or more pairs of electrons to a metal atom.

The term “metallocene,” as used herein, is an organometallic compound with at least one π-bound cyclopentadienyl moiety or substituted cyclopentadienyl moiety (such as substituted or unsubstituted cyclopentadienyl (Cp) and/or indenyl (Ind)) and more frequently two (or three) π-bound cyclopentadienyl moieties or substituted cyclopentadienyl moieties.

The following abbreviations may be used herein: Me is methyl, Et is ethyl, Pr is propyl, cPR is cyclopropyl, nPr is n-propyl, iPr is isopropyl, Bu is butyl, nBu is normal butyl, iBu is isobutyl, sBu is sec-butyl, tBu is tert-butyl, hex is hexyl, oct is octyl, Ph is phenyl, MAO is methylalumoxane, dme is 1,2-dimethoxyethane, p-tBu is para-tertiary butyl, TMS is trimethylsilyl, TIBAL is triisobutylaluminum, TNOAL is tri(n-octyl)aluminum, p-Me is para-methyl, Bz and Bn are benzyl (i.e., CH₂Ph), THF (also referred to as thf) is tetrahydrofuran, RT is room temperature (and is 23° C. unless otherwise indicated), tol is toluene, EtOAc is ethyl acetate, Cbz is Carbazole, and Cy is cyclohexyl.

“Catalyst productivity” is a measure of the mass of polymer produced using a known quantity of polymerization catalyst. Typically, “catalyst productivity” is expressed in units of (g of polymer)/(g of catalyst) or (g of polymer)/(mmols of catalyst) or the like. If units are not specified, then the “catalyst productivity” is in units of (g of polymer)/(grams of catalyst). For calculating catalyst productivity, only the weight of the transition metal component of the catalyst is used (i.e., the activator and/or co-catalyst is omitted). “Catalyst activity” is a measure of the mass of polymer produced using a known quantity of polymerization catalyst per unit time for batch and semi-batch polymerizations. For calculating catalyst activity, only the weight of the transition metal component of the catalyst is used (i.e., the activator and/or co-catalyst is omitted). Typically, “catalyst activity” is expressed in units of (g of polymer)/(mmol of catalyst)/hour or (kg of polymer)/(mmols of catalyst)/hour or the like. If units are not specified, then the “catalyst activity” is in units of (g of polymer)/(mmol of catalyst)/hour.

“Conversion” is the percentage of a monomer that is converted to polymer product in a polymerization and is calculated based on the polymer yield, the polymer composition, and the amount of monomer fed into the reactor.

### Ligands and Metallocene Complexes

The metallocenes described herein are asymmetric with C₁ symmetry, meaning the catalysts have no planes of symmetry about any axis. This asymmetry is advantageous as no isomers (rac/meso) are formed, thereby providing a much higher yield of metallocenes per unit of starting material compared to metallocenes that are symmetric but are capable of forming optical isomers. That is, metallocenes having C₁ symmetry may be advantageous in terms of subverting the need to separate optical isomers of the complex prior to polymerization. Additionally, some of the metallocenes described herein can provide isotactic propylene homopolymers (iPP), which is surprising given the asymmetry of the metallocene, as well as in-reactor long-chain branched copolymers when paired with a metallocene capable of promoting incorporation of vinyl-terminated macromonomers. It has been surprisingly discovered that an adamantyl or similar bulky alkyl group in the 4-position of an indacenyl ring system attached to a Group 4 transition metal may accomplish the foregoing as well as promote predominately vinyl termination of the resulting polymer. Relative to other types of metallocenes, metallocene catalysts based on bridged tetramethyl cyclopentadienyl/4-adamantyl-indacenyl ligands (or having a similar bulky alkyl substituent at the 4-position) may produce substantially lower amounts of vinylene and trisubstituted olefins in the polymerized reaction product. The resulting vinyl-terminated polymers may be further polymerized in the presence of a second metallocene, such as a C₂ symmetric metallocene or a pseudo-C₂ symmetric metallocene, to introduce long-chain branching within a higher molecular weight polymer.

Other bridged metallocenes similar to the foregoing may instead feature an aryl group at the 4-position of a substituted indacenyl ring system. Such metallocenes may promote efficient formation of ethylene copolymers having high molecular weights, such as ethylene-propylene random copolymers, or copolymers of ethylene with a higher alpha-olefin (e.g., a C₄-C₁₂ hydrocarbon having a terminal carbon-carbon double bond). The production of higher molecular weight polymers with such C₁ symmetric metallocenes is surprising in view of the tendency of other C₁ symmetric metallocenes to produce polymers of considerably lower molecular weight. In addition, aryl group substitution in the 4-position may also promote efficient production of vinyl-terminated polymers in some instances.

Any of the metallocenes provided herein can be supported or unsupported. Such metallocenes also can be used in combination with a second metallocene to produce long-chain branched polypropylenes (LCB-PPs). Suitable examples of second metallocenes that may be utilized in combination with a first metallocene having C₁ symmetry are discussed in further detail below.

In general, bridged metallocenes suitable for use in relation to the foregoing may have a structure represented by Formula 1

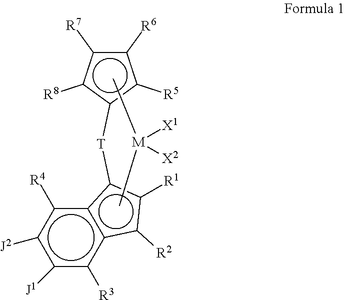

wherein:
M is a transition metal of Group 3, 4, or 5 of the Periodic Table of Elements, such as a Group 4 metal, for example Zr, Hf, or Ti;
T is a bridging group;
each of X¹ and X² is a univalent anionic ligand, or X¹ and X² are joined to form a metallocycle ring, a chelating ligand, a diene ligand, or an alkyidene;
R¹ is hydrogen, halogen, optionally C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, where R″ is C₁-C₁₀ alkyl and each R′ is hydrogen, C₁-C₁₀ alkyl, or C₆-C₁₀ aryl;
R², R³, and R⁴ are independently hydrogen, halogen, optionally substituted C₁-C₄₀ alkyl, optionally substituted C₆-C₁₄ aryl, an optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and each R′ is hydrogen, C₁-C₁₀ alkyl, or C₆-C₁₀ aryl; preferably, R³ is C₁-C₄₀ alkyl or optionally substituted C₆-C₁₄ aryl;
more preferably, R³ is a bulky alkyl group, such as optionally substituted cyclohexyl, optionally substituted norbornanyl, optionally substituted adamantanyl, or optionally substituted tert-butyl, such as cyclohexyl, 1-adamantyl, 2-adamantyl, (1s,4s)-bicyclo[2.2.1]heptan-7-yl, (1R,4S)-bicyclo[2.2.1]heptan-2-yl, or (1s,4s)-bicyclo[2.2.1]heptan-1-yl;
more preferably, R³ is an optionally substituted aryl group, still more preferably an optionally substituted phenyl group;
R⁵, R⁶, R⁷, and R⁸ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and each R′ is hydrogen, C₁-C₁₀ alkyl, or C₆-C₁₀ aryl, or one or more of R⁵ and R⁶, R⁶ and R⁷, or R⁷ and R⁸ are joined to form a C₃-C₆₂ substituted or unsubstituted, saturated or unsaturated, cyclic or polycyclic ring structure, or a combination thereof, preferably a C₅-C₈ substituted or unsubstituted, saturated or unsaturated, cyclic or polycyclic ring structure, or a combination thereof; and
J¹ and J² are each H, or J¹ and J² are joined to form a C₃-C₆₂ (alternately C₅-C₆₂, alternately C₅-C₄₀, alternately C₆ to C₃₀, alternately C₆ to C₂₀, or alternately C₅ to C₈) substituted or unsubstituted, saturated or unsaturated (including aromatic), cyclic or polycyclic ring structure, or a combination thereof, provided that J¹ and J² together with the two carbons they are bound to on the indenyl group form at least one saturated ring; preferably, J¹ and J² together with the two carbons they are bound to on the indenyl group form at least one 5- or 6-membered saturated ring.

As a non-limiting illustration, in Formula 1 the phrase “J¹ and J² together with the two carbons they are bound on the indenyl group” refers to the J¹ and J² groups and the carbon atoms in the box in the formula shown in Scheme 1 below. Preferably, the atoms in the box form a 5- or 6-membered saturated ring. For example, an indacenyl ligand contains such a saturated 5-membered ring and a hexahydrobenz[f]indenyl ligand contains such a saturated 6-membered ring. More preferably, the atoms in the box define a 5-membered saturated ring (i.e., an indacenyl ligand).

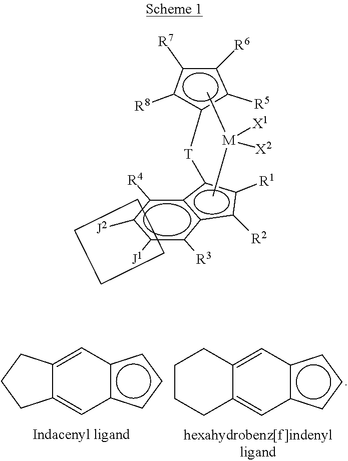

The unsaturated ring in the indacenyl ligand and the hexahydrobenz[f]indenyl ligand can be substituted or unsubstituted and can be part of multi-cyclic groups where the additional cyclic groups may be saturated or unsaturated, and substituted or unsubstituted. Typical substituents on the unsaturated ring may include optionally substituted C₁ to C₄₀ hydrocarbyl groups, heteroatoms (such as halogens, such as Br, F, Cl, or I), heteroatom-containing groups (such as a halocarbyl), or two or more substituents are joined together to form a cyclic or polycyclic ring structure (which may contain saturated and/or unsaturated rings), or a combination thereof.

In some embodiments of the present disclosure, J¹ and J² can be joined to form an unsubstituted C₄-C₃₀ (alternately C₅-C₃₀, alternately C₆-C₂₀, or alternately C₅ or C₆) cyclic or polycyclic ring, any of which may be saturated, partially saturated, or unsaturated. Examples include structures represented by Formulas 2-4:

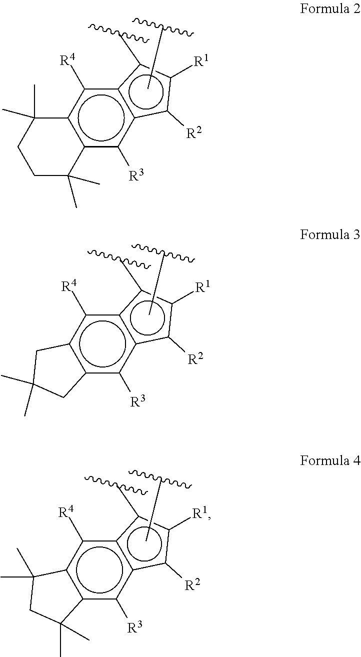

where the wavy lines indicate connection to M (such as Hf or Zr) and T (such as Me₂Si). In any of the foregoing, R³ may be a bulky alkyl group, preferably an optionally substituted cyclohexyl, optionally substituted norbornanyl, optionally substituted adamantyl, or optionally substituted tert-butyl, or an optionally substituted aryl group, preferably an optionally substituted phenyl group.

In some embodiments of the present disclosure, X¹ and X² are independently an optionally substituted C₁-C₄₀ alkyl (such as an optionally substituted C₂-C₂₀ alkyl), an optionally substituted C₆-C₁₄ aryl (such as an optionally substituted phenyl group), an optionally substituted C₃-C₁₃ heteroaryl, hydride, amide, alkoxide, sulfide, phosphide, halide, diene, amine, phosphine, ether, or a combination thereof. For example, each of X¹ and X² may be independently a halide, or a C₁-C₆ alkyl or a C₁-C₁₀ alkyl, such as methyl. In some embodiments, X¹ and X² are independently chloro, bromo, methyl, ethyl, propyl, butyl, pentyl, hexyl, heptyl, octyl, nonyl, decyl, undecyl, or dodecyl. In some embodiments of the present disclosure, X¹ and X² may form a part of a fused ring or a ring system, which may define a metallocycle, a chelating ligand, or a diene ligand bound to M.

In some embodiments, T is represented by the formula, (R*₂G)_{g}, wherein G is independently C, Si, or Ge, g is 1 or 2, and each R* is, independently, hydrogen, halogen, optionally substituted C₁-C₂₀ hydrocarbyl (such as methyl, ethyl, propyl, butyl, pentyl, hexyl, heptyl, octyl, nonyl, decyl, undecyl, dodecyl, or phenyl), or the two or more R* are joined to form a C₃-C₆₂ (alternately C₄-C₆₂, alternately C₄-C₂₀, alternately C₄-C₁₀, or alternately C₄-C₆) substituted or unsubstituted, saturated or unsaturated (including aromatic), cyclic or polycyclic ring structure. In some embodiments, the bridging group may be represented by R′₂C, R′₂Si, R′₂Ge, R′₂CCR′₂, R′₂CCR′₂CR′₂, R′₂CCR′₂CR′₂CR′₂, R′C═CR′, R′C═CR′CR′₂, R′₂CCR′═CR′CR′₂, R′C═CR′CR′═CR′, R′C═CR′CR′₂CR′₂, R′₂CSiR′₂, R′₂SiSiR′₂, R₂CSiR′₂CR′₂, R′₂SiCR′₂SiR′₂, R′C═CR′SiR′₂, R′₂CGeR′₂, R′₂GeGeR′₂, R′₂CGeR′₂CR′₂, R′₂GeCR′₂GeR′₂, R′₂SiGeR′₂, R′C═CR′GeR′₂, R′B, R′₂C—BR′, R′₂C—BR′—CR′₂, R′₂C—O—CR′₂, R′₂CR′₂C—O—CR′₂CR′₂, R′₂C—O—CR′₂CR′₂, R′₂C—O—CR′═CR′, R′₂C—S—CR′₂, R′₂CR′₂C—S—CR′₂CR′₂, R′₂C—S—CR′₂CR′₂, R′₂C—S—CR′═CR′, R′₂C—Se—CR′₂, R′₂CR′₂C—Se—CR′₂CR′₂, R′₂C—Se—CR₂CR′₂, R′₂C—Se—CR′═CR′, R′₂C—N═CR′, R′₂C—NR′—CR′₂, R′₂C—NR′—CR′₂CR′₂, R′₂C—NR′—CR′═CR′, R′₂CR′₂C—NR′—CR′₂CR′₂, R′₂C—P═CR′, or R′₂C—PR′—CR′₂ where each R′ is independently hydrogen or optionally substituted C₁-C₂₀ hydrocarbyl (such as methyl, ethyl, propyl, butyl, pentyl, hexyl, heptyl, octyl, nonyl, decyl, undecyl, dodecyl, or phenyl), C₁-C₂₀ halocarbyl, C₁-C₂₀ silylcarbyl, or C₁-C₂₀ germylcarbyl, or two or more adjacent R′ are joined to form a C₃-C₆₂ (alternately C₄-C₆₂, alternately C₄-C₂₀, alternately C₄-C₁₀, or alternately C₄-C₆) substituted or unsubstituted, saturated or unsaturated, cyclic or polycyclic ring structure. In some embodiments of the present disclosure, T may be CH₂, CH₂CH₂, C(CH₃)₂, (Ph)₂C, (p-(Et)₃SiPh)₂C, SiMe₂, SiPh₂, SiMePh, Si(CH₂)₃, or Si(CH₂)₄.

In some embodiments, suitable alkyl groups in any selection herein may be independently chosen from, but not limited to, methyl, ethyl, and isomers of propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, and triacontyl.

In some embodiments, suitable aryl groups in any selection herein may be independently chosen from, but not limited to, phenyl, methylphenyl, dimethylphenyl, ethylphenyl, diethylphenyl, propylphenyl, dipropylphenyl, butylphenyl, naphthyl, methylnaphthyl, dibutylphenylnaphthyl, and anthracenyl.

In some embodiments, suitable cycloalkyl groups in any selection herein may be chosen from, but not limited to, cyclopropyl, cyclobutyl, cyclopentyl, cyclohexyl, methylcyclohexyl, cycloheptyl, norbornanyl, adamantyl and the like.

In more specific examples, metallocenes having a structure represented by Formula 1 and having alkyl substitution at R³ may include variables defined in accordance with the following:
M is a Group 4 metal, preferably zirconium or hafnium;
T is a bridging group; preferably CR⁹R¹⁰ or SiR⁹R¹⁰, wherein R⁹ and R¹⁰ are independently hydrogen, optionally substituted C₁-C₄₀ alkyl or optionally substituted C₆-C₁₄ aryl, or R⁹ and R¹⁰ are joined to form a C₃-C₆₂ substituted or unsubstituted, saturated or unsaturated, cyclic or polycyclic ring structure; more preferably, T is CH₂, CH₂CH₂, C(CH₃)₂, (Ph)₂C, (p-(Et)₃SiPh)₂C, SiMe₂, SiPh₂, SiMePh, Si(CH₂)₃, Si(CH₂)₄, or Si(CH₂)₄;
X¹ and X² are each a univalent anionic ligand, or X¹ and X² are joined to form a metallocycle ring, a chelating ligand, a diene ligand, or an alkylidene, preferably X¹ and X² are independently a halide (F, Cl, Br, I) or C₁-C₆ hydrocarbyl, such as a C₁-C₆ alkyl or phenyl, more preferably methyl;
R¹ is hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl; preferably, R¹ is C₁-C₁₀ alkyl; more preferably R¹ is methyl;
R², R³, and R⁴ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl; preferably R³ is optionally substituted C₁-C₄₀ alkyl or optionally substituted C₆-C₁₄ aryl; more preferably, R² and R⁴ are H, and R³ is a bulky alkyl group, preferably optionally substituted cyclohexyl, optionally substituted norbornanyl, optionally substituted adamantyl (e.g., 1-adamantyl, 2-adamantyl, (1s,4s)-bicyclo[2.2.1]heptan-7-yl, (1R,4S)-bicyclo[2.2.1]heptan-2-yl, (1s,4s)-bicyclo[2.2.1]heptan-1-yl), or optionally substituted t-butyl;
R⁵, R⁶, R⁷, and R⁸ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl, or one or more of R⁵ and R⁶, R⁶ and R⁷, or R⁷ and R⁸ are joined to form a C₃-C₆₂ substituted or unsubstituted, saturated or unsaturated, cyclic or polycyclic ring structure, or a combination thereof; preferably R⁵, R⁶, R⁷, and R⁸ are each C₁-C₁₀ alkyl; more preferably R⁵, R⁶, R⁷, and R⁸ are each methyl; and
J¹ and J² are each H, or J¹ and J² are joined to form a C₃-C₆₂ substituted or unsubstituted, saturated or unsaturated, cyclic or polycyclic ring structure, or a combination thereof, preferably containing a five- or six-membered ring.

Accordingly, in some embodiments, metallocenes of the present disclosure having a bulky alkyl group at R³ may have a structure represented by Formula 5

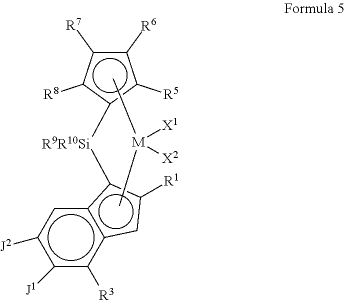

wherein:
M is a Group 4 metal, preferably Zr or Hf;
X¹ and X² are independently a halide (F, Cl, Br, I) or a C₁-C₆ alkyl; preferably X¹ and X² are each chloride or methyl;
R¹ is C₁-C₁₀ alkyl group, preferably methyl;
R³ is a bulky alkyl group, preferably optionally substituted cyclohexyl, optionally substituted norbornanyl, optionally substituted adamantyl, or optionally substituted t-butyl; preferably bulky alkyl groups include 1-adamantyl, 2-adamantyl, (1s,4s)-bicyclo[2.2.1]heptan-7-yl, (1R,4S)-bicyclo[2.2.1]heptan-2-yl, and (1s,4s)-bicyclo[2.2.1]heptan-1-yl;
R⁹ and R¹⁰ are independently optionally substituted C₁-C₁₀ alkyl or optionally substituted C₆-C₁₀ aryl, or R⁹ and R¹⁰ are joined to form a C₃-C₂₂ (alternately C₃-C₁₀, alternately C₃-C₆) substituted or unsubstituted, saturated or unsaturated, cyclic or polycyclic ring structure; more preferably, R⁹ and R¹⁰ are each methyl;
R⁵, R⁶, R⁷, and R⁸ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl, or one or more of R⁵ and R⁶, R⁶ and R⁷, or R⁷ and R⁸ are joined to form a C₃-C₆₂ (alternately C₃-C₁₀, alternately C₃-C₆, alternately C₅ or C₆) substituted or unsubstituted, saturated or unsaturated, cyclic or polycyclic ring structure, or a combination thereof; preferably, R⁵, R⁶, R⁷, and R⁸ are each C₁-C₁₀ alkyl; more preferably, R⁵, R⁶, R⁷, and R⁸ are each methyl; and
J¹ and J² are each H, or J¹ and J² together with the two carbons they are bound to on the indenyl group form a 5-membered saturated ring, which may be optionally substituted with one to six C₁-C₆ alkyl groups.

In still more specific examples, metallocenes having a bulky alkyl group at R³ may have a structure represented by Formula 6

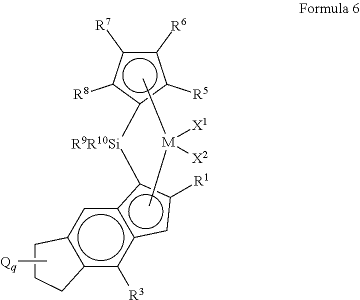

wherein:
Q is an optional C₁-C₆ alkyl group, and q is 0, 1, 2, 3, 4, 5, or 6. When present (q 0), optional substitution Q may be present at any non-aromatic carbon atom of the 5-membered ring defined by J¹ and J². The other variables in Formula 6 are defined in an identical manner to those specified for Formula 5.

Illustrative examples of metallocenes having a structure represented by Formulas 5 and 6 may include, but are not limited to:

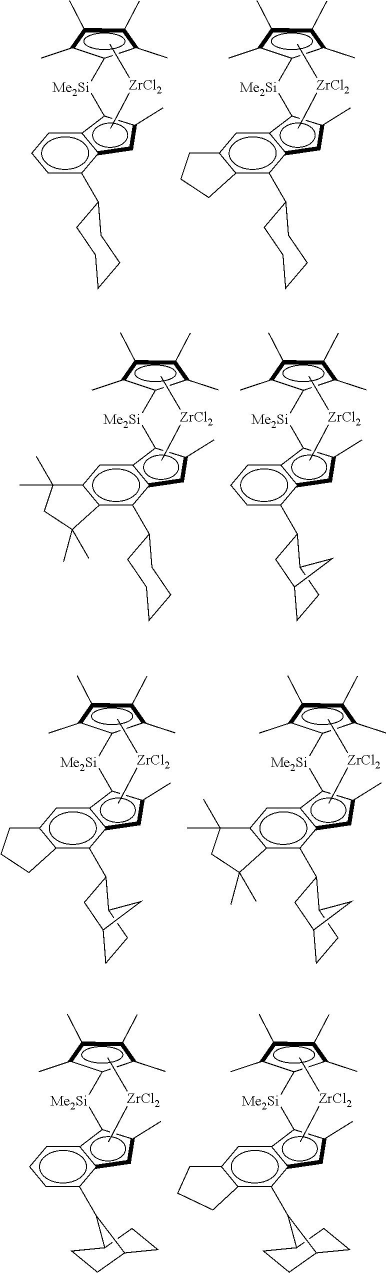

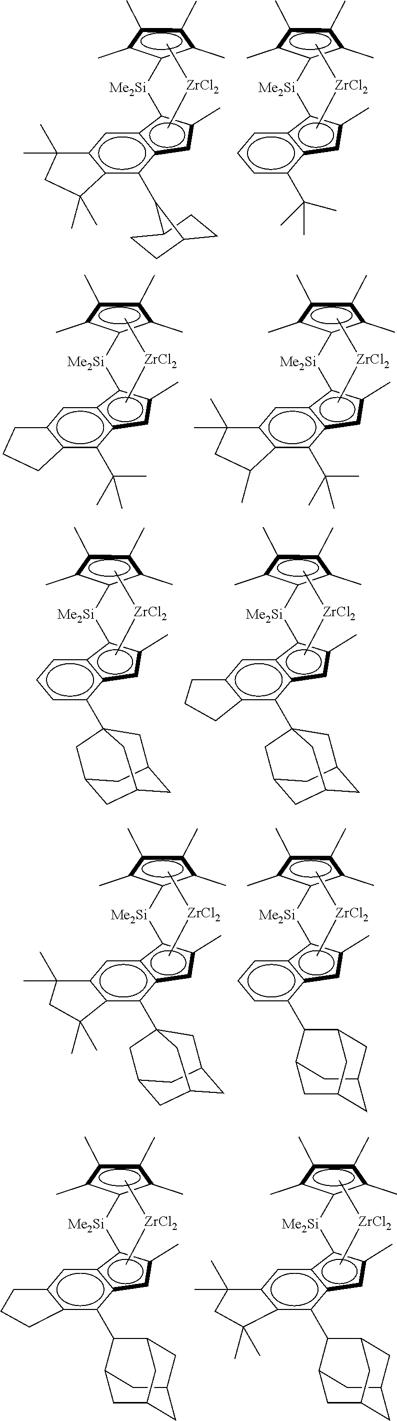

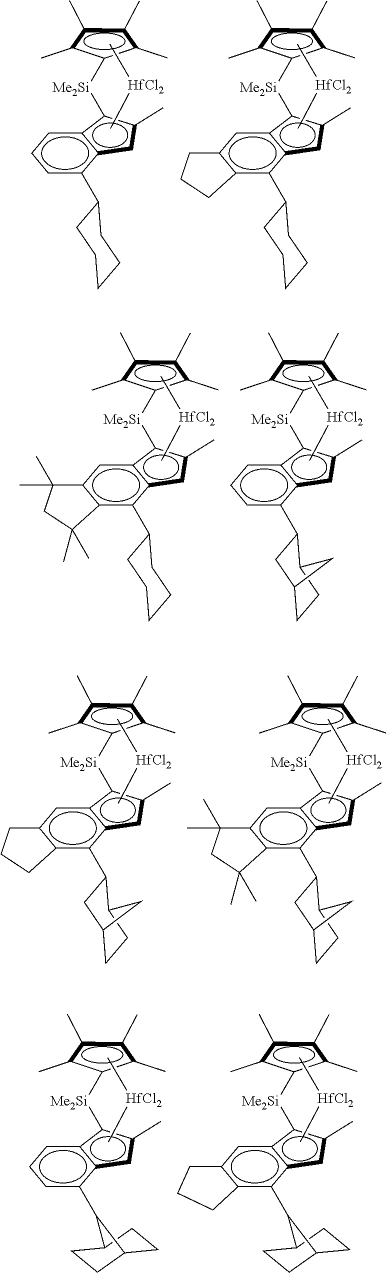

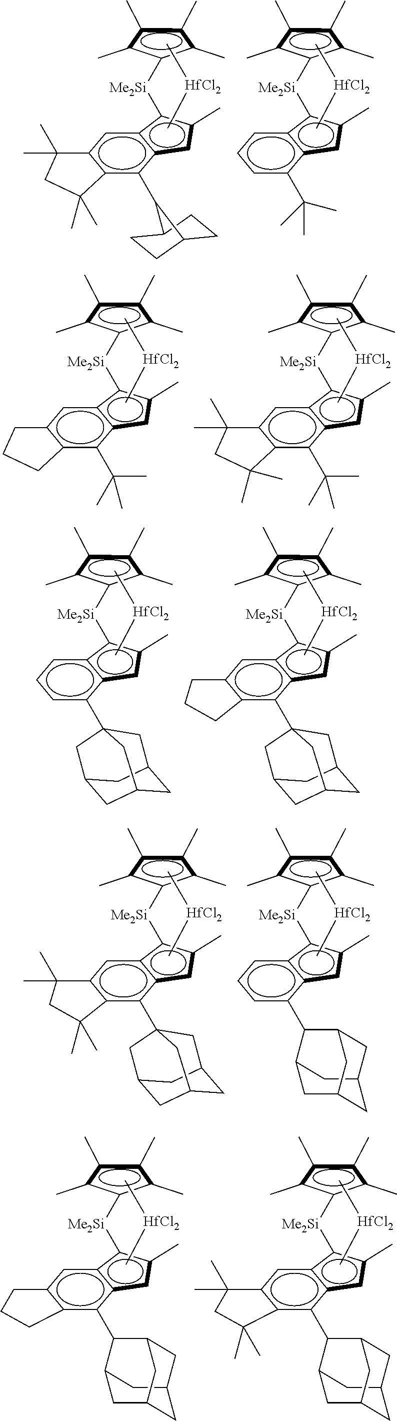

In some embodiments of the present disclosure, R³ may be an optionally substituted aryl group, preferably an optionally substituted phenyl group. Accordingly, in some embodiments, metallocenes of the present disclosure having an aryl group substitution at R³ may have a structure represented by Formula 7

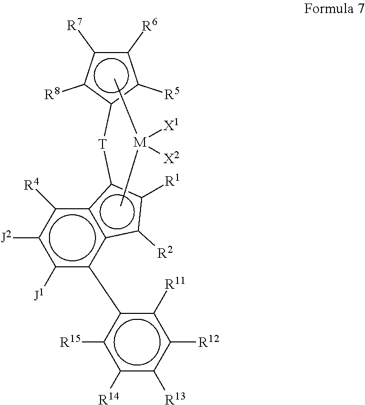

wherein:
R¹, R², R⁴—R⁸, T, X¹, X², J¹ and J² are defined as above for Formula 1, and R¹¹—R¹⁵ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and each R′ is hydrogen, C₁-C₁₀ alkyl, or C₆-C₁₀ aryl, or R¹¹ and R¹², R¹² and R¹³, R¹³ and R¹⁴, or R¹⁴ and R¹⁵, or any combination thereof are joined to form a C₃-C₆₂ substituted or unsubstituted, saturated or unsaturated, cyclic or polycyclic ring structure, or any combination thereof.

In more specific examples, metallocenes having a structure represented by Formula 7 may include variables defined in accordance with the following:
M is a Group 4 metal, preferably zirconium or hafnium;
T is a bridging group; preferably CR⁹R¹⁰ or SiR⁹R¹⁰, wherein R⁹ and R¹⁰ are independently hydrogen, optionally substituted C₁-C₄₀ alkyl, or optionally substituted C₆-C₁₄ aryl, or R⁹ and R¹⁰ are joined to form a C₃-C₂₂ (alternately C₃-C₁₀, alternately C₃-C₆) substituted or unsubstituted, saturated or unsaturated, cyclic or polycyclic ring structure, or a combination thereof; more preferably, T is CH₂, CH₂CH₂, C(CH₃)₂, (Ph)₂C, (p-(Et)₃SiPh)₂C, SiMe₂, SiPh₂, SiMePh, Si(CH₂)₃, Si(CH₂)₄, or Si(CH₂)₄;
X¹ and X² are each a univalent anionic ligand, or X¹ and X² are joined to form a metallocycle ring, a chelating ligand, a diene ligand, or an alkylidene, preferably X¹ and X² are independently a halide (F, Cl, Br, I) or a C₁-C₆ hydrocarbyl, such as a C₁-C₆ alkyl or phenyl; more preferably, X¹ and X² are methyl or chloride.
R¹ is hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl; preferably R¹ is C₁-C₁₀ alkyl; more preferably R¹ is methyl;
R² and R⁴ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl; preferably R² and R⁴ are hydrogen;
R⁵, R⁶, R⁷, and R⁸ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl, or one or more of R⁵ and R⁶, R⁶ and R⁷, or R⁷ and R⁸ are joined to form a C₃-C₆₂ (alternately C₃-C₁₀, alternately C₃-C₆, alternately C₅ or C₆) substituted or unsubstituted, saturated or unsaturated, cyclic or polycyclic ring structure, or a combination thereof; preferably R⁵, R⁶, R⁷, and R⁸ are each C₁-C₁₀ alkyl; more preferably R⁵, R⁶, R⁷, and R⁸ are each methyl;
R¹¹—R¹⁵ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and each R′ is hydrogen, C₁-C₁₀ alkyl, or C₆-C₁₀ aryl, or R¹¹ and R¹², R¹² and R¹³, R¹³ and R¹⁴, or R¹⁴ and R¹⁵, or any combination thereof are joined to form a C₃-C₆₂ (alternately C₃-C₁₀, alternately C₃-C₆, alternately C₅ or C₆) substituted or unsubstituted, saturated or unsaturated, cyclic or polycyclic ring structure; preferably R¹¹—R¹⁵ are independently hydrogen or C₁-C₁₀ alkyl; and
J¹ and J² are each H, or J¹ and J² together with the two carbons they are bound to on the indenyl group form a 5-membered saturated ring, which may be optionally substituted with one to six C₁-C₆ alkyl groups.

Accordingly, in some embodiments, metallocenes of the present disclosure having an aryl group at R³ may have a structure represented by Formula 8

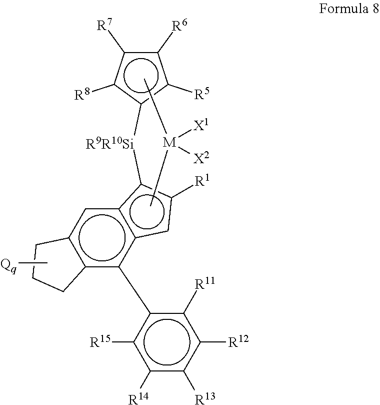

wherein:
M is a Group 4 metal, preferably Zr or Hf;
X¹ and X² are independently a halide (F, Cl, Br, I) or a C₁-C₆ alkyl; preferably X¹ and X² are each chloride or methyl;
R¹ is C₁-C₁₀ alkyl group, preferably methyl;
R⁹ and R¹⁰ are independently optionally substituted C₁-C₄₀ alkyl or optionally substituted C₆-C₁₄ aryl, or R⁹ and R¹⁰ are joined to form a C₃-C₂₂ (alternately C₃-C₁₀, alternately C₃-C₆) substituted or unsubstituted, saturated or unsaturated, cyclic or polycyclic ring structure, or a combination thereof; more preferably R⁹ and R¹⁰ are each methyl;
R¹¹—R¹⁵ are independently hydrogen or C₁-C₁₀ alkyl; and
Q is an optional C₁-C₆ alkyl group, and q is 0, 1, 2, 3, 4, 5, or 6. When present (q 0), optional substitution Q may be present at any non-aromatic carbon atom of the 5-membered ring defined by J¹ and J².

In still more specific examples, metallocenes having aryl group substitution at R³ may have a structure represented by Formula 9

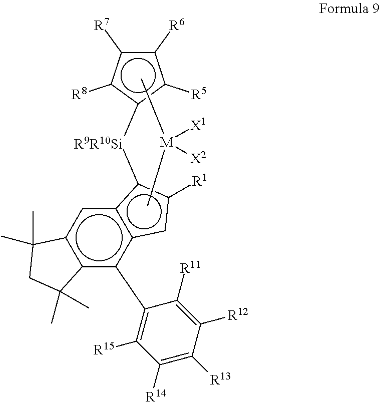

wherein the variables are defined as above for Formula 8.

Illustrative examples of metallocenes having a structure represented by Formula 7 include, but are not limited to:

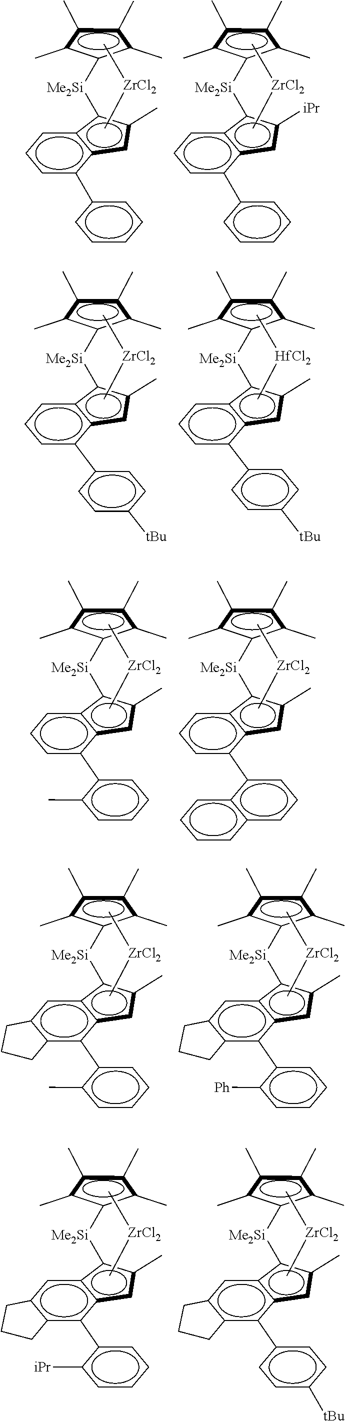

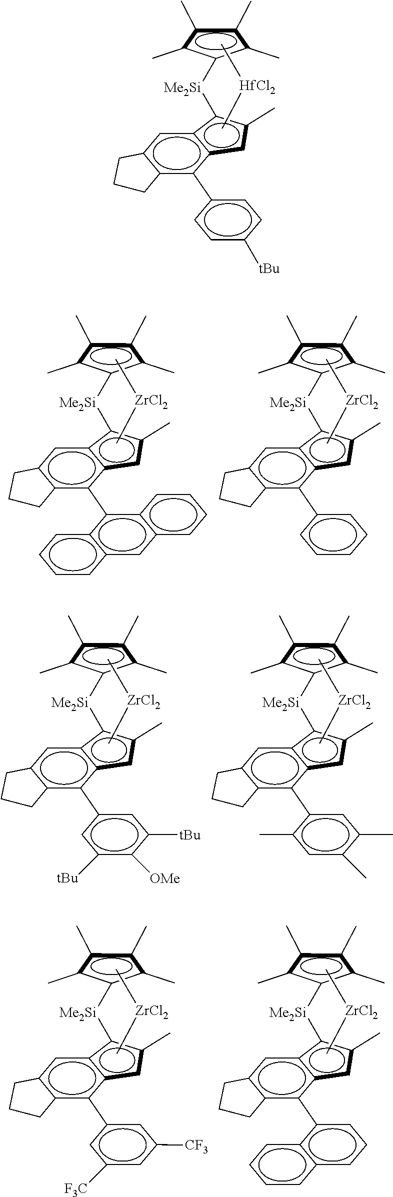

Illustrative examples of metallocenes having a structure represented by Formula 9 include, but are not limited to:

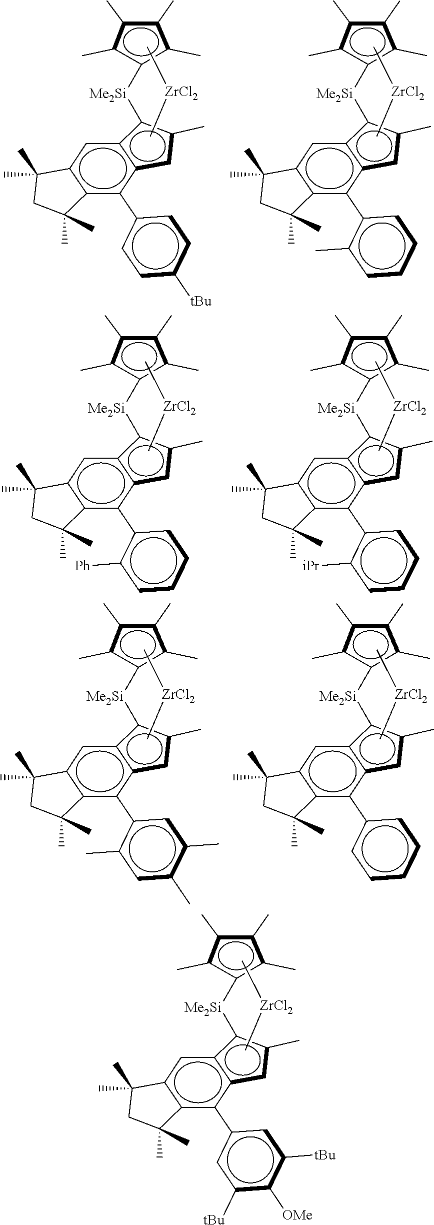

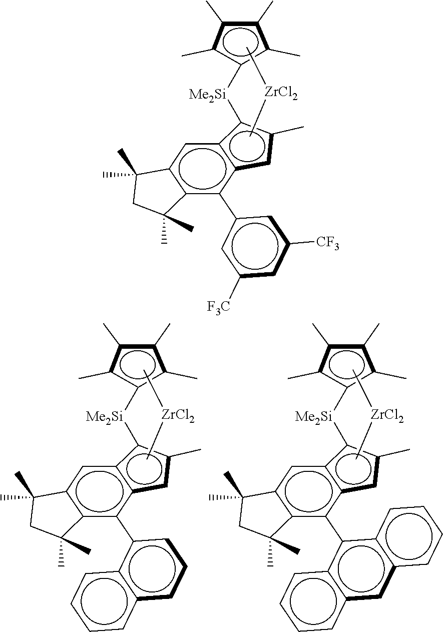

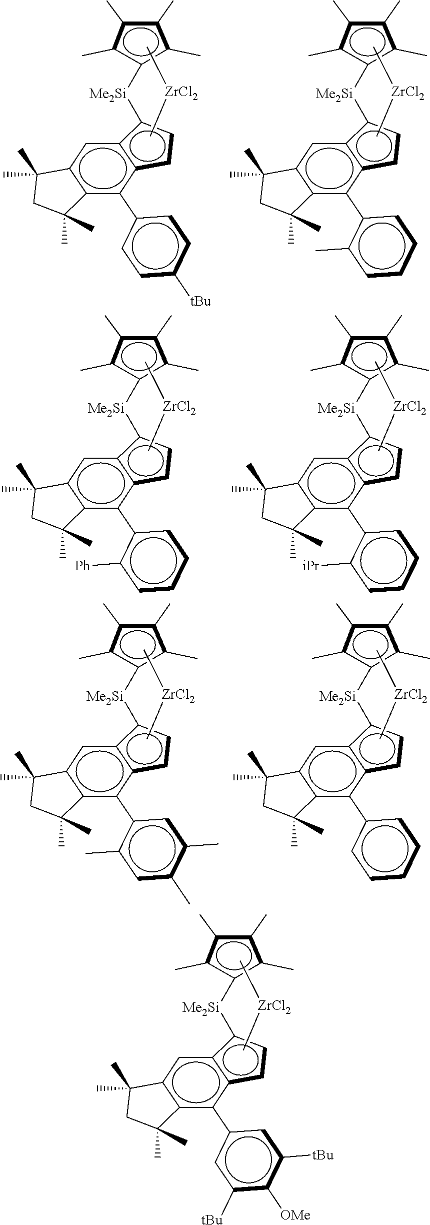

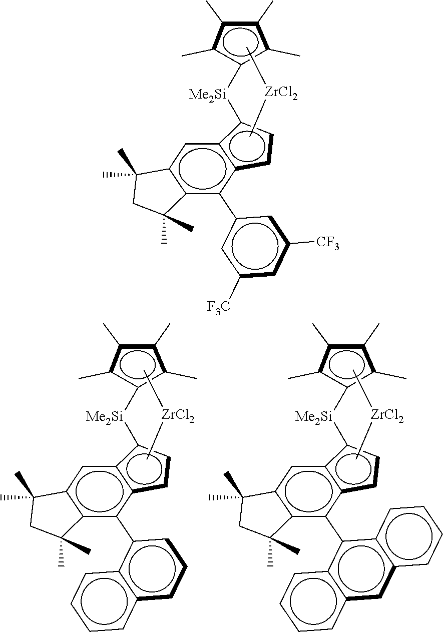

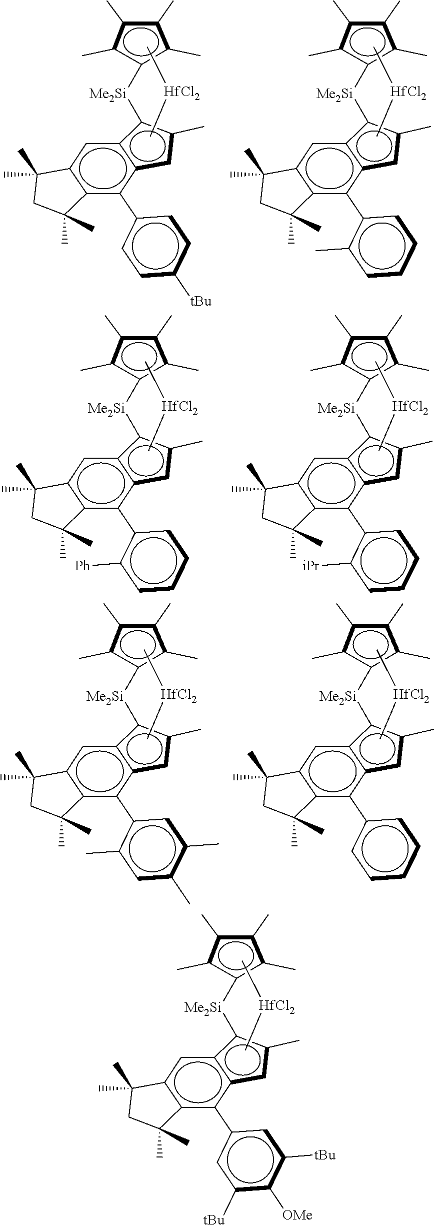

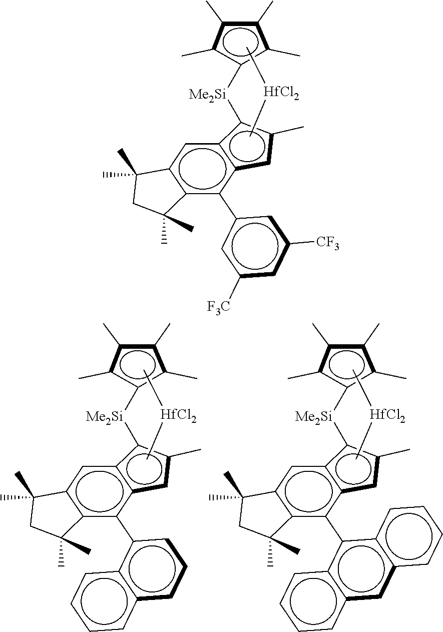

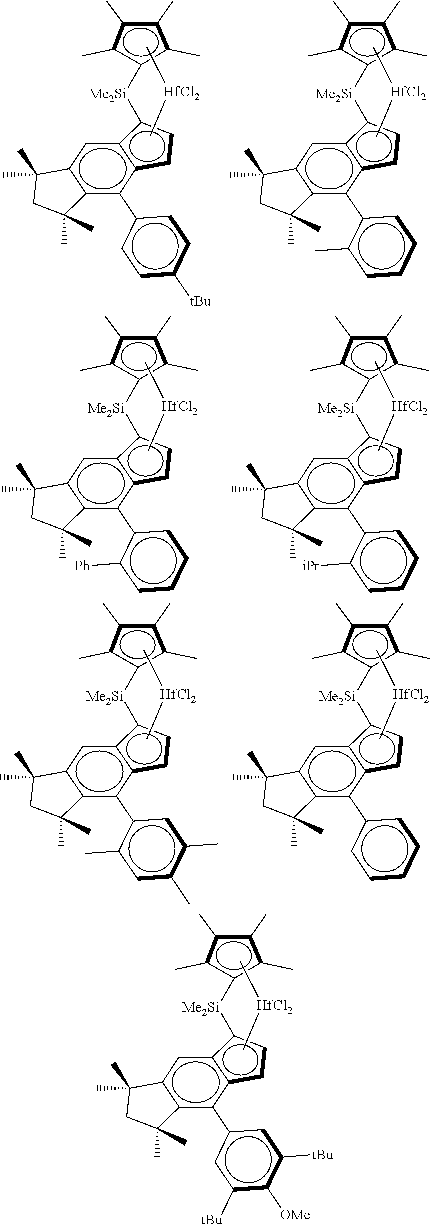

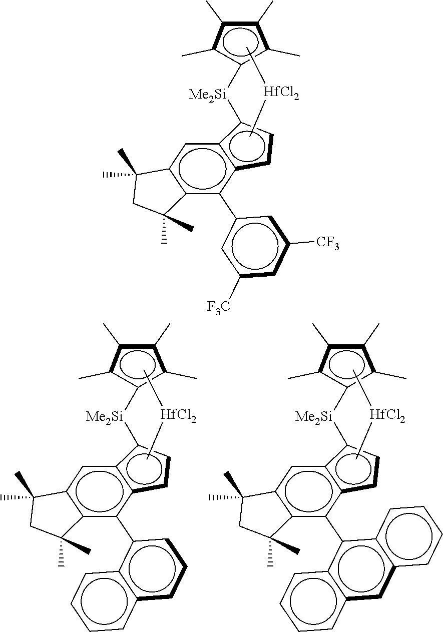

For nomenclature purposes, the following numbering convention (Scheme 2) is used for an indenyl ring. It should be noted that indenyl can be considered a cyclopentadienyl ring fused with a benzene ring. The structure below is drawn and named as an anion.

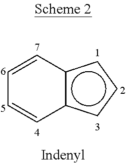

Also for clarity, the following ring structures are substituted indenyls, where substitutions at the 5- and 6-positions collectively define an expanded ring structure. For specific compound nomenclature purposes, these ligands are described below. A similar numbering and nomenclature convention is used for these types of substituted indenyls that include indacenyls, cyclopenta[b]naphthalenyls, heterocyclopentanaphthyls, heterocyclopentaindenyls, and the like, as illustrated in Scheme 3 below. Each structure is drawn and named as an anion.

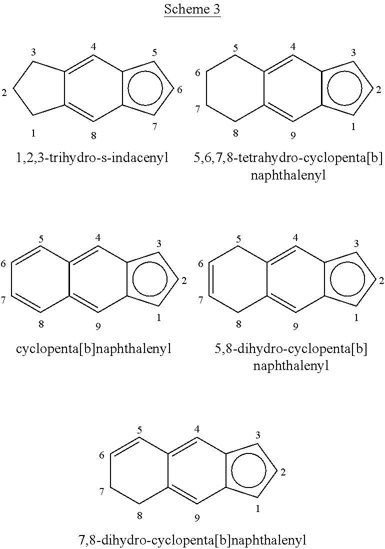

Catalysts comprising at least one metallocene having a structure represented by any of the formulas shown above may produce a vinyl-terminated polypropylene under suitable polymerization reaction conditions. Metallocenes having a bulky alkyl group at R³ may be particularly effective to afford a high degree of vinyl termination. Vinyl termination is useful in the context of polymer chemistry, as vinyl-terminated polymeric chains can be readily re-incorporated into another, growing chain to give long-chain branches, such as a long-chain branched polypropylene homopolymer or copolymer. Long-chain branched polymers typically exhibit higher shear thinning, improved melt strength, and strain hardening, which are beneficial features for foaming applications, for example.

In the case of metallocenes having an aryl group at R³, catalyst systems incorporating the metallocenes may afford high-crystallinity isotactic polypropylene with minimal regioerrors. Further, such catalyst systems may produce high molecular weight ethylene-propylene copolymers with high activities and excellent ethylene incorporation, as well as ethylene-octene plastomers (copolymers).

Any of the foregoing metallocenes may be incorporated in catalyst systems comprising an activator, optionally a co-activator, optionally a support, and optionally a scavenger. The activator and optional co-activator may convert the metallocenes into a form effective for promoting olefin polymerization under suitable polymerization reaction conditions, as described in further detail hereinbelow.

Any of the foregoing metallocenes may be present in a suitable catalyst system in combination with a second metallocene different than the first metallocene, or the foregoing metallocenes may be present individually in a suitable catalyst system. Preferably, metallocenes having a bulky alkyl group at R³ may be combined with a second metallocene different than the first metallocene (e.g., a C₂ symmetric metallocene or a pseudo-C₂ symmetric metallocene) and capable of further polymerizing vinyl-terminated polypropylenes or vinyl-terminated macromonomers to afford long-chain branched polypropylenes. Preferably, the second metallocene capable of re-incorporating and polymerizing vinyl-terminated polymer chains may be a metallocene having C₂ symmetry or pseudo-C₂ symmetry, further details of which are provided hereinbelow. By incorporating vinyl-terminated macromonomers during further polymerization, the C₂ symmetric metallocenes may afford higher molecular weight polypropylene characterized by long-chain branches that are produced in-reactor but without using a diene monomer. The resulting mixed or dual metallocene catalyst systems can be used in solution polymerization with conventional aluminoxane (alumoxane) or non-coordinating anion (NCA) type activators. More preferably, the mixed metallocene catalyst systems can be combined with an activator and supported on conventional support materials, such as silica, alumina, titania and other porous inorganic supports.

Accordingly, catalyst systems of the present disclosure may comprise at least one metallocene having a structure represented by any one of Formulas 1, 5, 6, 7, 8, or 9 above, in which variables are further defined as above, an activator, optionally a co-activator, optionally a scavenger, and optionally a support. In some embodiments, the catalyst systems may comprise a mixed metallocene catalyst system in which the at least one metallocene represented by any one of Formulas 1, 5, 6, 7, 8, or 9 is at least one first metallocene and the catalyst systems further comprise a second metallocene different than the at least one first metallocene. Preferably, the second metallocene is not a metallocene represented by any one of Formulas 1, 5, 6, 7, 8, or 9, and more preferably, the second metallocene is a metallocene having C₂ symmetry or pseudo-C₂ symmetry. Examples of suitable second metallocenes are provided hereinafter.

In some embodiments, the second metallocene may have a structure represented by Formula 10

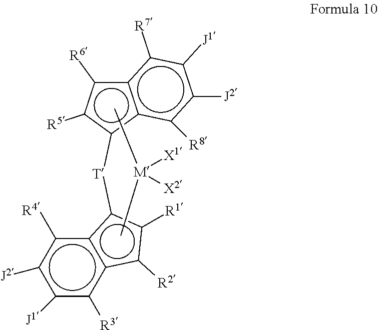

wherein:
M′ is a Group 4 metal; preferably Zr or Hf;
T′ is a bridging group;
X^{1′} and X^{2′} are each a univalent anionic ligand, or X^{1′} and X^{2′} are joined to form a metallocycle ring, a chelating ligand, a diene ligand, or an alkylidene; preferably, X¹ and X² are independently a halide (F, Cl, Br, I) or a C₁-C₆ alkyl; more preferably, X¹ and X² are each chloride or methyl;
R^{1′} and R^{5′} are hydrogen or optionally substituted C₁-C₄₀ alkyl; preferably hydrogen or methyl;
R^{3′}, and R^{7′} are hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl; preferably, R^{3′} and R^{7′} are optionally substituted C₆-C₄₀ aryl, more preferably, optionally substituted phenyl or optionally substituted naphthyl;
R^{2′}, R^{4′}, R^{6′}, and R^{8′} are independently hydrogen, optionally substituted C₁-C₄₀ alkyl, optionally substituted C₆-C₁₄ aryl, or optionally substituted C₃-C₁₃ heteroaryl; preferably, R^{2′}, R^{4′}, R^{6′}, and R^{8′} are hydrogen; and
J^{1′} and J^{2′} are each H, or J^{1′} and J^{2′} are joined to form a C₃-C₆₂ (alternately C₅-C₆₂, alternately C₅-C₄₀, alternately C₆ to C₃₀, alternately C₆ to C₂₀, or alternately C₅ to C₈) substituted or unsubstituted, saturated or unsaturated, cyclic or polycyclic ring structure, or a combination thereof, provided that J^{1′} and J^{2′} together with the two carbons they are bound to on the indenyl group form at least one saturated ring; preferably, J^{1′} and J^{2′} together with the two carbons they are bound to on the indenyl group form at least one 5- or 6-membered saturated ring.

Preferably, R^{1′} and R^{5′} are the same, R^{2′} and R^{6′} are the same, R^{3′} and R^{7′} are the same, R^{4′} and R^{8′} are the same, and each occurrence of J^{1′} and J^{2′} are the same, such that the second metallocene has C₂ symmetry. Accordingly, in some embodiments, the second metallocene may have a structure represented by Formula 11

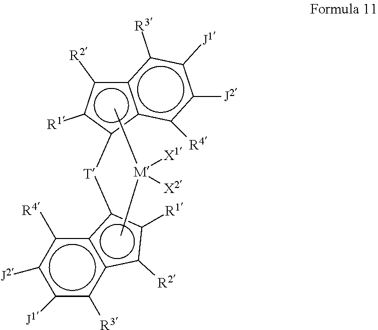

wherein:
M′ is a Group 4 metal, preferably zirconium or hafnium;
T′ is a bridging group; preferably CR^{9′}R^{10′} or SiR^{9′}R^{10′}, wherein R^{9′} and R^{10′} are independently hydrogen, optionally substituted C₁-C₄₀ alkyl, or optionally substituted C₆-C₁₄ aryl, or R^{9′} and R^{10′} are joined to form a C₃-C₆₂ substituted or unsubstituted, saturated or unsaturated, cyclic or polycyclic ring structure, or a combination thereof; more preferably, R^{9′} and R^{10′} are methyl;
X^{1′} and X^{2′} are independently a halide (F, Cl, Br, I) or a C₁-C₆ alkyl; preferably X^{1′} and X^{2′} are each chloride or methyl;
R^{1′} is an optionally substituted C₁-C₄₀ alkyl; preferably methyl;
R^{2′} and R^{4′} are hydrogen;
R^{3′} is optionally substituted phenyl or optionally substituted naphthyl; and
J^{1′} and J^{2′} are each H, or J^{1′} and J^{2′} together with the two carbons they are bound to on the indenyl group form a 5-membered saturated ring, which may be optionally substituted.

Still more specific examples of the second metallocene may have a structure represented by Formula 12

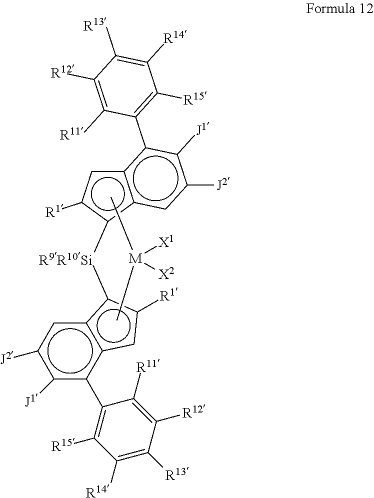

wherein:
M′ is a Group 4 metal, preferably zirconium or hafnium;
X^{1′} and X^{2′} are each a univalent anionic ligand, or X^{1′} and X² are joined to form a metallocycle ring, a chelating ligand, a diene ligand, or an alkylidene, preferably X¹ and X² are independently a halide (F, Cl, Br, I) or a C₁-C₆ hydrocarbyl, such as a C₁-C₆ alkyl or phenyl;
R^{9′} and R^{10′} are optionally substituted C₁-C₄₀ alkyl or optionally substituted C₆-C₁₄ aryl, or R^{9′} and R^{10′} are joined to form a C₃-C₆₂ substituted or unsubstituted, saturated or unsaturated, cyclic or polycyclic ring structure, or a combination thereof; preferably, T is CH₂, CH₂CH₂, C(CH₃)₂, (Ph)₂C, (p-(Et)₃SiPh)₂C, SiMe₂, SiPh₂, SiMePh, Si(CH₂)₃, Si(CH₂)₄, or Si(CH₂)₄;
R^{1′} is an optionally substituted C₁-C₄₀ alkyl; preferably methyl;
R^{2′} and R^{4′} are independently hydrogen, optionally substituted C₁-C₄₀ alkyl, or optionally substituted C₆-C₁₄ aryl; preferably R^{2′} and R^{4′} are hydrogen;
R^{11′}—R^{15′} are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl; and
J^{1′} and J^{2′} are each H, or J^{1′} and J^{2′} together with the two carbons they are bound to on the indenyl group form a 5-membered saturated ring, which may be optionally substituted.

Illustrative examples of second metallocenes having a structure represented by Formulas 11 and 12 include, but are not limited to:

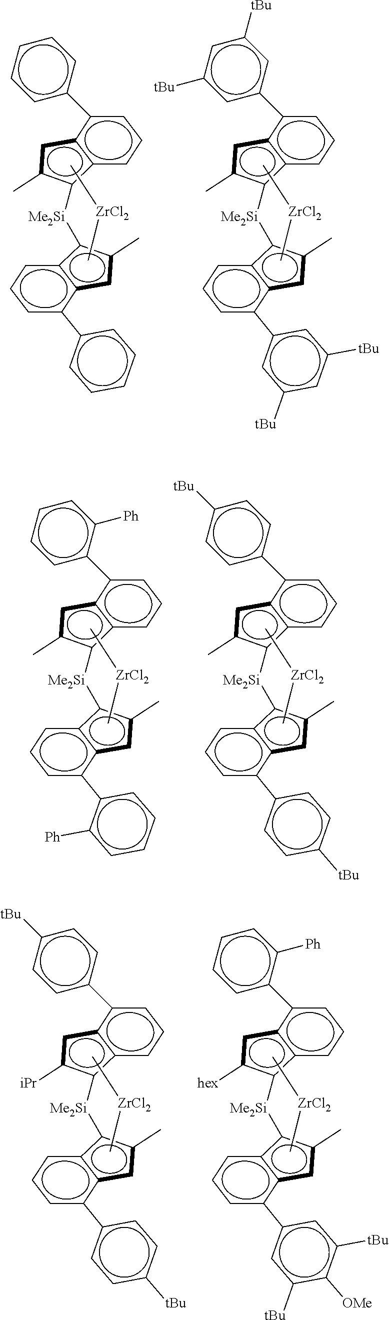

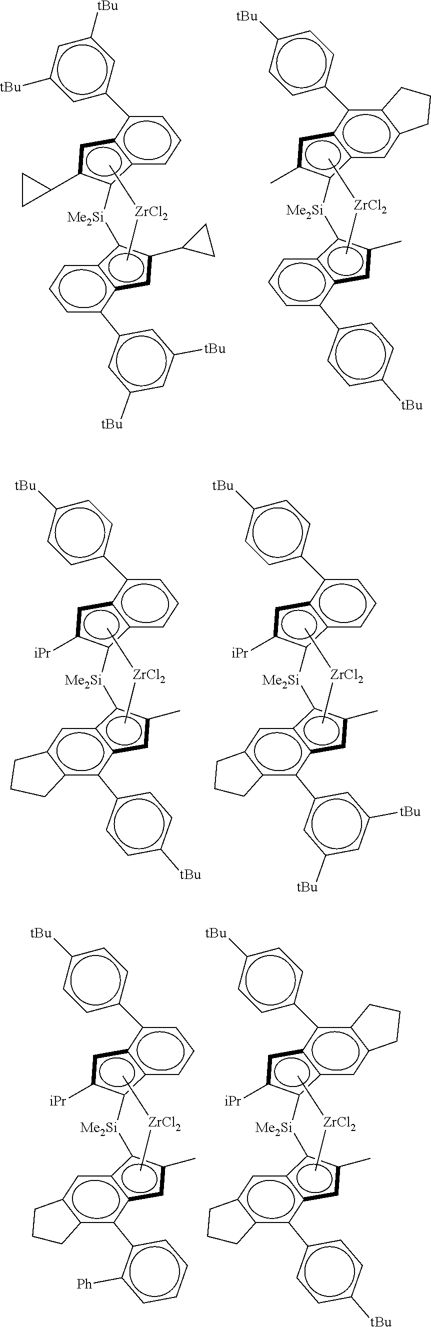

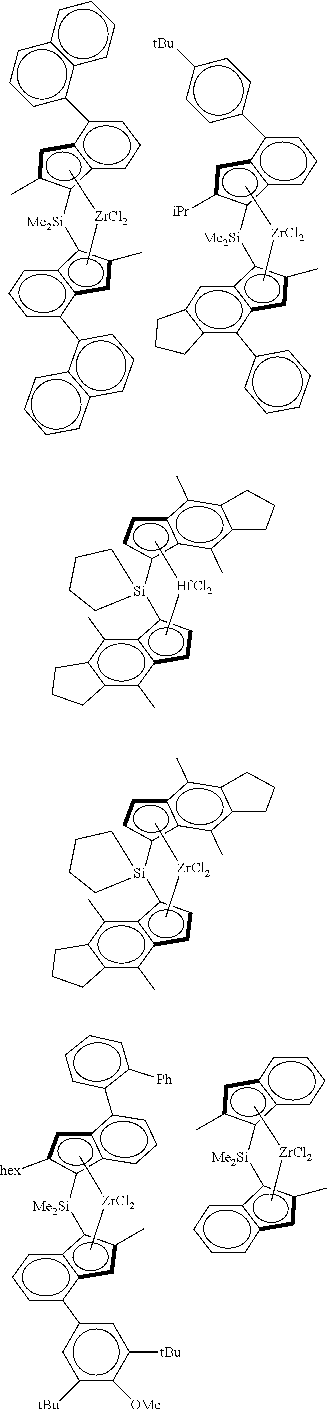

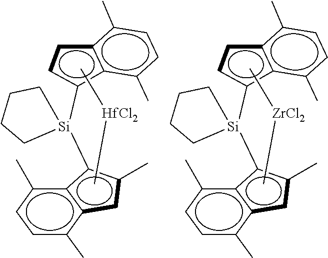

Multiple metallocenes may be present in any ratio in a catalyst system for use in a 5 polymerization process of the present disclosure. Preferred molar ratios of the first metallocene (A) to the second metallocene (B), if present, may fall within the range of (A:B) 1:1000 to 1000:1, alternately 1:100 to 500:1, alternately 1:10 to 200:1, alternately 1:1 to 100:1, alternately 1:1 to 75:1, or alternately 5:1 to 50:1, or alternately 10:1 to 1:10, or 50:1 to 1:50. The particular ratio chosen may depend on the exact metallocenes chosen, the method of activation, and the end product desired.

### Catalyst Systems

The terms “cocatalyst” and “activator” are used herein interchangeably. The catalyst systems described herein typically comprise one or more metallocenes as described above and an activator such as aluminoxane (alumoxane) or a non-coordinating anion and can be formed by combining the catalyst components described herein with activators in any manner known from the literature including combining them with supports, such as silica. The catalyst systems can also be added to or generated in solution polymerization or bulk polymerization (in the monomer). Catalyst systems of the present disclosure can have one or more activators and one, two or more metallocenes. Activators are defined to be any compound which can activate any one of the catalyst compounds described above by converting the neutral metal compound to a catalytically active metal compound cation. Non-limiting activators, for example, include alumoxanes, aluminum alkyls, ionizing activators, which may be neutral or ionic, and conventional-type cocatalysts. Preferred activators typically include alumoxane compounds, modified alumoxane compounds, and ionizing anion precursor compounds that abstract a reactive, 6-bound, metal ligand making the metal compound cationic and providing a charge-balancing non-coordinating or weakly coordinating anion, e.g. a non-coordinating anion.

Alumoxane (aluminoxane) activators may be utilized as activators in the catalyst systems described herein. Alumoxanes are generally oligomeric compounds containing —Al(R)—O— sub-units, where R is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, particularly when the abstractable ligand is an alkyl, halide, alkoxide or amide. Mixtures of different alumoxanes and modified alumoxanes can also be used. It may be preferable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584). Another useful alumoxane is solid polymethylaluminoxane as described in U.S. Pat. Nos. 9,340,630; 8,404,880; and 8,975,209.

When the activator is an alumoxane (modified or unmodified), some embodiments select the maximum amount of activator typically at up to a 5000-fold molar excess Al/M over the catalyst compound (per metal catalytic site). The minimum activator-to-catalyst-compound is a 1:1 molar ratio. Alternate preferred ranges include from 1:1 to 500:1, alternately from 1:1 to 200:1, alternately from 1:1 to 100:1, or alternately from 1:1 to 50:1.

In an alternate embodiment, little or no alumoxane is used in the polymerization processes described herein. Preferably, alumoxane is present at 0 mol %, alternately the alumoxane is present at a molar ratio of aluminum to catalyst compound transition metal less than 500:1, preferably less than 300:1, preferably less than 100:1, and preferably less than 1:1.

Other suitable activators for the catalysts can include compounds containing a non-coordinating anion, especially borane and borate compounds. Particularly useful borane and borate compounds containing a non-coordinating anion or similar entity include, for example, B(C₆F₅)₃, [PhNMe₂H]⁺[B(C₆F₅)₄]⁻, [Ph₃C]⁺[B(C₆F₅)₄]⁻, and [PhNMe₂H]⁺[B(C₁₀F₇)₄]⁻.

The term “non-coordinating anion” (NCA) means an anion which either does not coordinate to a cation or which is only weakly coordinated to a cation thereby remaining sufficiently labile to be displaced by a neutral Lewis base. The term NCA is defined to include multicomponent NCA-containing activators, such as N,N-dimethylanilinium tetrakis(pentafluorophenyl)borate and N,N-dimethylanilinium tetrakis(heptafluoronaphthyl)borate, that contain an acidic cationic group and the non-coordinating anion. The term NCA is also defined to include neutral Lewis acids, such as tris(pentafluorophenyl)boron, that can react with a catalyst to form an activated species by abstraction of an anionic group. Typically, NCAs coordinate weakly enough that a neutral Lewis base, such as an olefinically or acetylenically unsaturated monomer can displace it from the catalyst center. Any metal or metalloid that can form a compatible, weakly coordinating complex may be used or contained in the non-coordinating anion. Suitable metals include, but are not limited to, aluminum, gold, and platinum. Suitable metalloids include, but are not limited to, boron, aluminum, phosphorus, and silicon. The term non-coordinating anion includes neutral activators, ionic activators, and Lewis acid activators.

“Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with this invention are those that are compatible, stabilize the transition metal cation in the sense of balancing its ionic charge at +1, and yet retain sufficient lability to permit displacement during polymerization. Ionizing activators useful herein typically comprise an NCA, particularly a compatible NCA.

It is within the scope of this invention to use an ionizing activator, neutral or ionic. It is also within the scope of this invention to use neutral or ionic activators alone or in combination with alumoxane or modified alumoxane activators. For descriptions of useful activators please see U.S. Pat. Nos. 8,658,556 and 6,211,105.

It is within the scope of the present disclosure to use an ionizing, neutral, or ionic activator, such as tri(n-butyl)ammonium tetrakis(pentafluorophenyl)borate, a tris perfluorophenylboron metalloid precursor or a trisperfluoronaphthylboron metalloid precursor, polyhalogenated heteroborane anions (WO 98/43983), boric acid (U.S. Pat. No. 5,942,459), or any combination thereof. It is also within the scope of the present disclosure to use neutral or ionic activators alone or in combination with alumoxane activators.

The catalyst systems of the present disclosure may include at least one non-coordinating anion (NCA) activator. In preferred embodiments, boron-containing NCA activators represented by Formula 13 below may be used,

Z_{d}⁺(A^{d-}) Formula 13

where Z is (L-H) or a reducible Lewis acid; L is a neutral Lewis base; H is hydrogen; (L-H) is a Bronsted acid; A^{d-} is a boron-containing non-coordinating anion having the charge d⁻; and d is 1, 2, or 3

The cation component Z_{d}⁺ may include Bronsted acids such as protons or protonated Lewis bases or reducible Lewis acids capable of protonating or abstracting a moiety from the metal-ligand complexes to afford a cationic metal-ligand complex.

The cation component Z_{d}⁺ may also be a moiety such as silver, tropylium, carboniums, ferroceniums and mixtures thereof, preferably carboniums and ferroceniums. Suitable reducible Lewis acids include any triaryl carbonium (where the aryl can be substituted or unsubstituted, such as those represented by the formula: (Ar₃C⁺), where Ar is aryl or aryl substituted with a heteroatom, a C₁ to C₄₀ hydrocarbyl, or a substituted C₁ to C₄₀ hydrocarbyl). Preferably, the reducible Lewis acids in Formula 13 above defined as “Z” include those represented by the formula: (Ph₃C), where Ph is a substituted or unsubstituted phenyl, preferably substituted with C₁ to C₄₀ hydrocarbyls or substituted a C₁ to C₄₀ hydrocarbyls, preferably C₁ to C₂₀ alkyls or aromatics or substituted C₁ to C₂₀ alkyls or aromatics, and preferably Z_{d}⁺ is triphenylcarbonium.

When Z_{d}⁺ is the activating cation (L-H)_{d}⁺, it is preferably a Bronsted acid, capable of donating a proton to the transition metal catalytic precursor resulting in a transition metal cation, including ammoniums, oxoniums, phosphoniums, silyliums, and mixtures thereof, preferably ammoniums of methylamine, aniline, dimethylamine, diethylamine, N-methylaniline, diphenylamine, trimethylamine, triethylamine, N,N-dimethylaniline, methyldiphenylamine, pyridine, p-bromo-N,N-dimethylaniline, p-nitro-N,N-dimethylaniline, phosphoniums from triethylphosphine, triphenylphosphine, and diphenylphosphine, oxoniums from ethers such as dimethyl ether diethyl ether, tetrahydrofuran and dioxane, sulfoniums from thioethers, such as diethyl thioethers, tetrahydrothiophene, and mixtures thereof.

The anion component A^{d-} includes those having the formula [M^{k+}G]^{d-} wherein k is 1, 2, or 3; g is 1, 2, 3, 4, 5, or 6 (preferably 1, 2, 3, or 4); g−k=d; M is an element selected from Group 13 of the Periodic Table of the Elements, preferably boron or aluminum, and G is independently a hydride, bridged or unbridged dialkylamido, halide, alkoxide, aryloxide, hydrocarbyl, substituted hydrocarbyl, halocarbyl, substituted halocarbyl, and halo-substituted hydrocarbyl radicals, said G having up to 20 carbon atoms with the proviso that in not more than 1 occurrence is G a halide. Preferably, each G is a fluorinated hydrocarbyl group having 1 to 20 carbon atoms, more preferably, each G is a fluorinated aryl group, and most preferably, each G is a pentafluoroaryl group. Examples of suitable A^{d-} also include diboron compounds as disclosed in U.S. Pat. No. 5,447,895, which is fully incorporated herein by reference with respect to the diboron compounds disclosed therein.

Illustrative but not limiting examples of boron compounds which may be used as an activator are the compounds described as (and particularly those specifically listed as) activators in U.S. Pat. No. 8,658,556, which is incorporated by reference herein with respect to the boron compounds disclosed therein.

Most preferably, the activator Z_{d}⁺(A^{d-}) is one or more of N,N-dimethylanilinium tetra(perfluorophenyl)borate, N,N-dimethylanilinium tetrakis(perfluoronaphthyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, or triphenylcarbenium tetra(perfluorophenyl)borate. In any embodiment, the non-coordinating anion may be selected from N,N-dimethylanilinium tetrakis(perfluoronaphthyl)borate, N,N-dimethylanilinium tetrakis(perfluorobiphenyl)borate, N,N-dimethylanilinium tetrakis(perfluorophenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, triphenylcarbenium tetrakis(perfluorophenyl)borate, [Me₃NH⁺][B(C₆F₅)⁴⁻], 1-(4-(tris(pentafluorophenyl)borate)-2,3,5,6-tetrafluorophenyl) pyrrolidinium; [Me₃NH⁺][B(C₆F₅)⁴⁻], 1-(4-(tris(pentafluorophenyl)borate)-2,3,5,6-tetrafluorophenyl) pyrrolidinium, sodium tetrakis(pentafluorophenyl)borate, potassium tetrakis(pentafluorophenyl)borate, and 4-(tris(pentafluorophenyl)borate)-2,3,5,6-tetrafluoropyridinium. Preferably, the non-coordinating anion may be N,N-dimethylanilinium tetrakis(perfluoronaphthyl)borate.

Bulky activators are also useful herein as NCAs. “Bulky activator” as used herein refers to anionic activators represented by Formulas 14 or 15 below.

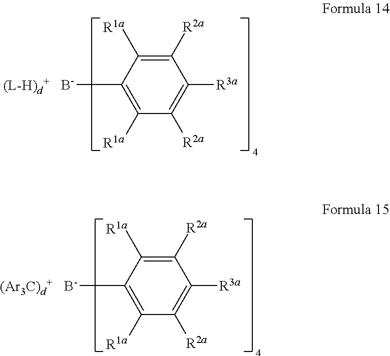

In Formulas 14 and 15, each R^{1a} is, independently, a halide, preferably a fluoride; Ar is substituted or unsubstituted aryl group (preferably a substituted or unsubstituted phenyl), preferably substituted with C₁ to C₄₀ hydrocarbyls, preferably C₁ to C₂₀ alkyls or aromatics; each R^{2a} is, independently, a halide, a C₆ to C₂₀ substituted aromatic hydrocarbyl group or a siloxy group of the formula —O—Si—R^{a}, where R^{a} is a C₁ to C₂₀ hydrocarbyl or hydrocarbylsilyl group (preferably R^{2a} is a fluoride or a perfluorinated phenyl group); each R^{3a} is a halide, C₆ to C₂₀ substituted aromatic hydrocarbyl group or a siloxy group of the formula —O—Si—R^{a}, where R^{a} is a C₁ to C₂₀ hydrocarbyl or hydrocarbylsilyl group (preferably R^{3a} is a fluoride or a C₆ perfluorinated aromatic hydrocarbyl group); wherein R^{2a} and R^{3a} can form one or more saturated or unsaturated, substituted or unsubstituted rings (preferably R^{2a} and R^{3a} form a perfluorinated phenyl ring); and L is a neutral Lewis base; (L-H)⁺ is a Bronsted acid; d is 1, 2, or 3; wherein the anion has a molecular weight of greater than 1020 g/mol; wherein at least three of the substituents on the B atom each have a molecular volume of greater than 250 cubic Å, greater than 300 cubic Å, or greater than 500 cubic Å, as specified below.

Preferably, (Ar₃C)_{d}⁺ is (Ph₃C)_{d}⁺, where Ph is a substituted or unsubstituted phenyl, preferably substituted with C₁ to C₄₀ hydrocarbyls or substituted C₁ to C₄₀ hydrocarbyls, preferably C₁ to C₂₀ alkyls or aromatics or substituted C₁ to C₂₀ alkyls or aromatics.

“Molecular volume” is used herein as an approximation of spatial steric bulk of an activator molecule in solution. Comparison of substituents with differing molecular volumes allows the substituent with the smaller molecular volume to be considered “less bulky” in comparison to the substituent with the larger molecular volume. Conversely, a substituent with a larger molecular volume may be considered “more bulky” than a substituent with a smaller molecular volume. Molecular volume may be calculated as reported in “A Simple “Back of the Envelope” Method for Estimating the Densities and Molecular Volumes of Liquids and Solids,” Journal of Chemical Education, Vol. 71, No. 11, November 1994, pp. 962-964. Molecular volume (MV), in units of cubic Å, is calculated using the formula: MV=8.3V_{S}, where V_{S} is the scaled volume. V_{S} is the sum of the relative volumes of the constituent atoms, and is calculated from the molecular formula of the substituent as specified below. For fused rings, the V_{S} is decreased by 7.5% per fused ring. The Calculated Total MV of the anion is the sum of the MV per substituent, for example, the MV of perfluorophenyl is 183 Å³, and the Calculated Total MV for tetrakis(perfluorophenyl)borate is four times 183 Å³, or 732 Å³.

| Element | Relative Volume |
|---|---|
| H | 1 |
| 1^{st} short period, Li to F | 2 |
| 2^{nd} short period, Na to Cl | 4 |
| 1^{st} long period, K to Br | 5 |
| 2^{nd} long period, Rb to I | 7.5 |
| 3^{rd} long period, Cs to Bi | 9 |

For a list of particularly useful bulky activators, U.S. Pat. No. 8,658,556, which is incorporated by reference herein with respect to its disclosure of bulk activators, may be consulted.

In any embodiment, a NCA activator may be an activator as described in U.S. Pat. No. 6,211,105. The NCA activator-to-catalyst ratio may be from about a 1:1 molar ratio to about a 1000:1 molar ratio, which includes, from about 0.1:1 to about 100:1 from about 0.5:1 to about 200:1, from about 1:1 to about 500:1, or from about 1:1 to about 1000:1. A particularly useful range is from about 0.5:1 to about 10:1, preferably about 1:1 to about 5:1.

It is also within the scope of this disclosure that the metal-ligand complexes may be activated with combinations of alumoxanes and NCAs (see for example, U.S. Pat. Nos. 5,153,157 and 5,453,410; EP 0 573 120 B1, and International Patent Application Publications WO 94/07928 and WO 95/14044, which discuss the use of an alumoxane in combination with an ionizing activator). Thus, in some embodiments, a NCA may be a co-activator to an alumoxane, or vice versa.

In addition to activator compounds, scavengers or co-activators can be used. Aluminum alkyl or organoaluminum compounds which may be utilized as scavengers or co-activators include, for example: trimethylaluminum, triethylaluminum, triisobutylaluminum, tri-n-hexylaluminum, tri-n-octylaluminum, ethylaluminum dichloride, diethylaluminum chloride, and diethyl zinc.

Chain transfer agents can also be used in the compositions and/or processes described herein. Useful chain transfer agents are typically alkylalumoxanes, a compound represented by the formula AlR₃, ZnR₂ (where each R is, independently, a C₁-C₈ aliphatic radical, preferably methyl, ethyl, propyl, butyl, pentyl, hexyl, octyl or an isomer thereof) or a combination thereof, such as diethyl zinc, methylalumoxane, trimethylaluminum, triisobutylaluminum, trioctylaluminum, or a combination thereof.

In any embodiment, a catalyst system suitable for use in the methods and systems disclosed herein may be disposed on a solid support. The solid support may allow a catalytic reaction, such as polymerization of an olefinic feed, to be conducted under heterogeneous conditions. In more specific embodiments, the solid support may be silica. Other suitable solid supports may include, but are not limited to, alumina, magnesium chloride, talc, inorganic oxides, or chlorides including one or more metals from Groups 2, 3, 4, 5, 13, or 14 of the Periodic Table, and polymers such as polystyrene, or functionalized and/or cross-linked polymers. Other inorganic oxides that may suitably function as solid supports include, for example, titania, zirconia, boron oxide, zinc oxide, magnesia, or any combination thereof. Combinations of inorganic oxides may be suitably used as solid supports as well. Illustrative combinations of suitable inorganic oxides include, but are not limited to, silica-alumina, silica-titania, silica-zirconia, silica-boron oxide, and the like.

In any embodiment, an alumoxane or other suitable activator may be disposed on silica or another suitable solid support before being combined with the metallocenes disclosed herein. The metal-ligand complexes disclosed herein can be disposed upon silica or another suitable support before being combined with an alumoxane or other suitable activator. Upon combining the activator and the solid support with the metal-ligand complexes, the resulting catalyst system may become disposed upon the solid support. Catalyst systems having different catalytic properties can be obtained depending upon whether the metal-ligand complexes or the activator are supported on the solid support first.

In any embodiment, an alumoxane, such as MAO, may be mixed in an inert solvent such as toluene and then be slurried with a solid support, such as silica. Alumoxane deposition upon the solid support may occur at a temperature from about 60° C. to 120° C., or about 80° C. to 120° C., or about 100° C. to 120° C. Deposition occurring below 60° C., including room temperature deposition, may also be effective.

In various embodiments, the catalyst system can comprise an inert support material. Preferably the supported material is a porous support material, for example: talc, and inorganic oxides. Other support materials include zeolites, clays, organoclays, or any other organic or inorganic support material and the like, or mixtures thereof.

Preferably, the support material is an inorganic oxide in a finely divided form. Suitable inorganic oxide materials for use in catalyst systems herein include Groups 2, 4, 13, and 14 metal oxides, such as silica, alumina, and mixtures thereof. Other inorganic oxides that may be employed either alone or in combination with the silica, or alumina are magnesia, titania, zirconia, and the like. Other suitable support materials, however, can be employed, for example, finely divided functionalized polyolefins, such as finely divided polyethylene. Particularly useful supports include magnesia, titania, zirconia, montmorillonite, phyllosilicate, zeolites, talc, clays, and the like. Also, combinations of these support materials may be used, for example, silica-chromium, silica-alumina, silica-titania, and the like. Preferred support materials include Al₂O₃, ZrO₂, SiO₂, and combinations thereof, more preferably SiO₂, Al₂O₃, or SiO₂/Al₂O₃.

In any embodiment, solid supports suitable for use in the disclosure herein can have a surface area ranging from about 10 to about 700 m²/g, pore volume in the range of from about 0.1 to about 4.0 cc/g and average particle size in the range of from about 5 to about 500 m. More preferably, the surface area of the support material is in the range of from about 50 to about 500 m²/g, pore volume of from about 0.5 to about 3.5 cc/g and average particle size of from about 10 to about 200 m. Most preferably the surface area of the support material is in the range from about 100 to about 400 m²/g, pore volume from about 0.8 to about 3.0 cc/g and average particle size is from about 5 to about 100 m. The average pore size of the support material useful in the invention is in the range of from 10 to 1000 Å, preferably 50 to about 500 Å, and most preferably 75 to about 350 Å. In some embodiments, the support material is a high surface area, amorphous silica (surface area=300 m²/gm; pore volume of 1.65 cm³/gm). Preferred silicas are marketed under the tradenames of DAVISON™ 952 or DAVISON™ 955 by the Davison Chemical Division of W.R. Grace and Company, PD17062™ (from PQ Corporation) or DM-L403™ and DM-L303™ (from Asahi Glass Chemical).

The support material may be free of absorbed water. Drying of the support material can be effected by heating or calcining at about 100° C. to about 1000° C., preferably at least about 200° C. When the support material is silica, it is heated to at least 200° C., preferably about 200° C. to about 850° C., and most preferably at about 400° C.; and for a time of about 1 minute to about 100 hours, from about 12 hours to about 72 hours, or from about 24 hours to about 60 hours. The calcined support material may have at least some reactive hydroxyl (OH) groups to produce supported catalyst systems of this invention. The calcined support material is then contacted with at least one polymerization catalyst comprising at least one catalyst compound and an activator.

The support material, having reactive surface groups, typically hydroxyl groups, is slurried in a non-polar solvent and the resulting slurry is contacted with a solution of a catalyst compound and an activator. In some embodiments, the slurry of the support material is first contacted with the activator for a period of time in the range of from about 0.5 hours to about 24 hours, from about 2 hours to about 16 hours, or from about 4 hours to about 8 hours. The solution of the catalyst compound is then contacted with the isolated support/activator. In some embodiments, the supported catalyst system is generated in situ. In alternate embodiments, the slurry of the support material is first contacted with the catalyst compound for a period of time in the range of from about 0.5 hours to about 24 hours, from about 2 hours to about 16 hours, or from about 4 hours to about 8 hours. The slurry of the supported catalyst compound is then contacted with the activator solution.

The mixture of the catalyst, activator and support is heated at about 0° C. to about 70° C., preferably at about 23° C. to about 60° C., preferably at room temperature. Contact times typically range from about 0.5 hours to about 24 hours, from about 2 hours to about 16 hours, or from about 4 hours to about 8 hours.

Suitable non-polar solvents are materials in which all of the reactants used herein, i.e., the activator, and the catalyst compound, are at least partially soluble and which are liquid at reaction temperatures. Preferred non-polar solvents are alkanes, such as isopentane, hexane, n-heptane, octane, nonane, and decane, although a variety of other materials including cycloalkanes, such as cyclohexane, aromatics, such as benzene, toluene, and ethylbenzene, may also be employed.

### Polymerization Processes and Polymer Characterization

Various embodiments described herein further relate to polymerization processes where monomer (such as ethylene, propylene, and/or a higher alpha olefin), and optionally one or more co-monomers, are contacted with a catalyst system comprising an activator and one or more metallocenes, as described above. The metallocenes and activator can be combined in any order, and are combined typically prior to contacting with the monomer. Suitable polymerization reaction conditions for conducting the polymerization reactions are provided below.

Monomers useful herein include substituted or unsubstituted C₂ to C₄₀ alpha olefins, preferably C₂ to C₂₀ alpha olefins, preferably C₂ to C₁₂ alpha olefins, preferably ethylene, propylene, butene, pentene, hexene, heptene, octene, nonene, decene, undecene, dodecene and isomers thereof. In a preferred embodiment, the monomer comprises propylene and one or more optional co-monomers comprising one or more ethylene or C₄ to C₄₀ olefins, preferably C₄ to C₂₀ olefins, or preferably C₆ to C₁₂ olefins. The C₄ to C₄₀ olefin monomers may be linear, branched, or cyclic. The C₄ to C₄₀ cyclic olefins can be strained or unstrained, monocyclic or polycyclic, and can optionally include heteroatoms and/or one or more functional groups. In another preferred embodiment, the monomer comprises ethylene and optional co-monomers comprising one or more C₃ to C₄₀ olefins, preferably C₄ to C₂₀ olefins, or preferably C₆ to C₁₂ olefins. The C₃ to C₄₀ olefin monomers can be linear, branched, or cyclic. The C₃ to C₄₀ cyclic olefins may be strained or unstrained, monocyclic or polycyclic, and can optionally include heteroatoms and/or one or more functional groups.

Exemplary C₂ to C₄₀ olefin monomers and optional co-monomers include ethylene, propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, preferably hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, preferably norbornene, norbornadiene, and dicyclopentadiene.

In some embodiments, one or more dienes may be present in the polymer produced herein at up to 10 wt %, preferably at 0.00001 to 1.0 wt %, preferably 0.002 to 0.5 wt %, even more preferably 0.003 to 0.2 wt %, based upon the total weight of the composition. In some embodiments, 500 ppm or less of diene is added to the polymerization, preferably 400 ppm or less, preferably or 300 ppm or less. In other embodiments, at least 50 ppm of diene is added to the polymerization, or 100 ppm or more, or 150 ppm or more. In still other embodiments, the polymerizations described herein may be conducted in the absence of dienes, particularly if a metallocene that produced a high degree of vinyl termination is used in combination with a second metallocene effective to introduce branching within the resulting polymer.

Preferred diolefin monomers useful in various embodiments described herein can include any hydrocarbon structure, preferably C₄ to C₃₀, having at least two unsaturated bonds, where at least two of the unsaturated bonds are readily incorporated into a polymer by either a stereospecific or a non-stereospecific catalyst(s). It is further preferred that the diolefin monomers be selected from alpha, omega-diene monomers (i.e., di-vinyl monomers containing two terminal alkene groups). More preferably, the diolefin monomers are linear di-vinyl monomers, most preferably those containing from 4 to 30 carbon atoms. Examples of preferred dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Preferred cyclic dienes include cyclopentadiene, vinylnorbornene, norbornadiene, ethylidene norbornene, divinylbenzene, dicyclopentadiene or higher ring containing diolefins with or without substituents at various ring positions.

In some embodiments, the polymers produced herein can be homopolymers of propylene or are copolymers of propylene having from about 0 wt % to about 50 wt % based on the total amount of polymer (such as from 1 wt % to 20 wt %) of one or more of C₂ or C₄ to C₂₀ olefin comonomer, based on a total amount of propylene copolymer, such as from about 0.5 wt % to about 18 wt %, such as from about 1 wt % to about 15 wt %, such as from about 3 wt % to about 10 wt %) of one or more of C₂ or C₄ to C₂₀ olefin comonomer (such as ethylene or C₄ to C₁₂ alpha-olefin, such as ethylene, butene, hexene, octene, decene, dodecene, such as ethylene, butene, hexene, octene, or C₄-C₁₄ α,ω-dienes such as butadiene, 1,5-hexadiene, 1,4-heptadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene).

The propylene homopolymer or propylene copolymer produced herein may have some level of isotacticity, and can be isotactic or highly isotactic. As used herein, “isotactic” is defined as having at least 10% isotactic pentads according to analysis by ¹³C NMR as described in US 2008/0045638 at paragraph [0613] et seq. As used herein, “highly isotactic” is defined as having at least 60% isotactic pentads according to analysis by ¹³C NMR. In at least one embodiment, a propylene homopolymer having at least about 85% isotacticity, such as at least about 90% isotacticity can be produced herein. In another embodiment, the propylene polymer produced can be atactic. Atactic polypropylene is defined to be less than 10% isotactic or syndiotactic pentads according to analysis by ¹³C NMR.

In at least some embodiments, propylene polymers produced herein may have improved levels of vinyl termination relative to polymers prepared with conventional catalysts. The vinyl termination fraction may greater than 45%, more preferably greater than 65% and even more preferably greater than 80% based on total polymer chains produced.

In at least some embodiments, propylene polymers produced herein may have improved levels of long-chain branching relative to linear counterparts. Such polymers may display improved flow and higher strain hardening and melt strength, which is advantageous for foaming applications. The level of branching is judged by viscosity averaged g′ᵥᵢₛ value obtained from GPC-4D analysis, as described further hereinafter. Such polymers may also show a rheological behavior known as strain hardening, which is characterized as a viscosity increase in the extensional rheological flow.

Unless otherwise indicated, the distribution and the moments of molecular weight (Mw, Mn, Mz, Mw/Mn, etc.), the comonomer content, and the branching index (g′) are determined by using a high temperature Gel Permeation Chromatography (Polymer Char GPC-IR) equipped with a multiple-channel band-filter based Infrared detector IR5 with a multiple-channel band filter based infrared detector ensemble IR5 with band region covering from about 2,700 cm⁻¹ to about 3,000 cm⁻¹ (representing saturated C—H stretching vibration), an 18-angle light scattering detector and a viscometer. Three Agilent PLgel 10-μm Mixed-B LS columns are used to provide polymer separation. Reagent grade 1,2,4-trichlorobenzene (TCB) (from Sigma-Aldrich) comprising ˜300 ppm antioxidant BHT can be used as the mobile phase at a nominal flow rate of ˜1.0 mL/min and a nominal injection volume of ˜200 μL. The whole system including transfer lines, columns, and detectors can be contained in an oven maintained at ˜145° C. A given amount of sample can be weighed and sealed in a standard vial with ˜10 μL flow marker (heptane) added thereto. After loading the vial in the auto-sampler, the oligomer or polymer may automatically be dissolved in the instrument with ˜8 mL added TCB solvent at ˜160° C. with continuous shaking. The sample solution concentration can be from ˜0.2 to ˜2.0 mg/ml, with lower concentrations used for higher molecular weight samples. The concentration, c, at each point in the chromatogram can be calculated from the baseline-subtracted IR5 broadband signal, I, using the equation: c=αI, where α is the mass constant determined with polyethylene or polypropylene standards. The mass recovery can be calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10M gm/mole. The MW at each elution volume is calculated with Equation 1:

$$log M = \frac{log ( {K}_{PS} / K )}{α + 1} + \frac{{α}_{PS} + 1}{α + 1} log {M}_{PS} \qquad Equation 1$$

where the variables with subscript “PS” stand for polystyrene while those without a subscript are for the test samples. In this method, α_{PS}=0.67 and K_{PS}=0.000175, a and K for other materials are as calculated as described in the published in literature (e.g., Sun, T. et al. (2001) Macromolecules, v. 34, pg. 6812), except that for purposes of this present disclosure and claims thereto, α=0.705 and K=0.0000229 for ethylene-propylene copolymers and ethylene-propylene-diene terpolymers, α=0.695 and K=0.000579 for linear ethylene polymers, α=0.705 and K=0.0002288 for linear propylene polymers, and α=0.695 and K=0.000181 for linear butene polymers. Concentrations are expressed in g/cm³, molecular weight is expressed in g/mole, and intrinsic viscosity (hence K in the Mark-Houwink equation) is expressed in dL/g unless otherwise noted.

The comonomer composition is determined by the ratio of the IR5 detector intensity corresponding to CH₂ and CH₃ channel calibrated with a series of PE and PP homo/copolymer standards whose nominal value are predetermined by NMR or FTIR. In particular, this provides the methyls per 1,000 total carbons (CH₃/1000TC) as a function of molecular weight. The short-chain branch (SCB) content per 1,000TC (SCB/1000TC) is then computed as a function of molecular weight by applying a chain-end correction to the CH₃/1000TC function, assuming each chain to be linear and terminated by a methyl group at each end. The weight % comonomer is then obtained from Equation 2 in which f is 0.3, 0.4, 0.6, 0.8, and so on for C₃, C₄, C₆, C₈, and so on co-monomers, respectively:

$$w 2 = f * SCB / 1000 TC . \qquad Equation 2$$

The bulk composition of the polymer from the GPC-IR and GPC-4D analyses is obtained by considering the entire signals of the CH₃ and CH₂ channels between the integration limits of the concentration chromatogram. First, the following ratio in Equation 3 is obtained

$$Bulk IR ratio = \frac{Area of {CH}_{3} signal within integration limits}{Area of {CH}_{2} signal within integration limits} . \qquad Equation 3$$

Then the same calibration of the CH₃ and CH₂ signal ratio, as mentioned previously in obtaining the CH3/1000TC as a function of molecular weight, is applied to obtain the bulk CH3/1000TC. A bulk methyl chain ends per 1,000TC (bulk CH3end/1000TC) is obtained by weight-averaging the chain-end correction over the molecular-weight range. Then Equations 4 and 5 apply

$$\begin{matrix}w 2 b = f * bulk CH 3 / 1000 TC & Equation 4 \\ bulk SCB / 1000 TC = bulk CH 3 / 1000 TC - bulk CH 3 end / 1000 TC & Equation 5\end{matrix}$$

and bulk SCB/1000TC is converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.), as specified in Equation 6:

$$\frac{{K}_{o} c}{Δ R ( θ )} = \frac{1}{MP ( θ )} + 2 {A}_{2} c . \qquad Equation 6$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and K_{O} is the optical constant for the system, as specified in Equation 7:

$${K}_{o} = \frac{4 {π}^{2} {{n}^{2} ( dn / dc )}^{2}}{{λ}^{4} {N}_{A}} \qquad Equation 7$$

where N_{A} is Avogadro's number, and (dn/dc) is the refractive index increment for the system. The refractive index, n=1.500 for TCB at 145° C. and k=665 nm. For analyzing polyethylene homopolymers, ethylene-hexene copolymers, and ethylene-octene copolymers, dn/dc=0.1048 ml/mg and A₂=0.0015; for analyzing ethylene-butene copolymers, dn/dc=0.1048*(1−0.00126*w2) ml/mg and A₂=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, η_{S}, for the solution flowing through the viscometer is calculated from their outputs. The intrinsic viscosity, [η], at each point in the chromatogram is calculated from the equation [η]=η_{S}/c, where c is concentration and is determined from the IR5 broadband channel output. The viscosity MW at each point is calculated as M=K_{PS}M^{α}^{_{PS}}⁺¹/[η], where aps is 0.67 and Kₚₛ is 0.000175.

The branching index (g′_{VIS}) is calculated using the output of the GPC-IR5-LS-VIS method as follows. The average intrinsic viscosity, [η]_{avg}, of the sample is calculated by

$${[ η ]}_{avg} = \frac{Σ {{c}_{i} [ η ]}_{i}}{Σ {c}_{i}} \qquad Equation 8$$

where the summations are over the chromatographic slices, i, between the integration limits.

The branching index g′ᵥᵢₛ is defined as Equation 9:

$${g}_{vis}^{′} = \frac{{[ η ]}_{avg}}{{KM}_{v}^{α}} , \qquad Equation 9$$

where M_{V} is the viscosity-average molecular weight based on molecular weights determined by LS analysis and the K and α are for the reference linear polymer, which are, for purposes of this present disclosure and claims thereto, α=0.705 and K=0.0000229 for ethylene-propylene copolymers and ethylene-propylene-diene terpolymers, α=0.695 and K=0.000579 for linear ethylene polymers, α=0.705 and K=0.0002288 for linear propylene polymers, α=0.695 and K=0.000181 for linear butene polymers. Concentrations are expressed in g/cm³, molecular weight is expressed in g/mole, and intrinsic viscosity (hence K in the Mark-Houwink equation) is expressed in dL/g unless otherwise noted. Calculation of the w2b values is as discussed above.

If not indicated as being measured by 4D-GPC, polymer molecular weights were determined by an automated “Rapid GPC” system as generally described in U.S. Pat. Nos. 6,491,823; 6,491,816; 6,475,391; 6,461,515; 6,454,947; 6,436,292; 6,406,632; 6,294,388, 6,260,407; and 6,175,409; each of which is fully incorporated herein by reference for US purposes. This apparatus was a series of three 30 cm×7.5 mm linear columns, each containing PLgel 10 m, Mix B. The GPC system was calibrated using polystyrene standards ranging from 580-3,390,000 g/mol. The system was operated at an eluent flow rate of 2.0 mL/minutes and an oven temperature of 165° C. 1,2,4-trichlorobenzene was used as the eluent. The polymer samples were dissolved in 1,2,4-trichlorobenzene at a concentration of 0.1-0.9 mg/mL. 250 μL of a polymer solution was injected into the system. The concentration of the polymer in the eluent was monitored using an evaporative light scattering detector or Polymer Char IR4 detector. The molecular weights presented are relative to linear polystyrene standards and are uncorrected.

In some embodiments, the polymers produced herein can have:
a) an Mw of from about 1,000 to about 1,000,000 g/mol (such as from about 25,000 to about 750,000 g/mol, such as from about 50,000 to about 500,000 g/mol, such as from about 80,000 to about 300,000 g/mol, such as from about 80,000 to about 200,000 g/mol) as determined by GPC-4D;
b) a molecular weight distribution, MWD, (Mw/Mn) of greater than about 2, such as from about 2 to about 30, such as from about 3 to about 20, such as from about 4 to about 10 as determined by GPC-4D;
c) a g′ᵥᵢₛ of greater than about 0.5, such as from about 0.5 to about 1, such as from about 0.6 to about 0.9, such as from about 0.7 to about 0.85, such as from about 0.75 to about 0.80, as determined by GPC-4D;
d) a melt flow rate (MFR) of from about 0.1 dg/min to about 1,000 dg/min, such as from about 1 dg/min to about 100 dg/min, such as from about 5 to about 10 dg/min as determined by ASTM D1238 (230° C., 2.16 kg); and/or
e) a Tm of greater than about 120° C., such as from about 130° C. to about 165° C., such as from about 140° C. to about 160° C., such as from about 145° C. to about 155° C. as determined by the differential scanning calorimetry procedure DSC-2 described below.

Polymerization processes of the various embodiments described herein may be carried out in any manner known in the art. Any suspension, homogeneous, bulk, solution, slurry, or gas-phase polymerization process known in the art may be used. Such processes can be run in a batch, semi-batch, or continuous mode. The term “continuous” means a system that operates without interruption or cessation. For example, a continuous process to produce a polymer or oligomer would be one where the reactants are continually introduced into one or more reactors and the polymer or oligomer product is continually withdrawn. Homogeneous polymerization processes and slurry processes can be utilized. A homogeneous polymerization process is defined to be a process where at least 90 wt % of the product is soluble in the reaction media. A bulk homogeneous process is particularly preferred. A bulk process is defined to be a process where monomer concentration in all feeds to the reactor is 70 vol % or more. Alternately, no solvent or diluent is present or added in the reaction medium, (except for the small amounts used as the carrier for the catalyst system or other additives, or amounts typically found with the monomer (e.g., propane in propylene). Alternatively, the process may be a slurry process. As used herein the term “slurry polymerization process” means a polymerization process where a supported catalyst is employed and monomers are polymerized on the supported catalyst particles. At least 95 wt % of oligomer products derived from the supported catalyst are in granular form as solid particles (not dissolved in the diluent). A heterogeneous process is defined to be a process where the catalyst system is not soluble in the reaction media.

Other additives may also be used in the polymerization, as desired, such as one or more scavengers, promoters, modifiers, chain transfer agents (such as diethyl zinc), hydrogen, aluminum alkyls, or silanes. Useful chain transfer agents are typically alkylalumoxanes, a compound represented by the formula AlR₃, ZnR₂ (where each R is, independently, a C₁-C₈ aliphatic radical, preferably methyl, ethyl, propyl, butyl, pentyl, hexyl, octyl or an isomer thereof) or a combination thereof; such as diethylzinc, methylalumoxane, trimethylaluminum, triisobutylaluminum, trioctylaluminum, diethylaluminum chloride, ethylaluminum dichloride, or a combination thereof.

Suitable diluents/solvents for polymerization include non-coordinating, inert liquids. Examples include: straight and branched-chain hydrocarbons (e.g., isobutane, butane, pentane, isopentane, hexanes, isohexane, heptane, octane, dodecane, and/or mixtures thereof); cyclic and alicyclic hydrocarbons (e.g., cyclohexane, cycloheptane, methylcyclohexane, methylcycloheptane, and/or mixtures thereof, such as may be found commercially (Isopar™)); perhalogenated hydrocarbons (e.g., perfluorinated C₄₋₁₀ alkanes, chlorobenzene, and aromatic and alkyl-substituted aromatic compounds, such as benzene, toluene, mesitylene, and xylene). Suitable solvents also include liquid olefins which optionally can act as monomers or co-monomers, such as, but not limited to: ethylene, propylene, 1-butene, 1-hexene, 1-pentene, 3-methyl-1-pentene, 4-methyl-1-pentene, 1-octene, 1-decene, and/or mixtures thereof. In a preferred embodiment, aliphatic hydrocarbon solvents (e.g., isobutane, butane, pentane, isopentane, hexanes, isohexane, heptane, octane, dodecane, and/or mixtures thereof) or cyclic and alicyclic hydrocarbons (e.g., cyclohexane, cycloheptane, methylcyclohexane, methylcycloheptane, and/or mixtures thereof) can be used. In any embodiment, the solvent can be substantially absent any aromatic compounds. For example, aromatic compounds can be present in the solvent at less than 1 wt %, preferably less than 0.5 wt %, preferably less than 0 wt % based upon the weight of the solvents. In any embodiment, a feed stream can comprise a diluent/solvent from about 60 vol % or less, about 40 vol % or less, or 20 vol % or less, based on the total volume of the feed stream. This includes from 0 vol % to about 60 vol %, from about 0 vol % to about 40 vol %, and about 0 vol % to about 20 vol %. Typical temperatures and/or pressures include a temperature in the range of about 0° C. to about 300° C., preferably about 20° C. to about 200° C., preferably about 35° C. to about 150° C., preferably from about 40° C. to about 120° C., preferably from about 45° C. to about 80° C.; and at a pressure in the range of from about 0.35 MPa to about 10 MPa, preferably from about 0.45 MPa to about 6 MPa, or preferably from about 0.5 MPa to about 4 MPa.

In any of the polymerization reactions disclosed herein, the polymerization reaction conditions can include a reaction temperature from about 30° C. to about 200° C., or from about 50° C. to about 150° C., or from about 80° C. to about 140° C., or from about 90° C. to about 130° C. Alternately, the polymerization reaction conditions can include a temperature ranging from about 30° C. or higher, or about 50° C. or higher, or about 100° C. or higher up to the boiling point of the solvent used in solution polymerization under the conditions present in the reactor.

Polymerization run times may be up to about 300 minutes, for example, in the range of from about 5 minutes to about 250 minutes, which includes from about 10 minutes to about 120 minutes. For continuous polymerization processes, the run time may correspond to a residence time in the reactor.

Processing of the oligomers can take place following the polymerization reaction. Suitable processing operations can include, but are not limited to: blending, or co-extrusion with any other polymer. Non-limiting examples of other polymers include, but are not limited to: linear low-density polyethylenes, elastomers, plastomers, high-pressure low-density polyethylene, high-density polyethylenes, polypropylenes, and/or the like. The oligomers formed according to the present disclosure can also be blended with additives to form compositions that may then be used in articles of manufacture. Suitable additives can include, but are not limited to: antioxidants, nucleating agents, acid scavengers, plasticizers, stabilizers, anticorrosion agents, blowing agents, ultraviolet light absorbers, quenchers, antistatic agents, slip agents, phosphites, phenolics, pigments, dyes and fillers and cure agents such as peroxide.

In various embodiments, hydrogen can be included in the polymerization reaction conditions to provide increased activity without significantly impairing the catalytic activity of the metal-ligand complexes. Catalyst activity (e.g., calculated as g/mmol catalyst/hour) can be at least 20% higher than the same reaction without hydrogen present, which includes at least 50% higher and at least 100% higher. The activity of the catalyst may be at least 50 g/mmol/hour, at least about 500 g/mmol/hour, at least about 5,000 g/mmol/hour, or at least about 50,000 g/mmol/hour. The conversion of an olefinic feed, based upon oligomer yield and the weight of the olefin monomer entering the reaction zone, can be at least about 10%, at least about 20%, at least about 30%, at least about 50%, or at least about 80%.

In a preferred embodiment, the polymerization: 1) is conducted at temperatures of 0° C. to 300° C. (preferably 25° C. to 150° C., preferably 40° C. to 120° C., preferably 45° C. to 80° C.); 2) is conducted at a pressure of atmospheric pressure to 10 MPa (preferably 0.35 to 10 MPa, preferably from 0.45 to 6 MPa, preferably from 0.5 to 4 MPa); 3) is conducted in an aliphatic hydrocarbon solvent (such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; preferably where aromatics are preferably present in the solvent at less than 1 wt %, preferably less than 0.5 wt %, preferably at 0 wt % based upon the weight of the solvents); 4) includes a catalyst system in the polymerization that comprises less than 0.5 mol %, preferably 0 mol % alumoxane, alternately the alumoxane is present at a molar ratio of aluminum to transition metal less than 500:1, preferably less than 300:1, preferably less than 100:1, preferably less than 1:1; 5) the polymerization preferably occurs in one reaction zone; 6) the productivity of the catalyst compound is at least 80,000 g/mmol/hr (preferably at least 150,000 g/mmol/hr, preferably at least 200,000 g/mmol/hr, preferably at least 250,000 g/mmol/hr, preferably at least 300,000 g/mmol/hr); 7) optionally scavengers (such as trialkyl aluminum compounds) are absent (e.g. present at 0 mol %, alternately the scavenger is present at a molar ratio of scavenger metal to transition metal of less than 100:1, preferably less than 50:1, preferably less than 15:1, preferably less than 10:1); and 8) optionally hydrogen is present in the polymerization reactor at a partial pressure of 0.001 to 50 psig (0.007 to 345 kPa) (preferably from 0.01 to 25 psig (0.07 to 172 kPa), more preferably 0.1 to 10 psig (0.7 to 70 kPa)). In a preferred embodiment, the catalyst system used in the polymerization comprises no more than one catalyst compound. A “reaction zone” also referred to as a “polymerization zone” is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In a preferred embodiment, the polymerization occurs in one reaction zone. Room temperature is 23° C. unless otherwise noted.

Polymerization of an olefinic feed stream may be carried out in a reaction zone within a reactor. A system can include multiple reactors and/or multiple reaction zones. A reactor can be a batch reactor, a semi-batch reactor, or a continuous reactor. Examples of suitable continuous reactors include, but are not limited to: continuous stirred tanks (and trains thereof), loop-type reactors, fluidized bed reactors, a combination thereof, and/or the like. Multiple reactors can be in series or in parallel. A reactor can include at least one reaction zone comprising one or more metal-ligand complexes containing a ligand represented by Formula 1 as a polymerization catalyst. A reactor may further include at least one inlet, configured and arranged to receive a feed stream and at least one outlet, configured and arranged to receive a product stream. In any embodiment where two or more different alpha olefins are reacted, a reactor may include additional inlets for receiving a stream comprising additional monomers. A reactor can further comprise one or more additional inlets for introducing one or more of a catalyst (e.g., one or more of the metal-ligand complexes described herein), diluent, or any other material, for example, a hydrogen stream, and/or a catalyst poison, into the reactor. A system can also comprise conduits for conveying spent catalyst to a catalyst regeneration system. A system comprising a reactor may also comprise equipment, processors, and controls for regulating various reactor conditions including, but not limited to, pressure, temperature, and flow rate. A system comprising a reactor can also comprise equipment and plumbing to recycle unused monomer, process gas, hydrogen, or any combination thereof, back into the system. One of ordinary skill in the art will be able to employ the catalyst systems disclosed herein to generate a product stream comprising a high yield of PAOs using reactors and equipment well known in the art without undue experimentation.

Embodiments disclosed herein include:
A. Catalyst systems containing two different metallocenes. The catalyst systems comprise: at least one first metallocene having a structure represented by Formula 1, at least one second metallocene different from the at least one first metallocene; optionally, a support; optionally, a scavenger; and an activator;

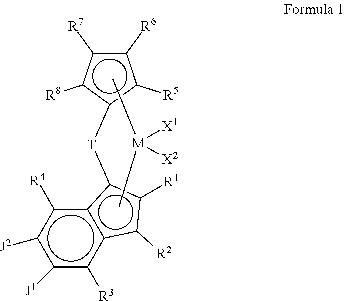

wherein:
   M is a Group 4 metal;
   T is a bridging group;
   X¹ and X² are each a univalent anionic ligand, or X¹ and X² are joined to form a metallocycle ring, a chelating ligand, a diene ligand, or an alkylidene;
   R¹ is hydrogen, halogen, optionally substituted C₁-C₄₀ alkyl, optionally substituted C₆-C₁₄ aryl, optionally substituted C₄-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
   R² and R⁴ are independently hydrogen, halogen, optionally substituted C₁-C₄₀ alkyl, optionally substituted C₆-C₁₄ aryl, optionally substituted C₄-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
      R³ is optionally substituted C₁-C₄₀ alkyl or optionally substituted C₆-C₁₄ aryl;
   R⁵, R⁶, R⁷, and R⁸ are independently hydrogen, halogen, optionally substituted C₁-C₄₀ alkyl, optionally substituted C₆-C₁₄ aryl, optionally substituted C₄-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl, or one or more of R⁵ and R⁶, R⁶ and R⁷, or R⁷ and R⁸ are joined to form a C₃-C₆₂ substituted or unsubstituted, saturated or unsaturated, cyclic or polycyclic ring structure, or a combination thereof; and
   J¹ and J² are each H, or J¹ and J² are joined to form a C₃-C₆₂ substituted or unsubstituted, saturated or unsaturated, cyclic or polycyclic ring structure, or a combination thereof.
B. Polymerization processes employing the catalyst system of A. The processes comprise: providing an olefinic feed; and contacting the catalyst system of A with the olefinic feed under polymerization reaction conditions to produce a polyolefin.
C. Metallocene compositions. The metallocene compositions comprise: at least one metallocene having a structure represented by Formula 9

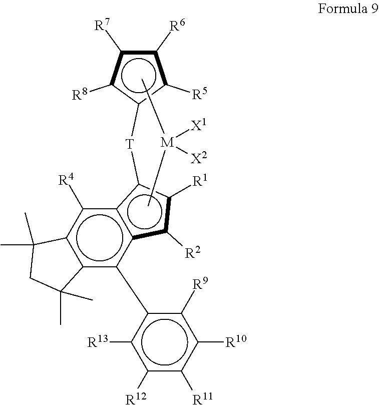

wherein:
   M is a Group 4 metal;
   T is a bridging group;
   X¹ and X² are each a univalent anionic ligand, or X¹ and X² are joined to form a metallocycle ring, a chelating ligand, a diene ligand, or an alkylidene;
   R¹ is hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
   R² and R⁴ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
   R⁵, R⁶, R⁷, and R⁸ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl, or one or more of R⁵ and R⁶, R⁶ and R⁷, or R⁷ and R⁸ are joined to form a C₃-C₆₂ substituted or unsubstituted, saturated or unsaturated, cyclic or polycyclic ring structure, or a combination thereof; and
   R¹¹—R¹⁵ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and each R′ is hydrogen, C₁-C₁₀ alkyl, or C₆-C₁₀ aryl, or R¹¹ and R¹², R¹² and R¹³, R¹³ and R¹⁴, or R¹⁴ and R¹⁵, or any combination thereof are joined to form a C₃-C₆₂ substituted or unsubstituted, saturated or unsaturated, cyclic or polycyclic ring structure, or a combination thereof.
D. Catalyst systems employing the metallocene composition of C. The catalyst systems comprise: the metallocene composition of C, an activator, optionally, a support, and optionally, a scavenger.
E. Polymerization processes employing the catalyst system of D. The processes comprise: providing an olefinic feed; and contacting the catalyst system of D with the olefinic feed under polymerization reaction conditions to produce a polyolefin.

Embodiments A and B may have one or more of the following additional elements present in any combination:
Element 1: wherein M is zirconium or hafnium.
Element 2: wherein T is (R*₂G)_{g}; wherein each G is independently C, Si, or Ge, g is 1 or 2, and each R* is independently hydrogen, halogen, or C₁-C₂₀ optionally substituted hydrocarbyl, or two or more R* are joined to form a C₃-C₆₂ substituted or unsubstituted, saturated or unsaturated, cyclic or polycyclic ring structure, or a combination thereof.
Element 3: wherein T is selected from the group consisting of CH₂, CH₂CH₂, C(CH₃)₂, (Ph)₂C, (p-(Et)₃SiPh)₂C, SiMe₂, SiPh₂, SiMePh, Si(CH₂)₃, Si(CH₂)₄, and Si(CH₂)₄.
Element 4: wherein X¹ and X² are independently halogen or C₁-C₆ hydrocarbyl.
Element 5: wherein: T is SiR⁹R¹⁰, wherein R⁹ and R¹⁰ are independently optionally substituted C₁-C₄₀ alkyl or optionally substituted C₆-C₁₄ aryl, or R⁹ and R¹⁰ are joined to form a C₃-C₆₂ substituted or unsubstituted, saturated or unsaturated, cyclic or polycyclic ring structure, or a combination thereof; J¹ and J² are joined to define an optionally substituted indacenyl ring system; R² and R⁴ are H; and R³ is a bulky alkyl group.
Element 6: wherein R³ is optionally substituted cyclohexyl, optionally substituted norbornanyl, optionally substituted adamantyl, or optionally substituted t-butyl.
Element 7: wherein: T is SiR⁹R¹⁰, wherein R⁹ and R¹⁰ are independently optionally substituted C₁-C₄₀ alkyl or optionally substituted C₆-C₁₄ aryl, or R⁹ and R¹⁰ are joined to form a C₃-C₆₂ substituted or unsubstituted, saturated or unsaturated, cyclic or polycyclic ring structure, or a combination thereof; J¹ and J² are joined to define an optionally substituted indacenyl ring system; R² and R⁴ are H; and R³ is an optionally substituted phenyl group.
Element 8: wherein J¹ and J² define a 1,1,3,3-tetramethyl-trihydro-s-indacenyl ring system.
Element 9: wherein the second metallocene has a structure represented by Formula 10

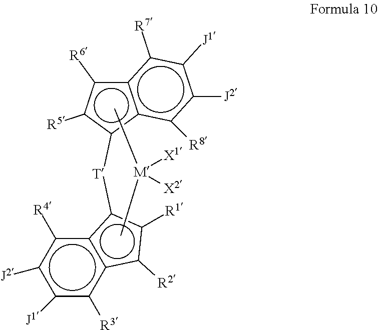

wherein:
   M′ is a Group 4 metal;
T′ is a bridging group;
   X^{1′} and X^{2′} are each a univalent anionic ligand, or X^{1′} and X^{2′} are joined to form a metallocycle ring, a chelating ligand, a diene ligand, or an alkylidene;
   R^{1′} and R^{5′} are hydrogen or optionally substituted C₁-C₄₀ alkyl;
   R^{3′} and R^{7′} are hydrogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
   R^{2′}, R^{4′}, R^{6′}, and R^{8′} are independently hydrogen, optionally substituted C₁-C₄₀ alkyl, or optionally substituted C₆-C₁₄ aryl; and
   J^{1′} and J^{2′} are each H, or J^{1′} and J^{2′} are joined to form a C₃-C₆₂ substituted or unsubstituted, saturated or unsaturated, cyclic or polycyclic ring structure, or a combination thereof.
Element 10: wherein T′ is SiR^{9′}R^{10′}, wherein R^{9′} and R^{10′} are independently optionally substituted C₁-C₄₀ alkyl or optionally substituted C₆-C₁₄ aryl, or R^{9′} and R^{10′} are joined to form a C₃-C₆₂ substituted or unsubstituted, saturated or unsaturated, cyclic or polycyclic ring structure, or a combination thereof.
Element 11: wherein the activator is an aluminoxane, a salt of a non-coordinating anion, or any combination thereof.
Element 12: wherein the support is present and comprises a support material.
Element 13: wherein the support material is selected from the group consisting of Al₂O₃, ZrO₂, SiO₂, SiO₂/Al₂O₃, SiO₂/TiO₂, silica clay, silicon oxide/clay, or mixtures thereof.
Element 14: wherein the olefinic feed comprises at least propylene, and the polyolefin is a propylene polymer that is a homopolymer or a copolymer.
Element 15: wherein the propylene polymer contains greater than 45% vinyl-terminated groups.
Element 16: wherein the propylene polymer has a Mw value of 1,000 to 500,000 g/mol, as measured by gel permeation chromatography.
Element 17: wherein the propylene polymer has a polydispersity index greater than 2.
Element 18: wherein the propylene polymer has a melting point of greater than 120° C.
Element 19: wherein the propylene polymer is long-chain branched with a g′ᵥᵢₛ value of less than 0.9, as measured by multi-detector gel-permeation chromatography.

Illustrative combinations applicable to A and B include, but are not limited to, 1, and 2 or 3; 1, 2 or 3, and 4; 1, 2 or 3, 4, and 5 or 7; 1, 2 or 3, and 5 or 7; 1, and 5 or 7; 1 and 9; 1, 5 or 7, and 9; 1, 2, 5 or 7, and 9; 1, 9, and 10; 2 or 3, and 4; 2 or 3, 4, and 5 or 7; 2 or 3, and 5 or 7; 2 or 3, and 9; 2 or 3, 5 or 7, and 9; 2 or 3, 9, and 10; 5 or 7, and 9; and 5 or 7, 9, and 10. Any of 11, 12, and/or 13 may be in combination with A or B or in further combination with any of the foregoing. With respect to B, any of the foregoing may be in further combination with 14 and one or more of 15-19.

Embodiments C-E may have one or more of the following additional elements present in any combination:
Element 20: wherein T is selected from the group consisting of CH₂, CH₂CH₂, C(CH₃)₂, (Ph)₂C, (p-(Et)₃SiPh)₂C, SiMe₂, SiPh₂, SiMePh, Si(CH₂)₃, Si(CH₂)₄, and Si(CH₂)₄.
Element 21: wherein R² and R⁴ are hydrogen.

With respect to C-E, 20 and 21 may be in combination with each other. Any of 11, 12, and/or 13 may be in combination with C-E or in further combination with 20, 21, or 21 and 22. Additional combinations applicable to C-E may include, but are not limited to, 2, and 3 or 4; 2, 3 or 4, and 5; 2, 3 or 4, and 21; 3 or 4, and 5; and 3 or 4, and 21.

The present disclosure further relates to the following non-limiting embodiments:
Embodiment 1. A mixed metallocene catalyst system comprising: at least one first metallocene having a structure represented by Formula 1, at least one second metallocene different from the at least one first metallocene; optionally, a support; optionally, a scavenger; and an activator;

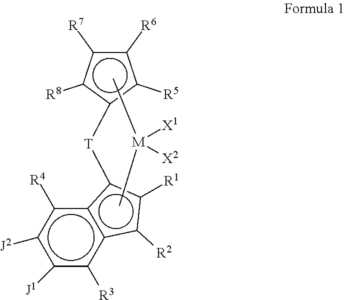

wherein:
   M is a Group 4 metal;
   T is a bridging group;
   X¹ and X² are each a univalent anionic ligand, or X¹ and X² are joined to form a metallocycle ring, a chelating ligand, a diene ligand, or an alkylidene;
   R¹ is hydrogen, halogen, optionally substituted C₁-C₄₀ alkyl, optionally substituted C₆-C₁₄ aryl, optionally substituted C₄-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
   R² and R⁴ are independently hydrogen, halogen, optionally substituted C₁-C₄₀ alkyl, optionally substituted C₆-C₁₄ aryl, optionally substituted C₄-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
      R³ is optionally substituted C₁-C₄₀ alkyl or optionally substituted C₆-C₁₄ aryl;
   R⁵, R⁶, R⁷, and R⁸ are independently hydrogen, halogen, optionally substituted C₁-C₄₀ alkyl, optionally substituted C₆-C₁₄ aryl, optionally substituted C₄-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl, or one or more of R⁵ and R⁶, R⁶ and R⁷, or R⁷ and R⁸ are joined to form a C₃-C₆₂ substituted or unsubstituted, saturated or unsaturated, cyclic or polycyclic ring structure, or a combination thereof; and
      J¹ and J² are each H, or J¹ and J² are joined to form a C₃-C₆₂ substituted or unsubstituted, saturated or unsaturated, cyclic or polycyclic ring structure, or a combination thereof.
Embodiment 2. The mixed metallocene catalyst system of Embodiment 1, wherein M is zirconium or hafnium.
Embodiment 3. The mixed metallocene catalyst system of Embodiment 1 or Embodiment 2, wherein T is (R*₂G)_{g}; wherein each G is independently C, Si, or Ge, g is 1 or 2, and each R* is independently hydrogen, halogen, or C₁-C₂₀ optionally substituted hydrocarbyl, or two or more R* are joined to form a C₃-C₆₂ substituted or unsubstituted, saturated or unsaturated, cyclic or polycyclic ring structure, or a combination thereof.
Embodiment 4. The mixed metallocene catalyst system of any one of Embodiments 1 to 3, wherein T is selected from the group consisting of CH₂, CH₂CH₂, C(CH₃)₂, (Ph)₂C, (p-(Et)₃SiPh)₂C, SiMe₂, SiPh₂, SiMePh, Si(CH₂)₃, Si(CH₂)₄, and Si(CH₂)₄.
Embodiment 5. The mixed metallocene catalyst system of any one of Embodiments 1 to 4, wherein X¹ and X² are independently halogen or C₁-C₆ hydrocarbyl.
Embodiment 6. The mixed metallocene catalyst system of any one of Embodiments 1 to 5, wherein: T is SiR⁹R¹⁰, wherein R⁹ and R¹⁰ are independently optionally substituted C₁-C₄₀ alkyl or optionally substituted C₆-C₁₄ aryl, or R⁹ and R¹⁰ are joined to form a C₃-C₆₂ substituted or unsubstituted, saturated or unsaturated, cyclic or polycyclic ring structure, or a combination thereof; J¹ and J² are joined to define an optionally substituted indacenyl ring system; R² and R⁴ are H; and R³ is a bulky alkyl group.
Embodiment 7. The mixed metallocene catalyst system of any one of Embodiments 1 to 6, wherein R³ is optionally substituted cyclohexyl, optionally substituted norbornanyl, optionally substituted adamantyl, or optionally substituted t-butyl.
Embodiment 8. The mixed metallocene catalyst system of any one of Embodiments 1 to 5, wherein: T is SiR⁹R¹⁰, wherein R⁹ and R¹⁰ are independently optionally substituted C₁-C₄₀ alkyl or optionally substituted C₆-C₁₄ aryl, or R⁹ and R¹⁰ are joined to form a C₃-C₆₂ substituted or unsubstituted, saturated or unsaturated, cyclic or polycyclic ring structure, or a combination thereof; J¹ and J² are joined to define an optionally substituted indacenyl ring system; R² and R⁴ are H; and R³ is an optionally substituted phenyl group.
Embodiment 9. The mixed metallocene catalyst system of any one of Embodiments 1 to 8, wherein J¹ and J² define a 1,1,3,3-tetramethyl-trihydro-s-indacenyl ring system.
Embodiment 10. The mixed metallocene catalyst system of any one of Embodiments 1 to 9, wherein the second metallocene has a structure represented by Formula 10

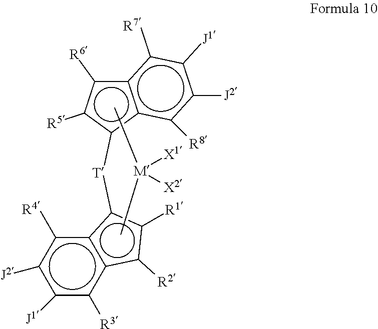

wherein:
   M′ is a Group 4 metal;
T′ is a bridging group;
   X^{1′} and X^{2′} are each a univalent anionic ligand, or X^{1′} and X^{2′} are joined to form a metallocycle ring, a chelating ligand, a diene ligand, or an alkylidene;
   R^{1′} and R^{5′} are hydrogen or optionally substituted C₁-C₄₀ alkyl;
   R^{3′} and R^{7′} are hydrogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
   R^{2′}, R^{4′}, R^{6′}, and R^{8′} are independently hydrogen, optionally substituted C₁-C₄₀ alkyl, or optionally substituted C₆-C₁₄ aryl; and
      J^{1′} and J^{2′} are each H, or J^{1′} and J^{2′} are joined to form a C₃-C₆₂ substituted or unsubstituted, saturated or unsaturated, cyclic or polycyclic ring structure, or a combination thereof.
Embodiment 11. The catalyst system of Embodiment 10, wherein T′ is SiR^{9′}R^{10′}, wherein R^{9′} and R^{10′} are independently optionally substituted C₁-C₄₀ alkyl or optionally substituted C₆-C₁₄ aryl, or R^{9′} and R^{10′} are joined to form a C₃-C₆₂ substituted or unsubstituted, saturated or unsaturated, cyclic or polycyclic ring structure, or a combination thereof.
Embodiment 12. The catalyst system of any one of Embodiments 1-11, wherein the activator is an aluminoxane, a salt of a non-coordinating anion, or any combination thereof.
Embodiment 13. The catalyst system of any of Embodiments 1-12, wherein the support is present and comprises a support material.
Embodiment 14. The catalyst system of Embodiment 13, wherein the support material is selected from the group consisting of Al₂O₃, ZrO₂, SiO₂, SiO₂/Al₂O₃, SiO₂/TiO₂, silica clay, silicon oxide/clay, or mixtures thereof.
Embodiment 15. A polymerization process comprising:
   providing an olefinic feed; and
   contacting the catalyst system of any one of Embodiments 1-14 with the olefinic feed under polymerization reaction conditions to produce a polyolefin.
Embodiment 16. The polymerization process of Embodiment 15, wherein the olefinic feed comprises at least propylene, and the polyolefin is a propylene polymer that is a homopolymer or a copolymer.
Embodiment 17. The polymerization process of Embodiment 16, wherein the propylene polymer contains greater than 45% vinyl-terminated groups.
Embodiment 18. The polymerization process of Embodiment 16 or Embodiment 17, wherein the propylene polymer has a Mw value of 1,000 to 500,000 g/mol, as measured by gel permeation chromatography.
Embodiment 19. The polymerization process of any one of Embodiments 16 to 18, wherein the propylene polymer has a polydispersity index greater than 2.
Embodiment 20. The polymerization process of any one of Embodiments 16 to 19, wherein the propylene polymer has a melting point of greater than 120° C.
Embodiment 21. The polymerization process of any one of Embodiments 16 to 20, wherein the propylene polymer is long-chain branched with a g′ᵥᵢₛ value of less than 0.9, as measured by multi-detector gel-permeation chromatography.
Embodiment 22. A metallocene composition comprising:
   at least one metallocene having a structure represented by Formula 9

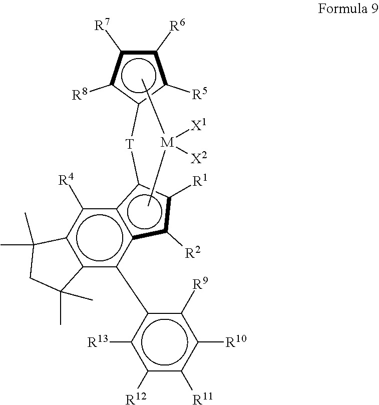

wherein:
M is a Group 4 metal;
T is a bridging group;
X¹ and X² are each a univalent anionic ligand, or X¹ and X² are joined to form a metallocycle ring, a chelating ligand, a diene ligand, or an alkylidene;
R¹ is hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
R² and R⁴ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
R⁵, R⁶, R⁷, and R⁸ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl, or one or more of R⁵ and R⁶, R⁶ and R⁷, or R⁷ and R⁸ are joined to form a C₃-C₆₂ substituted or unsubstituted, saturated or unsaturated, cyclic or polycyclic ring structure, or a combination thereof; and
R¹¹—R¹⁵ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and each R′ is hydrogen, C₁-C₁₀ alkyl, or C₆-C₁₀ aryl, or R¹¹ and R¹², R¹² and R¹³, R¹³ and R¹⁴, or R¹⁴ and R¹⁵, or any combination thereof are joined to form a C₃-C₆₂ substituted or unsubstituted, saturated or unsaturated, cyclic or polycyclic ring structure, or a combination thereof.
Embodiment 23. The metallocene composition of Embodiment 22, wherein T is selected from the group consisting of CH₂, CH₂CH₂, C(CH₃)₂, (Ph)₂C, (p-(Et)₃SiPh)₂C, SiMe₂, SiPh₂, SiMePh, Si(CH₂)₃, Si(CH₂)₄, and Si(CH₂)₄.
Embodiment 24. The metallocene composition of Embodiment 22 or Embodiment 23, wherein R² and R⁴ are hydrogen.
Embodiment 25. A catalyst system comprising the metallocene composition of Embodiment 22, an activator, optionally, a support, and optionally, a scavenger.
Embodiment 26. A polymerization process comprising:
   providing an olefinic feed; and
   contacting the catalyst system of claim 25 with the olefinic feed under polymerization reaction conditions to produce a polyolefin.

To facilitate a better understanding of the embodiments described herein, the following examples of various representative embodiments are given. In no way should the following examples be read to limit, or to define, the scope of the present disclosure.

### Examples

The foregoing discussion can be further described with reference to the following non-limiting examples.

### Metallocene Syntheses

4-Alkyl-Substituted Metallocenes: 4-Alkyl-substituted metallocenes were prepared in the manner outlined in Scheme 4 below. Synthesis of the 2-methyl-4-adamantyl zirconium metallocene analogue (Catalyst C16-Zr) is shown as a representative example. The as-produced zirconium dichloride complex may be converted to the corresponding dimethyl analogue through treatment with trimethylaluminum, as further shown in Scheme 4. Other alkyl-substituted Group 4 metallocenes may be synthesized in a similar manner.

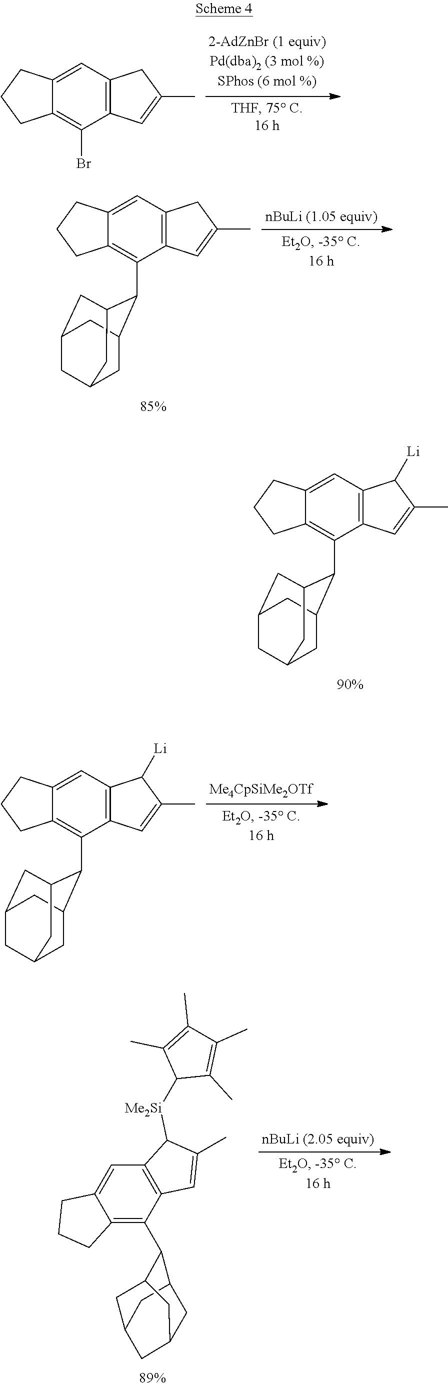

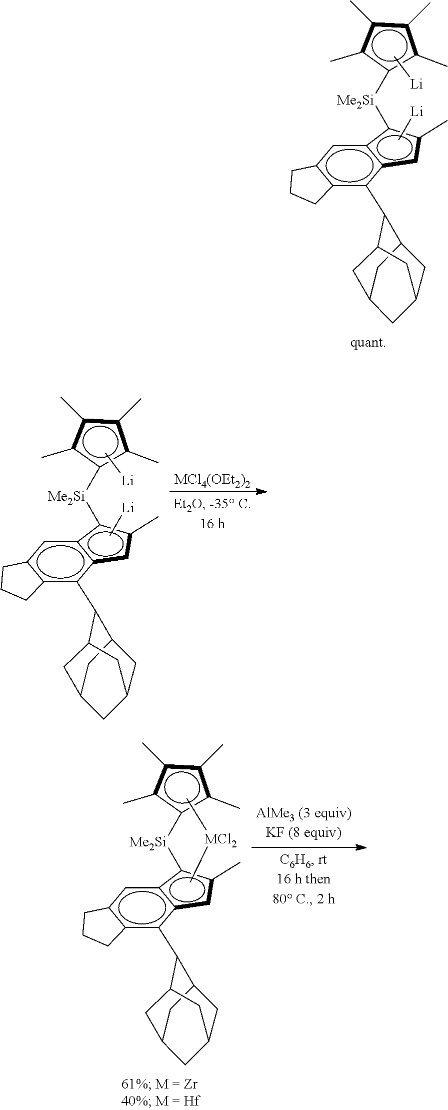

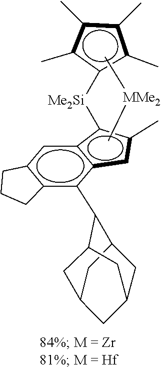

¹H NMR data of catalysts and ligands was collected at 23° C. using a 5 mm tube on a 400 MHz Bruker spectrometer with deuterated methylene chloride (CD₂Cl₂), benzene (C₆D6) or THF (thf-d8). Data was recorded with a 30° pulse with either 8 or 16 transients.

(1R,3S,5r,7r)-2-(6-methyl-1,2,3,7-tetrahydro-s-indacen-4-yl)adamantane. A combined solution of 2-methyl-4-bromo-tetrahydro-s-indacene (0.789 g, 3 mmol), Pd catalyst (3 mol %) and SPhos (6 mol %) ligand in THF was slowly added a solution of 2-adamantyl zinc bromide (6.6 mL, 0.5M, 1 equiv.). The solution was heated to 75° C. overnight. After 18 hours, the resulting orange mixture was acidified with HCl (10% solution) and concentrated under N2 stream. Water (25 mL) was then added, and the aqueous layer was extracted with diethyl ether (3×20 mL). The organic extracts were washed with water (3×20 mL) and brine (1×20 mL), dried over MgSO₄, filtered and concentrated in vacuo to give an orange oil. The resulting oil was chromatographed (5% EtOAc/hexane then 5-10% gradient). Solvent removal resulted in isolation of white-crystalline material (0.83 g, 85% yield). ¹H NMR (400 MHz, CD2Cl2) δ 7.06 (s, 1H), 6.42 (s, 1H), 3.49 (s, 2H), 3.39 (s, 1H), 2.93 (m, 4H), 2.46 (s, 2H), 2.15 (m, 5H), 2.02 (m, 5H), 1.84 (m, 4H), 1.78 (m, 4H).

(4-((1R,3S,5r,7r)-adamantan-2-yl)-2-methyl-1,5,6,7-tetrahydro-s-indacen-1-yl)lithium. BuLi (1.19 mL, 2.5 M) was slowly added to a cooled solution (−35° C.) of indacene (0.83 g, 3 mmol) in diethylether. The mixture very quickly became cloudy with white precipitate. It was allowed to stir for 18 hours. After 18 hours, solvent was removed in vacuo, and the residue was washed with pentane (20 mL), filtered and dried in vacuo (0.81 g white powder, 90% yield). ¹H NMR (400 MHz, C₆D₆/THF) δ 7.26 (s, 1H), 5.95 (s, 1H), 5.92 (s, 1H), 3.70 (s, 1H) 3.05 (m, 2H), 2.83 (m, 4H), 2.46 (s, 3H), 2.19 (m 2H), 2.20 (m, 2H), 1.89 (m, 8H), 1.66 (m, 2H).

(4-((5r,7r)-adamantan-2-yl)-2-methyl-1,5,6,7-tetrahydro-s-indacen-1-yl) dimethyl (2,3,4,5 tetramethylcyclopenta-2,4-dien-1-yl) silane. Lithium indacene slurry in diethylether (0.81 g) was cooled to −35° C. in a glove box freezer. In a small vial, a solution of Me₄CpSi(Me)₂OTf (0.77 g, 1 equiv.) in diethylether was cooled to −35° C. While stirring, the solution of Me₄CpSi(Me)₂OTf was added to the solution of lithium indacenide. Due to poor solubility additional 2 mL of THF were added and the resulting clear, pale yellow solution was stirred overnight. After 18 hours, solvent was removed in vacuo to yield an off-white solid. The solid was extracted with pentane (20 mL), filtered and dried in vacuo to give a white solid in excellent purity (1.01 g, 89% yield). ¹H NMR (400 MHz, C₆D₆/THF) δ 7.35 (s, 1H), 6.93 (s, 1H), 3.61 (s, 1H), 3.45 (s, 1H), 3.28 (s, 1H), 2.86 (m, 4H), 2.74 (s, 1H), 2.44 (m, 2H) 2.14 (s, 3H), 2.02 (m, 7H) 1.99 (s, 3H) 1.94 (s, 3H), 1.83 (s, 6H), 1.69 (m, 6H), −0.21 (s, 3H), −0.20 (s, 3H).

General procedure for metallocene synthesis. To an ether solution of ligand (1 equiv.) was slowly added 2.05 equiv. nBuLi at −35° C. The mixture initially showed no apparent color change, but it turned orange with precipitate upon warming up to room temperature. It was allowed to stir overnight. After 18 hours, the mixture was cooled back down to −35° C. While stirring, MCl₄(OEt₂)₂(M=Zr, Hf) was added as a powder. Initially no color change was observed. As the reaction mixture warmed to room temperature, the solution became orange with precipitate. It was allowed to stir at room temperature overnight. After 20 hours, the mixture was concentrated under vacuum to give a yellow solids. The solids were extracted with methylene chloride, filtered and concentrated in vacuo. Excess pentane was added and the mixture was stirred for 2 hours at room temperature, filtered and washed with minimum pentane to give metallocenes as yellow solids.

Catalyst C16-Zr (61% Yield)¹H NMR (400 MHz, CD₂Cl₂) δ 7.30 (s, 1H), 6.86 (s, 1H), 3.44 (s, 1H), 3.14 (s, 2H), 2.80 (s, 3H), 2.62 (d, 2H), 2.31 (s, 3H), 2.09 (s, 4H), 2.05 (s, 3H), 2.03-1.97 (m, 4H), 1.95 (s, 3H), 1.90 (s, 3H), 1.86 (s, 3H), 1.84 (s, 3H), 1.72 (s, 3H), 1.20 (s, 3H), 1.10 (s, 3H).

Catalyst C16-Hf (40% Yield)¹H NMR (500 MHz, CD₂Cl₂) δ 7.33 (s, 1H), 6.74 (s, 1H), 3.43 (s, 1H), 3.18 (t, 2H), 2.91-2.79 (m, 1H), 2.79-2.69 (m, 1H), 2.61 (d, 2H), 2.40 (s, 3H), 2.16 (s, 3H), 2.14-2.06 (m, 4H), 2.06-2.00 (m, 3H), 1.98 (d, 6H), 1.89 (s, 3H), 1.84 (t, 3H), 1.77-1.68 (m, 4H), 1.19 (s, 3H), 1.10 (s, 3H).

General procedure for alkylation of metallocenes. To a stirring mixture of metallocene and KF (8 equiv.) in benzene was added neat TMA (3 equiv.). No initial color change was observed. The mixture was allowed to react for 16 hours. After 16 hours, the mixture was additionally heated to 75° C. for 2 hours filtered over KF (2×120 mg) and dried under vacuum. Solvent removal yielded pure dimethyl-complexes with a minor amount of mono-methyl (5-10%).

Methylated Catalyst C16-Zr (Yield=84%) ¹H NMR (500 MHz, Benzene-d₆) δ 7.27 (s, 1H), 7.13 (s, 1H) 3.72 (s, 1H), 3.13-2.95 (m, 3H), 2.94 (s, 1H), 2.80-2.55 (m, 4H), 2.35-2.13 (m, 5H), 2.09 (s, 3H) 2.07 (m, 1H), 1.97 (m, 3H), 1.92 (s, 4H), 1.86-1.81 (m, 9H), 1.81-1.68 (m, 8H), 0.84 (s, 3H), −1.30 (s, 3H).

Methylated Catalyst C16-Hf (Yield=81%)¹H NMR (500 MHz, Benzene-d₆) δ 7.30 (s, 1H), 7.04 (d, 1H), 3.69 (s, 1H), 3.14-2.98 (m, 3H), 2.93 (s, 1H), 2.80-2.58 (m, 5H), 2.13 (s, 3H), 2.20 (m, 2H) 1.97 (d, 3H), 1.92-1.89 (m, 8H), 1.86 (s, 3H), 1.80 (s, 3H), 1.78 (d, 3H), 1.74-1.65 (m, 3H), 0.84 (s, 3H), −0.19 (s, 3H), −1.49 (s, 3H).

4-Aryl-Substituted Metallocenes: 4-Aryl-substituted metallocenes were prepared through a similar sequence of reactions to those illustrate in Scheme 4, except the aryl group was introduced to the indenyl ring through Suzuki coupling with an arylboronic acid reagent. Synthesis of the 2-methyl-4-t-butylphenyl zirconium metallocene analogue (Catalyst C17-Zr) is provided below as a representative example. The as-produced zirconium dichloride complex may be converted to the corresponding dimethyl analogue through treatment with trimethylaluminum. Other aryl-substituted Group 4 metallocenes may be synthesized in a similar manner.

4-(4-(tert-Butyl)phenyl)-1,1,3,3,6-pentamethyl-1,2,3,5-tetrahydro-s-indacene. 4-bromo-1,1,3,3,6-pentamethyl-1,2,3,5-tetrahydro-s-indacene (0.98 g, 3.19 mmol), 4-tert-butylphenylboronic acid (0.57 g, 3.19 mmol), potassium carbonate (0.99 g, 7.03 mmol), bis(dibenzylideneacetone)palladium (0.02 g, 0.03 mmol), 1,3,5,7-tetramethyl-6-phenyl-2,4,8-troxa-6-phosphaadamantane (0.03 g, 0.10 mmol), tetrahydrofuran (15 mL), and nitrogen-purged water (3 mL) were combined in a tube. The tube was sealed, and the reaction was stirred and heated to 75° C. for 16 hours. The reaction was then allowed to cool to room temperature. The reaction was concentrated in vacuo to remove tetrahydrofuran. The resulting residue was partitioned between water and hexane (50 mL). The hexane layer was collected, and the aqueous phase was washed once more with hexane (50 mL). The combined hexane extracts were washed with aqueous potassium carbonate and then brine. The hexane extract was dried over anhydrous magnesium sulfate then filtered. The filtrate was concentrated in vacuo to obtain the product as an orange solid (1.06 g, 92% yield).

Lithium 4-(4-(tert-butyl)phenyl)-2,5,5,7,7-pentamethyl-1,5,6,7-tetrahydro-s-indacenide. N-butyllithium (1.2 mL, 2.5 M in hexane) was combined with a precooled, stirred solution of 4-(4-tert-butyl)phenyl)-1,1,3,3,6-pentamethyl-1,2,5,5-tetrahydro-s-indacene (1.06 g) in 50 mL of diethyl ether. The reaction was stirred at room temperature for 5 hours, then concentrated under a stream of nitrogen and vacuum. The residue was stirred in 10 mL of pentane. The resulting suspension was filtered over a plastic, fritted funnel. The filtered solid was washed further with two additions of pentane (5 mL). The solid was collected and concentrated under high vacuum to produce a light, white-pink solid (0.977 g, 90% yield).

(4-(4-(tert-Butyl)phenyl-2,5,5,7,7-pentamethyl-1,5,6,7-tetrahydro-s-indacenyl)dimethyl-(2,3,4,5-tetramethylcyclopentadienyl)silane. Lithium 4-(4-(tert-butyl)phenyl)-2,5,5,7,7-pentamethyl-1,5,6,7-tetrahydro-s-indacenide (0.98 g) was mixed with a solution of dimethyl(2,3,4,5-tetramethylcyclopentadienyl)silyl trifluoromethanesulfonate (0.88 g) in 20 mL of diethyl ether. The reaction was stirred at room temperature for 15 hours, then concentrated under a stream of nitrogen and vacuum. The residue was extracted twice with 20 mL of pentane filtered over CELITE®. The combined pentane extracts were concentrated under a stream of nitrogen and then under high vacuum to produce an off-white foam (1.41 g, 97% yield).

Lithium 4-(4-(tert-butyl)phenyl)-1-(dimethyl(2,3,4,5-tetramethylcyclopentadieneidyl)silyl)-2,5,5,7,7-pentamethyl-1,5,6,7-tetrahydro-s-indacenide. N-butyllithium (2.2 mL, 2.5 M in hexane) was added to a solution of (4-(4-(tert-butyl)phenyl)-2,5,5,7,7-pentamethyl-1,5,6,7-tetrahydro-s-indacenyl)dimethyl(2,3,4,5-tetramethylcyclopentadienyl)silane (1.21 g) in 50 mL of diethyl ether. The reaction was stirred at room temperature, then concentrated under a stream of nitrogen and vacuum to produce a tan-brown solid (1.58 g, 98% yield) containing diethyl ether and pentane.

Dimethylsilyl (2,5,5,7,7-pentamethyl-4-(4-tert-butyl-phenyl)-1,5,6,7-tetrahydro-s-indacenyl)(2,3,4,5-tetramethyl-cyclopentadienyl) zirconium dichloride (Catalyst I2-Zr). A solution of zirconium chloride (0.345 g) in 10 mL of toluene was mixed with a precool solution of lithium 4-(4-(tert-butyl)phenyl)-1-(dimethyl(2,3,4,5-tetramethylcyclopentadienidyl)silyl)-2,5,5,7,7-pentamethyl-1,5,6,7-tetrahydro-s-indacenide (0.89 g) in 30 mL of diethyl ether. The reaction was stirred at room temperature for 16 hours, then concentrated under a stream of nitrogen and vacuum. The residue was extracted twice with 20 mL of dicholoromethane and filtered over CELITE®. The combined dichloromethane extracts were concentrated under a stream of nitrogen and vacuum to produce a brown solid. The solid was filtered over a plastic, fritted funnel and was combined with two 10 mL additions of hexane. The solid was collected and concentrated under high vacuum to yield a bright yellow solid (0.45 g, 43% yield).

Dimethylsilyl (2,5,5,7,7-pentamethyl-4-(4-tert-butyl-phenyl)-1,5,6,7-tetrahydro-s-indacenyl)(2,3,4,5-tetramethyl-cyclopentadienyl) hafnium dichloride (Catalyst I2-Hf). A solution of hafnium chloride (0.367 g) in 5 mL of toluene was mixed with a precooled solution of lithium 4-(4-(tert-butyl)phenyl)-1-(dimethyl(2,3,4,5-tetramethylcyclopentadienidyl)silyl)-2,5,5,7,7-pentamethyl-1,5,6,7-tetrahydro-s-indacenide (0.70 g) in 30 mL of diethyl ether. The reaction was stirred at room temperature for 17 hours, then concentrated under a stream of nitrogen and vacuum. The residue was extracted with dichloromethane and filtered over CELITE®. The dichloromethane extract was concentrated under a stream of nitrogen and vacuum. The solid was stirred in hexane, initially producing a brown solution. The solution was stirred until the mixture formed a suspension. The resulting suspension was filtered over a plastic, fritted funnel and washed with two 10 mL additions of hexane. The solid was concentrated under high vacuum to yield a pale yellow-tan solid (0.43 g, 48% yield).

Dimethylsilyl (2,5,5,7,7-pentamethyl-4-(4-tert-butyl-phenyl)-1,5,6,7-tetrahydro-s-indacenyl)(2,3,4,5-tetramethyl-cyclopentadienyl) hafnium dimethyl. A solution of methylmagnesium bromide (0.95 mL, 3 M in diethyl ether) was mixed with a solution of dimethylsilyl (2,5,5,7,7-pentamethyl-4-(4-tert-butyl-phenyl)-1,5,6,7-tetrahydro-s-indacenyl)(2,3,4,5-tetramethyl-cyclopentadienyl) hafnium dichloride (0.43 g) in 20 mL of toluene. The reaction was stirred and heated to 70° C. for 2.5 hours. Then, the reaction was heated to 80° C. for 20.5 hours. After an additional 1 mL of diethyl ether was added to the reaction, the solution was stirred for 24 hours. Methylmagnesium bromide (0.4 mL, 3 M in diethyl ether) was added to the reaction mixture, then stirred and heated to 90° C. for an additional 3.5 hours. Then, the reaction temperature was increased to 100° C. and stirred for 3 hours. Methylmagnesium bromide (0.5 mL, 3 M in diethyl ether) was added, and the reaction was stirred and heated to 110° C. for 1 hour. While cooling, the reaction was concentrated under a stream of nitrogen and vacuum. The residue was extracted with hot hexane (10 mL, then 5 mL) and filtered over CELITE® while hot. The combined hot hexane extracts were concentrated under a stream of nitrogen and vacuum to produce a fraction of the product as an off-white foam (0.31 g). The hot hexane-washed solid was extracted with toluene (20 mL, then 10 mL) and filtered over CELITE®. The combined toluene extracts were concentrated under a stream of nitrogen and vacuum to yield a second fraction of the product (0.08 g) (combined fractions=0.39 g, 95% yield).

4-Alkyl- and 4-aryl-substituted metallocene compounds synthesized for further testing are shown in Scheme 5 below.

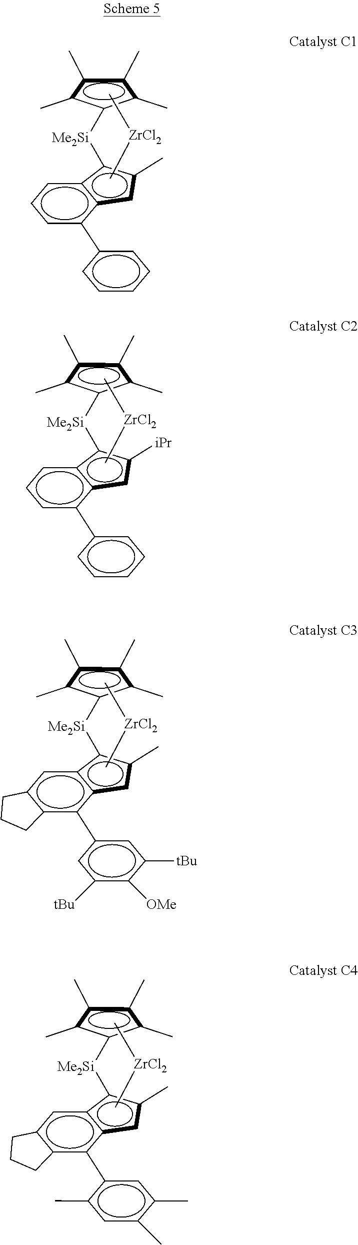

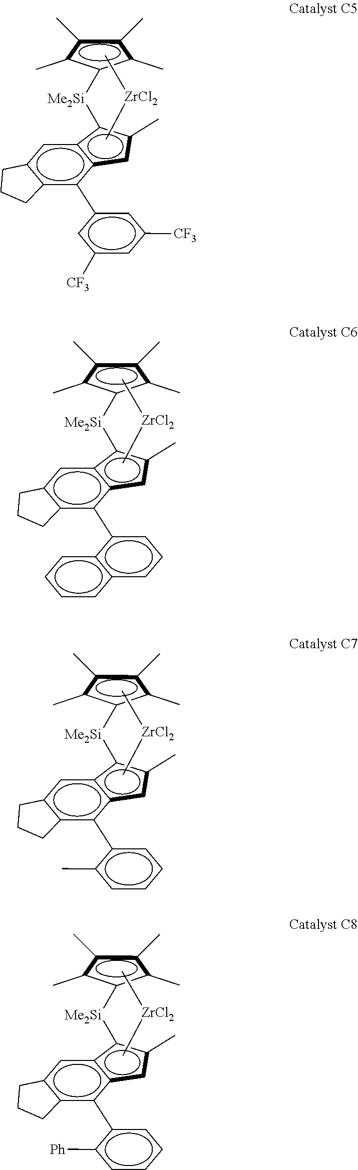

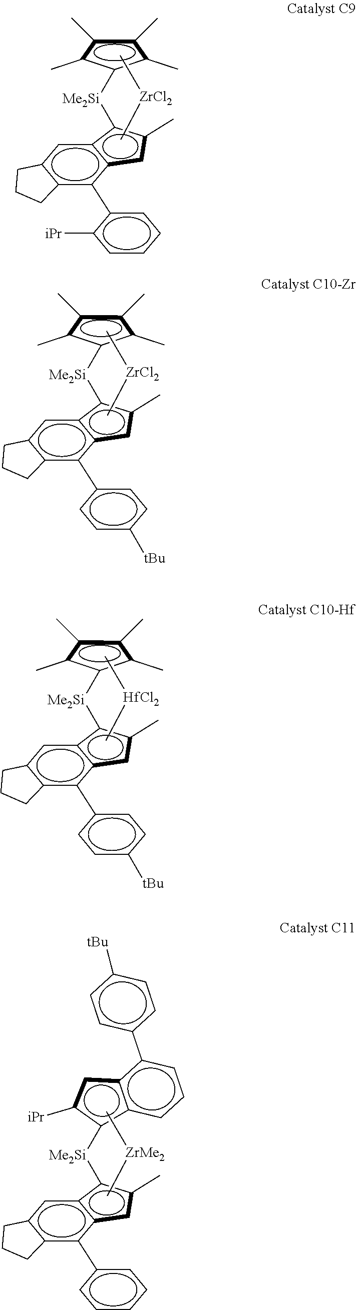

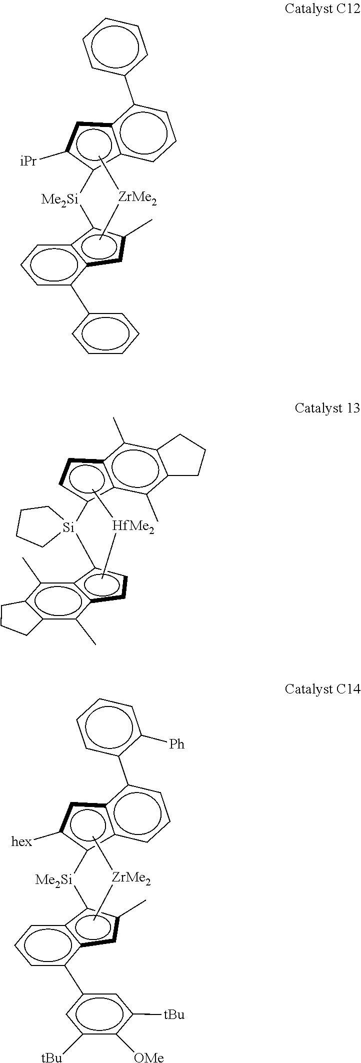

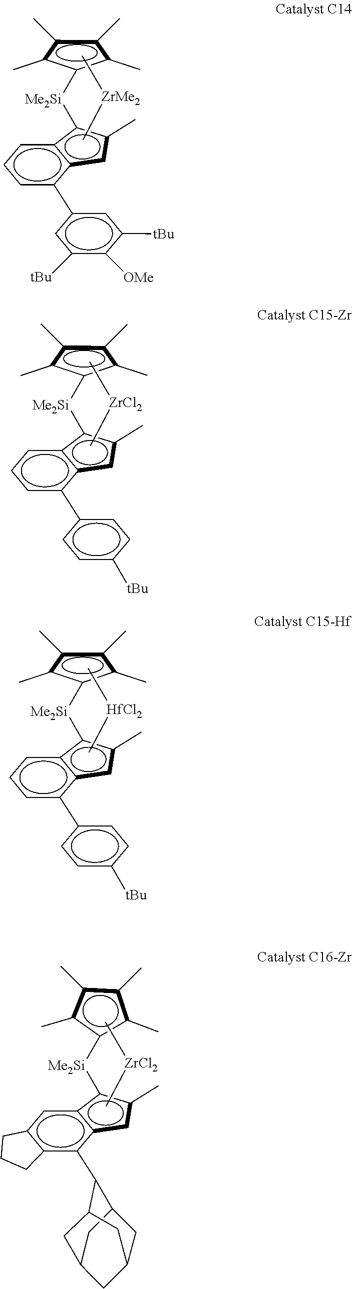

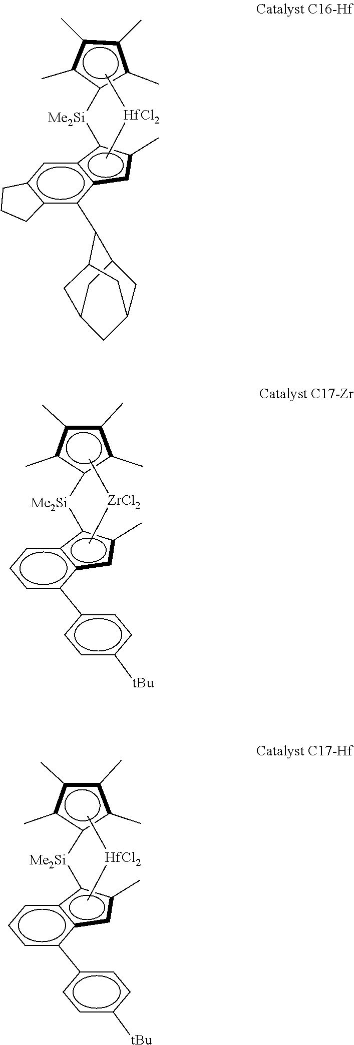

Preparation of silica supported MAO (SMAO). In a celstir, 10.0 g of DM-L403 silica (AGC, dehydrated at 200° C.) was suspended in ˜100 mL of dry toluene. While stirring, 15.8 g of 30% solution of MAO was slowly added to the stirring silica mixture (over 10 minutes). The reactions were allowed to stir for 1.5 hours. After 1.5 hours, the temperature was raised to 100° C. and the reactions were allowed to stir for additional 2.5 hours. Upon cooling, the resulting slurry was filtered, and the solids were washed with toluene (2×50 mL), pentane (2×50 mL) and were dried in vacuo for at least 2 hours to give resulting SMAO as a white free flowing powder.

Preparation of supported Catalyst C16-Zr. In a 25 mL scintillation vial, 1.0 g of previously prepared SMAO was suspended in 10 mL of anhydrous toluene and placed on a shaker. 0.514 mL of triisobutylaluminum solution (1M in hexane) was then added and the resulting mixture was agitated for 15 minutes at room temperature. After 15 minutes, metallocene Catalyst C16-Zr (25 μmol) was slowly added to the silica mixture as a toluene solution (ca. 2 mL). The resulting slurry was agitated for 3 hours. After 3 hours, the slurry was filtered on a glass frit, the solid was washed with toluene (2×5 mL) and pentane (2×5 mL) and dried in vacuo to give the supported catalyst as orange/red free flowing solids. The resulting solids were suspended in mineral oil to make 5 wt % slurry which was used in lab reactor polymerizations.

Preparation of supported Catalyst C11. In a 25 mL scintillation vial, 1.0 g of previously prepared SMAO was suspended in 10 mL of anhydrous toluene and placed on a shaker. 0.514 mL of triisobutylaluminum solution (1M in hexane) was then added and the resulting mixture was agitated for 15 minutes at room temperature. After 15 minutes, metallocene Catalyst C11 (25 μmol) was slowly added to the silica mixture as a toluene solution (ca. 2 mL). The resulting slurry was agitated for 3 hours. After 3 hours, the slurry was filtered on a glass frit, the solid was washed with toluene (2×5 mL) and pentane (2×5 mL) and dried in vacuo to give the supported catalyst as orange/red free flowing solids. The resulting solids were suspended in mineral oil to make 5 wt % slurry which was used in lab reactor polymerizations.

Preparation of Mixed Supported Catalysts C11/C16-Zr. In a 25 mL scintillation vial, 1.0 g of previously prepared SMAO was suspended in 10 mL of anhydrous toluene and placed on a shaker. 0.514 mL of triisobutylaluminum solution (1M in hexane) was then added and the resulting mixture was agitated for 15 minutes at room temperature. After 15 minutes, a metallocene catalyst mixture of Catalyst C16-Zr (12.5 μmol) and Catalyst C11 (12.5 μmol) was slowly added to the silica mixture as a toluene solution (ca. 2 mL). The resulting slurry was agitated for 3 hours. After 3 hours, the slurry was filtered on a glass frit, the solid was washed with toluene (2×5 mL) and pentane (2×5 mL) and dried in vacuo to give the supported catalyst as orange/red free flowing solids. The resulting solids were suspended in mineral oil to make 5 wt % slurry which was used in lab reactor polymerizations.

Preparation of Mixed Supported Catalysts C14/C16-Zr. In a 25 mL scintillation vial, 1.0 g of previously prepared SMAO was suspended in 10 mL of anhydrous toluene and placed on a shaker. 0.514 mL of triisobutylaluminum solution (1M in hexane) was then added and the resulting mixture was agitated for 15 minutes at room temperature. After 15 minutes, a metallocene catalyst mixture of Catalyst C16-Zr (12.5 μmol) and Catalyst C14 (12.5 μmol) was slowly added to the silica mixture as a toluene solution (ca. 2 mL). The resulting slurry was agitated for 3 hours. After 3 hours, the slurry was filtered on a glass frit, the solid was washed with toluene (2×5 mL) and pentane (2×5 mL) and dried in vacuo to give a supported catalyst as orange/red free flowing solids. The resulting solids were suspended in mineral oil to make 5 wt % slurry which was used in lab reactor polymerizations.

Preparation of Supported Catalysts C10-Zr, C15-Zr, and C17-Zr. In a 25 mL scintillation vial, 0.6 g of previously prepared SMAO was suspended in 10 mL of anhydrous toluene and placed on a shaker. Triisobutylaluminum (0.31 mL, 1 M in hexane) was added and the resulting mixture was agitated for 15 minutes at room temperature. After 15 minutes, metallocene catalyst (based on 12 μmol/g loading) was slowly added to the silica mixture as a toluene solution (ca. 2 mL). The resulting slurry was agitated for 3 hours. After agitation, the slurry was filtered on a glass frit, the solid was washed twice with 5 mL of toluene and twice with 5 mL of pentane, and dried in vacuo to yield the supported catalyst as orange-red free flowing solids. The resulting solids obtained for each metallocene catalyst were suspended in mineral oil to produce a 5 wt % slurry which was used in the lab reactor polymerizations.

### Polymerization Reactions and Data

Polymerization procedure (HT). Solution propylene polymerizations were carried out under high-throughput conditions according to the following general procedure. A pre-weighed glass vial insert and disposable stirring paddle were fitted to each reaction vessel of the reactor, which contains 48 individual reaction vessels. The reactor was then closed and ethylene gas was introduced at a desired pressure. Then solvent (typically the isohexane) was added to bring the total reaction volume, including the subsequent additions, to 5 mL and the reactor vessels were heated to their set temperature (usually from about 50° C. to about 110° C.). The contents of the vessel were stirred at 800 rpm. An activator solution (typically 1.1-1000 molar equivalents of methyl alumoxane (MAO) in toluene or non-coordinating anion activator) was then injected into the reaction vessel along with 500 microliters of toluene. Catalyst (typically 0.50 mM in toluene, such as 20-40 nmol of catalyst) and another aliquot of toluene (500 microliters) were then added to initiate the reaction. Equivalence is determined based on the mol equivalents relative to the moles of the transition metal in the catalyst complex. The reaction was then allowed to proceed until a pre-determined amount of pressure had been taken up by the reaction. Alternatively, the reaction may be allowed to proceed for a set amount of time. At this point, the reaction was quenched by pressurizing the vessel with compressed air. After the polymerization reaction, the glass vial insert containing the polymer product and solvent was removed from the pressure cell and the inert atmosphere glove box, and the volatile components were removed using a Genevac HT-12 centrifuge and Genevac VC3000D vacuum evaporator operating at elevated temperature and reduced pressure. The vial was then weighed to determine the yield of the polymer product. The resultant polymer was analyzed by Rapid GPC (see above) to determine the molecular weight and by DSC (see below) to determine melting point.

Polymerization procedure (Reactor). Supported catalyst (ca. 0.5-0.6 g) was slurried into dry and degassed mineral oil to yield a slurry containing 5% by weight of supported catalyst. The supported catalysts (typically 25-50 mg) were added to the reactor as a slurry in oil. The catalyst slurry containing certain amounts of catalysts was injected using 250 mL propylene into a 2 L autoclave reactor containing propylene (1000 mL) and triisobutylaluminum, TIBAL (2.0 mL of 5% toluene solution). The reactor was kept at ambient temperature for 5 minutes, after which the temperature was raised to 70° C. At that point, polymerization was allowed to proceed for 30 minutes. After 30 minutes H₂ (provided from a 183 mL container under the pressure of 30-33 psi) was added. The polymerization was allowed to proceed for additional 20 minutes. After the allotted time, the reactor was cooled to room temperature and vented. The polymer was collected and dried in a vacuum oven at 60° C. overnight. The resultant polymer was analyzed by GPC-4D (see above) to determine the molecular weight.

DSC Procedure: For the high-throughput samples, the melting temperature (Tₘ) was measured using Differential Scanning Calorimetry (DSC) using commercially available equipment such as a TA Instruments TA-Q200 DSC. Typically, 5 to 10 mg of molded polymer or plasticized polymer was sealed in an aluminum pan and loaded into the instrument at about room temperature. Samples were pre-annealed at about 220° C. for about 15 minutes and then allowed to cool to about room temperature overnight. The samples were then heated to about 220° C. at a heating rate of about 100° C./min, held at this temperature for at least about 5 minutes, and then cooled at a rate of about 50° C./min to a temperature typically at least about 50° C. below the crystallization temperature. Melting points were collected during the heating period.

¹H NMR procedure. ¹H NMR data of the polymer was collected at 120° C. using a 10 mm cryoprobe on a 600 MHz Bruker spectrometer with deuterated tetrachloroethane (tce-d2). Samples were prepared with a concentration of 30 mg/mL at 140° C. Data was recorded with a 30° pulse, 5 second delay, 512 transients. Signals were integrated and the numbers of unsaturation types per 1,000 carbons were reported. Scheme 6 shows the types of unsaturation that may be present in a polypropylene produced through metallocene catalysis. In Scheme 6, R represents the remainder of the polymer chain. The shift regions for the types of unsaturation in polypropylene are shown in Table 1.

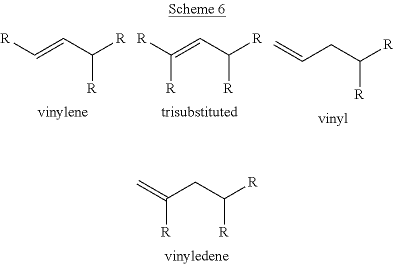

TABLE 1

| | | Number of |
|---|---|---|
| | | Hydrogens Per |
| Unsaturation Type | Region (ppm) | Structure |
| Vinyl | 4.95-5.10 | 2 |
| Vinylidene | 4.70-4.84 | 2 |
| Vinylene | 5.31-5.55 | 2 |
| Trisubstituted | 5.11-5.30 | 1 |

Transient extensional viscosity was measured at 190° C. using a SER2-P testing Platform available from Xpansion Instruments LLC, Tallmadge, Ohio, USA. The sample was prepared by placing the pellets in a mold measuring approximately 50 mm×50 mm with a thickness of ˜0.5 mm. The mold was pressed in a Carver laboratory press with a 3 pressure stage procedure at 190° C.: The material was preheated with 0 pounds of pressure for 2 minutes, pressed at 5 k lbs of pressure for 2 minutes, then the pressure was maintained at 0 while still in the mold for 15 minutes. Samples were cut into test strips measuring between 13 and 13.4 mm in width, ˜18 mm in length, and between 0.5 mm and 0.6 mm in average thickness. Note that there is variation in dimensions due to sample type. Samples were tested on an MCR 501 rheometer with an SER testing fixture. Samples were temperature equilibrated for 10-15 minutes before the test. The SER Testing Platform was used on a MCR501 rheometer available from Anton Paar. The SER Testing Platform is described in U.S. Pat. Nos. 6,691,569 and 6,578,413, which are incorporated herein for reference. A general description of transient uniaxial extensional viscosity measurements is provided, for example, in “Measuring the transient extensional rheology of polyethylene melts using the SER universal testing platform”, Society of Rheology, Inc., J. Rheol., v. 49(3), pp. 585-606 (2005). Strain hardening occurs when a polymer is subjected to elongational flow and the transient extensional viscosity increases with respect to the linear viscoelasticity envelop (LVE). Strain hardening is observed as abrupt upswing of the extensional viscosity in the transient extensional viscosity vs. time plot. A strain hardening ratio (SHR) is used to characterize the upswing in extensional viscosity and is defined as the ratio of the maximum transient extensional viscosity at certain strain rate over the respective value of the LVE. Strain hardening is present in the material when the ratio is greater than 1.

Peak melting point, Tₘ, described for reactor batches (also referred to as melting point) and peak crystallization temperature, T_{c}, (also referred to as crystallization temperature) were determined using the following DSC procedure according to ASTM D3418-03. Differential scanning calorimetric (DSC-2) data can be obtained using a TA Instruments model DSC2500 machine. Samples weighing approximately 5 to 10 mg were sealed in an aluminum hermetic sample pan and loaded into the instrument at about room temperature. The DSC data was recorded by first gradually heating the sample to about 200° C. at a rate of about 10° C./minute. The sample was kept at about 200° C. for 5 minutes, then cooled to about −50° C. at a rate of about 10° C./minute, followed by an isothermal stage for about 5 minutes and heating to about 200° C. at about 10° C./minute, holding at about 200° C. for about 5 minutes and then cooling down to about 25° C. at a rate of about 10° C./minute. Both the first and second cycle thermal events were recorded. The melting and crystallization temperatures reported here were obtained during the second heating/cooling cycle unless otherwise noted. In the event of conflict between the DSC Procedure-1 and DSC procedure-2, DSC procedure-2 is used.

### Vinyl-Terminated Polypropylenes

The tendency of various metallocene catalysts to promote P-hydride elimination or to promote chain transfer to monomer within the polymer chain is indicated in the ¹H NMR spectroscopy data presented in Table 2 below, which shows the distribution of olefin unsaturation types obtained from Catalysts C1-C8 under polymerization reaction conditions. The polymers were produced under high-throughput polymerization conditions ([Catalyst]=30 nmol, unsupported, [MAO]=500 equivalents relative to [Catalyst], 115 psi propylene, T=70° C., solvent=isohexane).

TABLE 2

| Catalyst | Vinylene (%) | Trisub. (%) | Vinyl (%) | Vinylidene (%) |
|---|---|---|---|---|
| C1 | 12.7 | 12.7 | 22.2 | 52.4 |
| C2 | 5.7 | 5.7 | 38.6 | 50.0 |
| C3 | 7.0 | 14.0 | 34.9 | 44.2 |
| C4 | 1.4 | 14.1 | 42.3 | 42.3 |
| C5 | 2.7 | 16.0 | 46.7 | 34.7 |
| C6 | 4.0 | 16.0 | 37.3 | 42.7 |
| C7 | 18.2 | 20.5 | 29.5 | 31.8 |
| C8 | 11.8 | 14.7 | 35.3 | 38.2 |

As indicated in Table 2, the 4-aryl-substituted metallocenes produced iPP with a wide distribution amongst vinylidenes, trisubstituted olefins, vinyls and vinylenes. In most cases, vinylidene termination was predominant and accounted for ˜30-50% of the total unsaturation. Vinyl termination was typically observed in the range of 30-40% of the total unsaturation. Vinylene and trisubstituted olefins were considerably less common.

Tables 3 and 4 show polymerization activity, polymer melting points, molecular weight values, and unsaturation distribution for 4-alkyl-substituted metallocenes (Catalysts C16-Zr and C16-Hf) in comparison to a pseudo-C₂ symmetric metallocene catalyst (Catalyst C13). The polymers were produced under high-throughput polymerization conditions ([Catalyst]=30 nmol, unsupported, [MAO]=500 equivalents relative to [Catalyst] or [NCA-1]/[NCA-2]=1.1 equivalents relative to [Catalyst], 115 psi or 145 psi propylene, T=70° C. or 100(C).

TABLE 3

| | | Catalyst | Catalyst | | |
|---|---|---|---|---|---|
| | | Activity | Activity | | |
| | | (kg/mmol · h) | (kg/mmol · h) | Tₘ | Tₘ |
| Catalyst | Activator | (70° C.) | 100° C.) | (70° C.) | (100° C.) |
| C16-Zr | NCA-1ª | 168.4 | 80.3 | 122.5 | 99.9 |
| C16-Zr | NCA-2^{b} | 173.9 | 80.5 | 129.5 | 110.0 |
| C16-Zr | MAO^{c} | 147.8 | 76.7 | 133.6 | 117.9 |
| C16-Hf | NCA-1ª | 172.8 | 92.3 | 112.6 | — |
| C16-Hf | NCA-2^{b} | 191.6 | 93.2 | 122.4 | 106.2 |
| C16-Hf | MAO^{c} | 69.6 | 44.4 | 133.0 | 111.9 |
| C13 | NCA-1ª | 71.4 | 91.3 | 137.5 | 123.1 |
| (comp.) | | | | | |
| C13 | NCA-2^{b} | 64.6 | 65.2 | 139.1 | 128.6 |
| (comp.) | | | | | |

^{a}NCA-1 is [C₈H₁₂N][B(C₆F₅)₄)]
^{b}NCA-2 is [C₈H₁₂N][B(C₁₀F₇)₄)]
^{c}MAO is methylalumoxane

TABLE 4

| | T | | | | | Vinylene | Trisub. | Vinyl | Vinyledene |
|---|---|---|---|---|---|---|---|---|---|
| Catalyst | (° C.) | Activator | Mₙ | M_{w} | PDI | (%) | (%) | (%) | (%) |
| C16-Zr | 70 | NCA-1^{a} | 4,105 | 8,804 | 2.1 | 0.6 | 1.7 | 46.4 | 51.3 |
| C16-Zr | 100 | NCA-1^{b} | 1,473 | 2,241 | 1.5 | 0.4 | 1.2 | 43.3 | 55.2 |
| C16-Zr | 70 | NCA-2^{b} | 6,654 | 14,324 | 2.1 | 0.7 | 2.9 | 50.4 | 46.0 |
| C16-Zr | 100 | NCA-2^{b} | 2,047 | 3,434 | 1.7 | 0.3 | 0.9 | 45.1 | 53.7 |
| C16-Zr | 70 | MAO^{c} | 10,298 | 18,840 | 1.8 | 0.9 | 5.2 | 60.6 | 33.2 |
| C16-Zr | 100 | MAO^{c} | 2,063 | 3,617 | 1.8 | 0.6 | 1.6 | 55.8 | 41.9 |
| C16-Hf | 70 | NCA-1^{a} | 3,702 | 7,826 | 2.1 | 0.2 | 1.5 | 84.4 | 14.0 |
| C16-Hf | 100 | NCA-1^{b} | 1,338 | 1,924 | 1.4 | 0.1 | 1.3 | 82.4 | 16.2 |
| C16-Hf | 70 | NCA-2^{b} | 4,329 | 10,082 | 2.3 | 0.2 | 1.8 | 85.5 | 12.6 |
| C16-Hf | 100 | NCA-2^{b} | 1,821 | 3,078 | 1.7 | 0.0 | 1.3 | 82.9 | 15.9 |
| C16-Hf | 70 | MAO^{c} | 9,687 | 18,299 | 1.9 | 0.6 | 3.9 | 79.5 | 16.0 |
| C16-Hf | 100 | MAO^{c} | 1,837 | 2,995 | 1.6 | 0.2 | 1.9 | 86.2 | 11.7 |
| C13 | 70 | NCA-1^{a} | 42,272 | 70,679 | 1.7 | 3.0 | 3.7 | 69.3 | 24.0 |
| (comp.) | | | | | | | | | |
| C13 | 100 | NCA-1^{b} | 6,510 | 11,844 | 1.8 | 8.2 | 9.3 | 53.6 | 28.9 |
| (comp.) | | | | | | | | | |
| C13 | 70 | NCA-2^{b} | 62,081 | 102,631 | 1.7 | 8.1 | 11.3 | 58.1 | 22.6 |
| (comp.) | | | | | | | | | |
| C13 | 100 | NCA-2^{b} | 10,934 | 21,189 | 2.0 | 2.9 | 5.1 | 83.5 | 8.6 |
| (comp.) | | | | | | | | | |

^{a}NCA-1 is [C₈H₁₂N][B(C₆F₅)₄)]
^{b}NCA-2 is [C₈H₁₂N][B(C₁₀F₇)₄)]
^{c}MAO is methylalumoxane

As shown in Table 3, Catalysts C16-Zr and C16-Hf were almost 3-fold more active at 70° C. relative to Catalyst C13. Catalyst C16-Zr maintained relatively constant activity regardless of the activator, whereas Catalyst C16-Hf was more active with soluble NCA 10 activators. Both Catalyst C16-Zr and Catalyst C16-Hf experienced a substantial activity drop at 100° C. C₂ symmetric Catalyst C13, in contrast, experienced a slight increase in activity at 100° C. with NCA-1 activation, while the activity increase with NCA-2 was negligible. As shown in Table 4, Catalysts C16-Zr and C16-Hf afforded considerably higher vinyl termination and lower molecular weights than did comparative C₂ symmetric Catalyst C13. Catalyst C16-Zr showed similar vinyl content with both NCA activators. MAO activation of Catalyst C16-Zr yielded the highest vinyl count for this catalyst (61% at 70° C. and 56% at 100° C.). The observed 61% VTM content at 70° C. for Catalyst C16-Zr is consistent with data obtained for supported catalysts under bulk polymerization of propylene at 70° C. (see below). Catalyst C16-Hf produced iPP with very high VTM counts under all tested conditions (80-85%). The highly variable data for comparative Catalyst C13 suggests that VTM generation shows large dependence on reaction conditions such as activator and temperature. The 4-alkyl-substituted catalysts, especially Catalyst C16-Zr, on the other hand, appeared to be more robust and generated similar VTM amounts under all tested conditions. This result suggests that the nature of the counter ion and eventual loss of crystallinity (tacticity) at higher polymerization temperatures do not largely affect termination pathways for Catalysts C16-Zr and C16-Hf.

Supported catalysts prepared as above were also subjected to polymerization reaction conditions and the distribution of polymer unsaturation was determined. Table 5 shows the distribution of polymer unsaturation obtained from propylene polymerization with selected supported catalysts. The polymerization was conducted at 70° C. under bulk propylene conditions in a dual stage run (30 min. without H₂, followed by 20 min. with H₂ in 1200 mL liquid propylene at 70° C. with 2.0 mL of 5 vol % triisobutylaluminum (reactor scavenger), and 50 mg of supported catalyst). Mw values were obtained by 4D-GPC.

TABLE 5

| | | | | | | | Vinyle- |
|---|---|---|---|---|---|---|---|
| | Activity | M_{w} | Tₘ | Vinylene | Trisub. | Vinyl | dene |
| Catalyst | (g/g · h) | (kDa) | (° C.) | (%) | (%) | (%) | (%) |
| C3 | 5015 | 188 | 157.0 | 6.3 | 18.8 | 31.3 | 43.8 |
| C4 | 5100 | 99 | 156.0 | 4.5 | 9.1 | 27.3 | 59.1 |
| C7 | 5178 | 100 | 156.8 | 3.0 | 21.2 | 30.3 | 45.5 |
| C8 | 3964 | 353 | 157.3 | 6.5 | 35.5 | 22.6 | 35.5 |
| C9 | 5970 | 358 | 158.4 | 5.0 | 25.0 | 25.0 | 45.0 |
| C10-Zr | 4206 | 303 | 156.7 | 4.3 | 21.7 | 30.4 | 43.5 |
| C12 | 2230 | 659 | 148.4 | 4.0 | 28.0 | 20.0 | 48.0 |
| C16-Zr | 2588 | 153 | 139.0 | 1.9 | 3.7 | 57.4 | 37.0 |

As shown, Catalyst C16-Zr, having bulky 4-alkyl substitution, produced a substantially higher content of VTM compared to other catalysts of similar structure but having 4-aryl substitution. Relative to other tested catalysts, Catalyst C16-Zr produced substantially lower amounts of both vinylene and trisubstituted olefins.

Since Catalyst C16-Zr produced significant amount of VTMs, it was co-supported with another C₂ symmetric catalyst or pseudo-C₂ symmetric catalyst demonstrating high activity toward comonomer incorporation. To this end, Catalysts C11 or C14 were co-supported with Catalyst C16-Zr to determine if VTMs produced by Catalyst C16-Zr could be further incorporated in a long-chain branched polymer under the mediation of C11 or C14. The two catalysts were combined in a 1:1 molar ratio in an amount to afford 0.25 wt % Zr on the support. Polymerization was conducted under bulk propylene conditions in a dual stage run (30 min. without H₂, followed by 20 min. with H₂) in 1200 mL liquid propylene at 70° C. with 2.0 mL of 5 vol % triisobutylaluminum (reactor scavenger), and 50 mg of supported catalyst. Table 6 summarizes the polymerization performance of the dual metallocene supported catalysts in comparison to single metallocene supported catalysts. Molecular weights were determined by GPC-4D.

TABLE 6

| | Activity | T_{c} | Tₘ | Mₙ | M_{w} | M_{z} | |
|---|---|---|---|---|---|---|---|
| Catalyst | (g/gh) | (° C.) | (° C.) | (kDa) | (kDa) | (kDa) | g′ᵥᵢₛ |
| C16-Zr | 2588 | 99.9 | 139.0 | 19 | 168 | 472 | 0.810 |
| C11 | 6637 | 110.8 | 152.6 | 14 | 221 | 1178 | 0.939 |
| C11/C16-Zr | 4837 | 113.5 | 152.3 | 16 | 182 | 1228 | 0.865 |
| C14/C16-Zr | 2455 | 119.9 | 150.1 | 14 | 215 | 1626 | 0.803 |

As shown in Table 6, Catalyst C16-Zr alone afforded substantial branching as apparent from its g′ᵥᵢₛ value but a low molecular weight. FIG. 1 is a GPC-4D analysis of polypropylene produced using Catalyst C16-Zr. Catalyst C11, in contrast, afforded a considerably higher molecular weight value but a decreased extent of branching. In contrast, when both metallocene catalysts were co-supported together, both high polymer molecular weights and an extent of branching comparable to that obtained with Catalyst C16-Zr alone was realized. The likely cause for this result is re-incorporation of VTMs produced by Catalyst C16-Zr under mediation of either Catalyst C11 or C14. FIG. 2 is a GPC-4D analysis of polypropylene produced using dual metallocene Catalyst C16-Zr/Catalyst C14. The GPC-4D analysis showed bimodal behavior, with heavy branch content on the high Mw side, as indicated by significant reduction of g′ᵥᵢₛ value. Although the difference in homopolymer crystallinity between the VTM producing catalyst (Catalyst C16-Zr, Tm=139.0° C.) and VTM incorporating catalysts (Catalyst C11 and Catalyst C14, Tm≈153° C.) was substantial, as evidenced by the difference in melting point values, the polypropylenes prepared with mixed catalyst systems did show a single melting point, which suggests likely co-crystallization of unreacted VTMs with the bulk sample. As expected for LCB-PP, the gradual shift in crystallization temperature from a typical Tc=109° C. for iPP to higher values is observed (113.5° C. for Catalyst C11/Catalyst C16-Zr and Tc=119.0° C. for Catalyst C14/Catalyst C16—Zr), indicating expected crystallization behavior of long-chain branched polymers. The increased crystallization temperature (Tc) is best illustrated in FIG. 3, which shows the DSC trace of the polypropylene prepared with Catalyst C11/Catalyst C16-Zr.

The potential for Catalyst C16-Zr to promote re-incorporation of its own vinyl-terminated macromonomers to yield a low Mw long-chain branched polymer sample was next investigated by extensional flow rheology with an SER testing fixture. Extensional flow rheology at 165° C. showed onset of strain hardening even for the polypropylene produced using the single metallocene Catalyst C16-Zr (FIG. 4), which is indicative of probable in situ formation and re-incorporation of long-chain branched polypropylene. This is further corroborated with the low g′ᵥᵢₛ (0.80) value obtained with Catalyst C16-Zr. FIG. 5 is a plot of extensional flow rheology at 170° C. at two rates (10 s⁻¹ and 1 s⁻¹) for the polypropylene produced using Catalyst C14/Catalyst C16-Zr, which again showed good strain hardening indicative of formation of LCB-PP.

### Other Polymers

Catalysts C10-Zr, C10-Hf, C15-Zr, C15-Hf, C17-Zr, and C17-Hf were investigated for their ability to mediate olefin polymerization reactions to produce polyethylene, ethylene-octene copolymers, polypropylene, and ethylene-propylene rubber.

Reactor polymerization (HT) and bulk slurry polymerization were performed as described above. GPC and Tm data were collected as described above.

Ethylene polymerization data is shown in Table 7, and ethylene-octene copolymerization data is shown in Table 8. In both cases, the polymerization experiments were conducted under high-throughput conditions at 85° C. in isohexane at 15 psi ethylene and catalyst concentrations of 20 nmol and activator concentrations of [B(C₁₀F₇)₄][HNMe₂C₆H₅](1.1 equivalents relative to metallocene) as the non-coordinating anion activator. The metal dichloride complex was methylated with trimethylaluminum/potassium fluoride prior to polymerization as discussed above.

TABLE 7

| | Activity | Mn | Mw | | Tm |
|---|---|---|---|---|---|
| Catalyst | (kg/mmol · h) | (g/mol) | (g/mol) | PDI | (° C.) |
| C10-Zr | 921.1 | 152,195 | 361,735 | 2.4 | 134.9 |
| C10-Hf | 206.7 | 458,116 | 1,108,580 | 2.4 | 132.0 |
| C15-Zr | 932.6 | 128,509 | 366,744 | 2.9 | 133.4 |
| C15-Hf | 211.1 | 392,417 | 858,541 | 2.2 | 132.5 |
| C17-Zr | 892.3 | 160,879 | 341,810 | 2.2 | 134.3 |
| C17-Hf | 518.6 | 356,936 | 895,687 | 2.6 | 132.9 |

TABLE 8

| | 1-octene | Activity | Mn | Mw | | Tm | |
|---|---|---|---|---|---|---|---|
| Catalyst | (μL) | (kg/mmol · h) | (g/mol) | (g/mol) | PDI | (° C.) | wt % octene |
| C10-Zr | 100 | 996.0 | 105,017 | 251,388 | 2.4 | 108.4 | 12.3 |
| C10-Zr | 200 | 1113.2 | 107,433 | 231,758 | 2.2 | 95.6 | 20.2 |
| C10-Hf | 100 | 274.4 | 265,272 | 586,728 | 2.2 | 87.5 | 18.3 |
| C10-Hf | 200 | 317.3 | 243,849 | 527,170 | 2.2 | 43.1 | 30.3 |
| C15-Zr | 100 | 1150.6 | 100,648 | 239,200 | 2.4 | 104.9 | 11.7 |
| C15-Zr | 200 | 1299.9 | 85,847 | 195,425 | 2.3 | 91.9 | 21.5 |
| C15-Hf | 100 | 149.0 | 292,415 | 587,247 | 2.1 | 89.9 | 14.7 |
| C15-Hf | 200 | 128.0 | 249,555 | 534,547 | 2.1 | 58.1 | 27.6 |
| C17-Zr | 100 | 1021.6 | 103,808 | 232,840 | 2.3 | 104.1 | 13.6 |
| C17-Zr | 200 | 1138.2 | 96,795 | 204,951 | 2.1 | 90.0 | 23.5 |
| C17-Hf | 100 | 638.1 | 143,316 | 435,510 | 3.1 | 93.7 | 17.0 |
| C17-Hf | 200 | 776.0 | 129,703 | 345,213 | 2.7 | 74.9 | 31.7 |

The data in Tables 7 and 8 demonstrate comparably high activities for Catalysts C17-Zr and C17-Hf in comparison to the corresponding Catalysts C10-Zr and C10-Hf and C15-Zr and C15-Hf. The polymers produced showed similar molecular weight ranges, extent of 1-octene incorporation, and polydispersity. Quite surprisingly, Catalyst C17-Hf showed significantly higher activity relative to Catalysts C10-Hf and C15-Hf, but with a minor penalty in molecular weight.

Table 9 shows data associated with gas-phase polymerizations using the supported catalysts prepared as above.

TABLE 9

| | | | C₆ | | | | |
|---|---|---|---|---|---|---|---|
| | | | pre- | | | | |
| | Catalyst | Pressure | charge | H₂/C₂ | C₆/C₂ | Yield | Produc- |
| Catalyst | (mg) | (psig) | (mL) | flow | flow | (g) | tivity |
| C10-Zr | 19.4 | 240 | 2.5 | 0.5 | 0.1 | 36.1 | 1,861 |
| C15-Zr | 15.2 | 240 | 2.5 | 0.5 | 0.1 | 21.2 | 1,395 |
| C17-Zr | 22.3 | 240 | 2.5 | 0.5 | 0.1 | 31.1 | 1,395 |

As shown in Table 9, high catalyst productivity values were realized during gas phase polymerization.

Propylene polymerization data under solution polymerization conditions at 115 psi propylene and 70° C. in isohexane solvent is shown in Tables 10 and 11. The data in Table 10 was obtained with MAO initiator (500 equivalents relative to catalyst metal, 30 nmol), and the data in Table 11 was obtained with a NCA activator ([C₈H₁₂N][B(C₁₀F₇)₄)], 1.1 equivalents relative to catalyst metal, 30 nmol).

TABLE 10

| | Activity | Mn | Mw | | Tm |
|---|---|---|---|---|---|
| Catalyst | (kg/mmol · h) | (g/mol) | (g/mol) | PDI | (° C.) |
| C10-Zf | 436.3 | 38,719 | 73,426 | 1.9 | 152.3 |
| C10-Hf | 33.9 | 24,353 | 41,660 | 1.7 | 152.5 |
| C15-Zr | 265.8 | 53,400 | 94,017 | 1.8 | 149.7 |
| C15-Hf | 7.5 | 21,268 | 37,929 | 1.8 | 141.5 |
| C172-Zr | 97.4 | 57,109 | 90,061 | 1.6 | 153.3 |
| C17-Hf | 5.8 | 24,021 | 41,706 | 1.8 | 151.9 |

TABLE 11

| | Activity | Mn | Mw | | Tm |
|---|---|---|---|---|---|
| Catalyst | (kg/mmol · h) | (g/mol) | (g/mol) | PDI | (° C.) |
| C10-Hf | 834.7 | 11,949 | 23,541 | 2.0 | 143.3 |
| C15-Hf | 255.1 | 14,963 | 26,039 | 1.8 | 127.1 |
| C17-Hf | 492.2 | 11,790 | 21,351 | 1.9 | 143.6 |

As shown, the Hf catalysts demonstrated poor activities when activated with MAO, but high activity values were realized when activated with the NCA.

Propylene polymerization data under slurry polymerization conditions in liquid propylene at 70° C. in the presence of 0.2 M triisobutylaluminum is shown in Table 12. The supported catalysts prepared as above were used to obtain the data in Table 12. Molecular weight data was determined by GPC-4D.

TABLE 12

| | Hydrogen | Catalyst | Yield | Productivity | Mn | Mw | | Tm |
|---|---|---|---|---|---|---|---|---|
| Catalyst | (mmol) | (mg) | (g) | (g/g · h) | (g/mol) | (g/mol) | PDI | (° C.) |
| C10-Zr | 1 | 25.5 | 84.0 | 13,191 | 64,356 | 222,133 | 3.5 | 157 |
| C17-Zr | 0 | 24.9 | 32.5 | 2,605 | 108,805 | 218,735 | 2.0 | 153 |
| C17-Zr | 2 | 25.5 | 64.0 | 7,535 | 46,081 | 101,762 | 2.2 | 152 |

As shown, Catalyst C17-Zr afforded a narrower PDI relative to comparative catalyst C16.

Ethylene-propylene co-polymerization data under solution polymerization conditions is shown in Table 13. The data in Table 13 was obtained either with MAO (500 equivalents relative to catalyst metal, 20 nmol catalyst) or with [C₈H₁₂N][B(C₁₀F₇)₄)] activators (1.1 equivalents relative to catalyst metal plus 0.5 μmol tri-n-octylaluminum, 20 nmol catalyst). The polymerizations were conducted in isohexane solvent at 70° C. in the presence of 115 psi propylene and either 60 psi ethylene (MAO activation) or 30 psi ethylene (non-coordinating anion, activation)

TABLE 13

| | Acti- | Activity | Mn | Mw | | wt % |
|---|---|---|---|---|---|---|
| Catalyst | vator | (kg/mmol · h) | (g/mol) | (g/mol) | PDI | C₂ |
| C10-Zr | MAO | 1487.8 | 37,879 | 101,645 | 2.7 | 21.4 |
| C10-Zr | NCA | 1451.3 | 36,956 | 86,367 | 2.4 | 14.9 |
| C15-Zr | MAO | 1115.5 | 43,809 | 106,340 | 2.4 | 20.3 |
| C15-Zr | NCA | 845.6 | 62,130 | 116,953 | 1.9 | 17.1 |
| C17-Zr | MAO | 414.2 | 114,276 | 226,183 | 2.0 | 26.8 |
| C17-Zr | NCA | 99.0 | 145,458 | 250,306 | 1.7 | 29.1 |

As shown, Catalyst C17-Zr afforded considerably higher ethylene-propylene polymer molecular weights and narrower PDI values than did the comparative catalysts under both MAO and NCA activation. Increased ethylene incorporation was also realized relative to the comparative catalysts.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

While the foregoing is directed to embodiments of the present invention, other and further embodiments of the invention may be devised without departing from the basic scope thereof, and the scope thereof is determined by the claims that follow.

1. A mixed metallocene catalyst system comprising:
at least one first metallocene having a structure represented by Formula 1, at least one second metallocene different from the at least one first metallocene;
optionally, a support;
optionally, a scavenger; and
an activator; 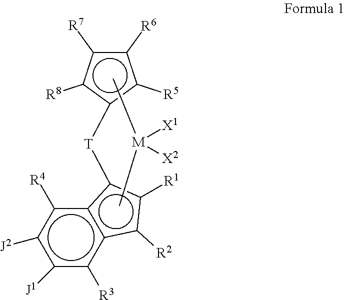
wherein:
M is a Group 4 metal;
T is a bridging group;
X¹ and X² are each a univalent anionic ligand, or X¹ and X² are joined to form a metallocycle ring, a chelating ligand, a diene ligand, or an alkylidene;
R¹ is hydrogen, halogen, optionally substituted C₁-C₄₀ alkyl, optionally substituted C₆-C₁₄ aryl, optionally substituted C₄-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
R² and R⁴ are independently hydrogen, halogen, optionally substituted C₁-C₄₀ alkyl, optionally substituted C₆-C₁₄ aryl, optionally substituted C₄-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
R³ is optionally substituted C₁-C₄₀ alkyl or optionally substituted C₆-C₁₄ aryl;
R⁵, R⁶, R⁷, and R⁸ are independently hydrogen, halogen, optionally substituted C₁-C₄₀ alkyl, optionally substituted C₆-C₁₄ aryl, optionally substituted C₄-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl, or one or more of R⁵ and R⁶, R⁶ and R⁷, or R⁷ and R⁸ are joined to form a C₃-C₆₂ substituted or unsubstituted, saturated or unsaturated, cyclic or polycyclic ring structure, or a combination thereof; and
J¹ and J² are each H, or J¹ and J² are joined to form a C₃-C₆₂ substituted or unsubstituted, saturated or unsaturated, cyclic or polycyclic ring structure, or a combination thereof.

2. The mixed metallocene catalyst system of claim 1, wherein M is zirconium or hafnium.

3. The mixed metallocene catalyst system of claim 1, wherein T is (R*₂G)_{g};
wherein each G is independently C, Si, or Ge, g is 1 or 2, and each R* is independently hydrogen, halogen, or C₁-C₂₀ optionally substituted hydrocarbyl, or two or more R* are joined to form a C₃-C₆₂ substituted or unsubstituted, saturated or unsaturated, cyclic or polycyclic ring structure, or a combination thereof.

4. The mixed metallocene catalyst system of claim 1, wherein T is selected from the group consisting of CH₂, CH₂CH₂, C(CH₃)₂, (Ph)₂C, (p-(Et)₃SiPh)₂C, SiMe₂, SiPh₂, SiMePh, Si(CH₂)₃, Si(CH₂)₄, and Si(CH₂)₄.

5. The mixed metallocene catalyst system of claim 1, wherein X¹ and X² are independently halogen or C₁-C₆ hydrocarbyl.

6. The mixed metallocene catalyst system of claim 1, wherein:
T is SiR⁹R¹⁰, wherein R⁹ and R¹⁰ are independently optionally substituted C₁-C₄₀ alkyl or optionally substituted C₆-C₁₄ aryl, or R⁹ and R¹⁰ are joined to form a C₃-C₆₂ substituted or unsubstituted, saturated or unsaturated, cyclic or polycyclic ring structure, or a combination thereof;
J¹ and J² are joined to define an optionally substituted indacenyl ring system;
R² and R⁴ are H; and
R³ is a bulky alkyl group.

7. The mixed metallocene catalyst system of claim 6, wherein R³ is optionally substituted cyclohexyl, optionally substituted norbornanyl, optionally substituted adamantyl, or optionally substituted t-butyl.

8. The mixed metallocene catalyst system of claim 1, wherein:
T is SiR⁹R¹⁰, wherein R⁹ and R¹⁰ are independently optionally substituted C₁-C₄₀ alkyl or optionally substituted C₆-C₁₄ aryl, or R⁹ and R¹⁰ are joined to form a C₃-C₆₂ substituted or unsubstituted, saturated or unsaturated, cyclic or polycyclic ring structure, or a combination thereof;
J¹ and J² are joined to define an optionally substituted indacenyl ring system;
R² and R⁴ are H; and
R³ is an optionally substituted phenyl group.

9. The mixed metallocene catalyst system of claim 8, wherein J¹ and J² define a 1,1,3,3-tetramethyl-trihydro-s-indacenyl ring system.

10. The mixed metallocene catalyst system of claim 1, wherein the second metallocene has a structure represented by Formula 10 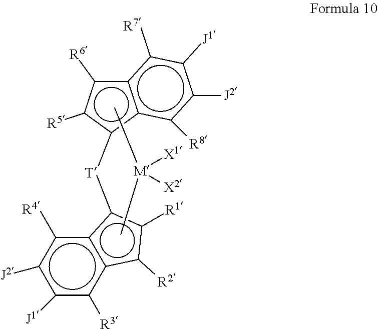
wherein:
M′ is a Group 4 metal;
T′ is a bridging group;
X^{1′} and X^{2′} are each a univalent anionic ligand, or X^{1′} and X^{2′} are joined to form a metallocycle ring, a chelating ligand, a diene ligand, or an alkylidene;
R^{1′} and R^{5′} are hydrogen or optionally substituted C₁-C₄₀ alkyl;
R^{3′} and R^{7′} are hydrogen, optionally substituted C₁-C₄₀ alkyl, optionally substituted C₆-C₁₄aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
R^{2′}, R^{4′}, R^{6′}, and R^{8′} are independently hydrogen, optionally substituted C₁-C₄₀ alkyl, or optionally substituted C₆-C₁₄ aryl; and
J^{1′} and J^{2′} are each H, or J^{1′} and J^{2′} are joined to form a C₃-C₆₂ substituted or unsubstituted, saturated or unsaturated, cyclic or polycyclic ring structure, or a combination thereof.

11. The catalyst system of claim 10, wherein T′ is SiR^{9′}R^{10′}, wherein R^{9′} and R^{10′} are independently optionally substituted C₁-C₄₀ alkyl or optionally substituted C₆-C₁₄ aryl, or R^{9′} and R^{10′} are joined to form a C₃-C₆₂ substituted or unsubstituted, saturated or unsaturated, cyclic or polycyclic ring structure, or a combination thereof.

12. The catalyst system of claim 1, wherein the activator is an aluminoxane, a salt of a non-coordinating anion, or any combination thereof.

13. (canceled)

14. The catalyst system of claim 13, wherein the support is present and comprises a support material and wherein the support material is selected from the group consisting of Al₂O₃, ZrO₂, SiO₂, SiO₂/Al₂O₃, SiO₂/TiO₂, silica clay, silicon oxide/clay, or mixtures thereof.

15. A polymerization process comprising:
providing an olefinic feed; and
contacting the catalyst system of claim 1 with the olefinic feed under polymerization reaction conditions to produce a polyolefin.

16. The polymerization process of claim 15, wherein the olefinic feed comprises at least propylene, and the polyolefin is a propylene polymer that is a homopolymer or a copolymer.

17. The polymerization process of claim 16, wherein the propylene polymer contains greater than 45% vinyl-terminated groups.

18. The polymerization process of claim 16, wherein the propylene polymer has a Mw value of 1,000 to 500,000 g/mol, as measured by gel permeation chromatography.

19. The polymerization process of claim 16, wherein the propylene polymer has a polydispersity index greater than 2.

20. The polymerization process of claim 16, wherein the propylene polymer has a melting point of greater than 120° C.

21. The polymerization process of claim 16, wherein the propylene polymer is long-chain branched with a g′ᵥᵢₛ value of less than 0.9, as measured by multi-detector gel-permeation chromatography.

22. A metallocene composition comprising:
at least one metallocene having a structure represented by Formula 9 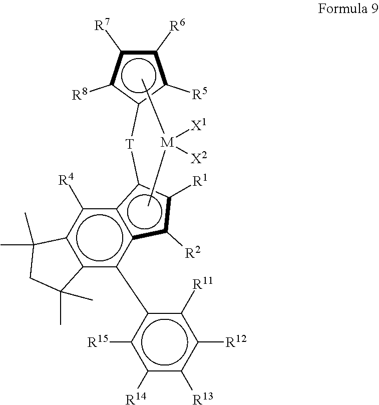
wherein:
M is a Group 4 metal;
T is a bridging group;
X¹ and X² are each a univalent anionic ligand, or X¹ and X² are joined to form a metallocycle ring, a chelating ligand, a diene ligand, or an alkylidene;
R¹ is hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
R² and R⁴ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl;
R⁵, R⁶, R⁷, and R⁸ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and R′ is hydrogen, C₁-C₁₀ alkyl, or C₆-C₁₀ aryl, or one or more of R⁵ and R⁶, R⁶ and R⁷, or R⁷ and R⁸ are joined to form a C₃-C₆₂ substituted or unsubstituted, saturated or unsaturated, cyclic or polycyclic ring structure, or a combination thereof; and
R¹¹—R¹⁵ are independently hydrogen, halogen, optionally substituted C₁-C₄₀ alkyl, optionally substituted C₆-C₁₄ aryl, optionally substituted C₃-C₁₃ heteroaryl, —NR′₂, —SR′, —OR′, —SiR′₃, —OSiR′₃, —PR′₂, or —R″—SiR′₃, wherein R″ is C₁-C₁₀ alkyl and each R′ is hydrogen, C₁-C₁₀ alkyl, or C₆-C₁₀ aryl, or R¹¹ and R¹², R¹² and R¹³, R¹³ and R¹⁴, or R¹⁴ and R¹⁵, or any combination thereof are joined to form a C₃-C₆₂ substituted or unsubstituted, saturated or unsaturated, cyclic or polycyclic ring structure, or a combination thereof.

23. The metallocene composition of claim 22, wherein T is selected from the group consisting of CH₂, CH₂CH₂, C(CH₃)₂, (Ph)₂C, (p-(Et)₃SiPh)₂C, SiMe₂, SiPh₂, SiMePh, Si(CH₂)₃, Si(CH₂)₄, and Si(CH₂)₄.

24. The metallocene composition of claim 22, wherein R² and R⁴ are hydrogen.

25. A catalyst system comprising the metallocene composition of claim 22, an activator, optionally, a support, and optionally, a scavenger.

26. A polymerization process comprising:
providing an olefinic feed; and
contacting the catalyst system of claim 25 with the olefinic feed under polymerization reaction conditions to produce a polyolefin.
